(19) United States
(12) Patent Application Publication
(10) Pub. No.: US 2018/0033008 A1
(43) Pub. Date: Feb. 1, 2018

(54) SYSTEM, INFORMATION PROCESSING DEVICE, AND COMPUTER-READABLE RECORDING MEDIUM

(71) Applicants: Takashi GOTO, Kanagawa (JP); Ryohsuke TAKAHASHI, Kanagawa (JP); Takayasu OE, Kanagawa (JP); Hiroshi KATO, Kanagawa (JP); Masayuki OSUGI, Tokyo (JP)

(72) Inventors: Takashi GOTO, Kanagawa (JP); Ryohsuke TAKAHASHI, Kanagawa (JP); Takayasu OE, Kanagawa (JP); Hiroshi KATO, Kanagawa (JP); Masayuki OSUGI, Tokyo (JP)

(73) Assignee: Ricoh Company, Ltd., Tokyo (JP)

(21) Appl. No.: 15/664,162

(22) Filed: Jul. 31, 2017

(30) Foreign Application Priority Data
Aug. 1, 2016 (JP) 2016-151594
Mar. 2, 2017 (JP) 2017-039370

(51) Int. Cl. G06Q 20/40; G06Q 20/02

(52) U.S. Cl. CPC G06Q 20/4014; G06Q 20/02

(57) ABSTRACT

According to an embodiment, a system includes an information processing device and an information terminal, connected via a communication network. The terminal includes owner identification information of an owner of the information terminal. The terminal receives operator identification information for identifying an operator of the information terminal, and transmits, to the device, request information for requesting a process for a target for charging and first pair information containing the owner identification information and the operator identification information. The information processing device includes second pair information in which the owner identification information is associated with the operator identification information. The information processing device collates the second pair information with the first pair information, performs the process for the target when verification information indicating matching of the pair information, and manages the owner identification information corresponding to the verification information, as information for a target person for charging.

### CROSS-REFERENCE TO RELATED APPLICATIONS

The present application claims priority under 35 U.S.C. §119 to Japanese Patent Application No. 2016-151594, filed on Aug. 1, 2016 and Japanese Patent Application No. 2017-039370, filed on Mar. 2, 2017. The contents of which are incorporated herein by reference in their entirety.

### BACKGROUND OF THE INVENTION

### 1. Field of the Invention

The present invention relates to a system, an information processing device, and a computer-readable recording medium.

### 2. Description of the Related Art

Typically, the data of photographs that are taken at a school event is registered in a file-sharing server device installed in a school network, and the event participants can view the photographs by accessing the school network from information terminals. A decision-making system is known in which one of the mechanisms of a system for accessing a file-sharing server device from an information terminal is disclosed. In the decision-making system, in order to access a file server (a file-sharing server) from a client terminal (an information terminal), management information such as an ID and a password is transmitted to a management server, and it is determined according to the management information whether or not the user is authorized to establish connection with the file server (see Japanese Unexamined Patent Application Publication No. 2010-512597).

Moreover, a technology has been disclosed in which a wireless terminal device performs communication in the ad hoc mode so as to receive information indicating the connection status of each wireless base station and, based on the received information, decides on the wireless base station for establishing connection (see Japanese Patent No. 5155355).

Furthermore, a technology has been disclosed regarding a roaming process in which an information terminal switches among access points. In the concerned literature, the following points are written: the ranges of reach of the radio waves of two access points are overlapped so as to ensure that the data communication with the information terminal is not interrupted; and, from among the access points scanned by the information terminal, the access point having the greatest radio field intensity is given priority for establishing connection (see Japanese Patent No. 5025585).

Moreover, a technology regarding accessing a shared folder has been disclosed. In the concerned literature, it is disclosed that the users participating in a conference are identified and are made to specify the destination for storing conference material files in a predetermined shared folder created in advance (see Japanese Patent 5040238).

In the case of taking an online order from an information terminal that has established connection with the school network, the user of the information terminal needs to be charged according to the order. However, in the conventional technology, even if the school network is accessed from an information terminal, there is no mechanism to determinably figure out the identity of the person who needs to be charged. Hence, there is a risk that fraudulent orders are given by personation.

### SUMMARY OF THE INVENTION

According to an embodiment, a system includes an information processing device and an information terminal. The information processing device and the information terminal are connectible for communication via a communication network. The information terminal includes owner identification information for uniquely identifying an owner of the information terminal. The information terminal also includes an input receiver and a request transmitter. The input receiver is configured to receive input of operator identification information for identifying an operator of the information terminal. The request transmitter is configured to transmit, to the information processing device, request information for requesting a process for a target for charging and first pair information containing the owner identification information and the operator identification information. The information processing device includes second pair information in which the owner identification information of the information terminal is associated with the operator identification information of the operator who is the owner of the information terminal. The second pair information is registered in advance. The information processing device also includes a verifier, a request processor, and a charge manager. The verifier is configured to collate the second pair information with the first pair information transmitted by the request transmitter. The request processor configured to, when verification information indicating that the first pair information matches with the second pair information is acquired as a result of collation performed by the verifier, perform the process for the target indicated in the request information transmitted by the request transmitter. The charge manager is configured to manage the owner identification information corresponding to the verification information acquired, as information for a target person for charging for whom the process for the target is performed by the request processor.

### BRIEF DESCRIPTION OF THE DRAWINGS

FIG. 1 is a diagram illustrating an exemplary overall configuration of a photograph ordering system according to a first embodiment;

FIG. 2 is a diagram illustrating an exemplary hardware configuration of an information terminal;

FIG. 3 is a diagram illustrating an exemplary data structure of “owner identification information”;

FIG. 4 is a diagram illustrating an exemplary functional configuration of the information terminal;

FIG. 5 is a diagram illustrating an exemplary hardware configuration of a web server device;

FIG. 6 is a diagram illustrating an exemplary data structure of an individual identification information table;

FIG. 7 is a diagram illustrating an exemplary data structure of a connection information table;

FIG. 8 is a diagram illustrating an exemplary data structure of a photograph order information table;

FIG. 9 is a diagram illustrating an exemplary screen structure of a preregistration screen;

FIG. 10 is a diagram illustrating an exemplary screen structure of an owner ID input screen;

FIG. 11 is a diagram illustrating an exemplary screen structure of a search input form screen;

FIG. 12 is a diagram illustrating an exemplary screen structure of a photograph ordering screen;

FIG. 13 is a diagram illustrating an exemplary functional configuration of the web server device;

FIG. 14 is a diagram illustrating an exemplary sequence of processes performed by the information terminal and the web server device;

FIG. 15 is a diagram illustrating an exemplary sequence of a preregistration process performed by the information terminal of the administrator and the web server device;

FIG. 16 is a diagram illustrating an exemplary sequence of a viewing operation;

FIG. 17 is a diagram (continuation) illustrating an exemplary sequence of the viewing operation;

FIG. 18 is a diagram (continuation) illustrating an exemplary sequence of the viewing operation;

FIG. 19 is a diagram illustrating an exemplary flow of a reading process of reading the “owner identification information” from the information terminal;

FIG. 20 is a diagram illustrating an exemplary flow of a setting process of setting the owner ID in the information terminal;

FIG. 21 is a diagram illustrating an exemplary network configuration according to a second embodiment;

FIG. 22 is a diagram illustrating an exemplary hardware configuration of an allocating device;

FIG. 23 is a diagram illustrating an exemplary functional configuration of the allocating device;

FIG. 24 is a diagram illustrating an exemplary data structure of connection information stored in a hard disk drive (HDD);

FIG. 25 is a diagram illustrating an exemplary data structure of an allocation table;

FIG. 26 is a sequence diagram for explaining the communication connection and the communication termination between the information terminals and mediating devices;

FIG. 27 is a diagram illustrating an exemplary sequence of processes for the communication connection as performed by the functional units in the information terminal and the allocating device;

FIG. 28 is a diagram illustrating an exemplary sequence of processes for the communication termination as performed by the functional units in the information terminal and the allocating device;

FIG. 29 is an explanatory diagram for explaining a deciding process performed by an allocation processor;

FIG. 30 is an exemplary hardware configuration of an allocating device according to a third embodiment;

FIG. 31 is a diagram illustrating an exemplary functional configuration of the allocating device;

FIG. 32 is a diagram illustrating an exemplary hardware configuration of the mediating device;

FIG. 33 is a diagram illustrating an exemplary functional configuration of the mediating device;

FIG. 34 is a diagram illustrating an exemplary data structure of a registration information table of the mediating device;

FIG. 35 is a diagram illustrating an exemplary sequence of a communication process performed by the functional units of the information terminal, the allocating device, and the mediating device;

FIG. 36 is a diagram illustrating an exemplary sequence of a communication process performed in the case of deleting the identification information of the information terminal, which is registered in the mediating device, from the allocating device;

FIG. 37 is a diagram illustrating an exemplary network configuration of a connection distribution method according to a fourth embodiment;

FIG. 38 is a diagram illustrating an exemplary hardware configuration of a wireless base station according to the fourth embodiment;

FIG. 39 is a diagram illustrating an exemplary functional configuration of the wireless base station;

FIG. 40 is a diagram illustrating an exemplary data structure of a connection count monitoring table;

FIG. 41 is a diagram illustrating an exemplary flow of an updating process performed by a connection count monitor to update the connection count in the connection count monitoring table;

FIG. 42 is a diagram illustrating an exemplary state in which the number of information terminals connected to an access point is exceeding the upper limit;

FIG. 43 is a diagram illustrating an exemplary flow of a connection distribution process performed by the wireless base station;

FIG. 44 is a diagram for explaining the relationship between the variation in the radio wave transmission output at an access point and the roaming of information terminals accompanying the variation;

FIG. 45 is a diagram illustrating an example of the post-distribution connection status;

FIG. 46 is a diagram illustrating an exemplary flow of a roaming process performed by the information terminal;

FIG. 47 is a diagram illustrating examples of a support rate that is individually set in each access point;

FIG. 48 is a diagram illustrating an exemplary relationship between the data rate and the sensitivity in the information terminal;

FIG. 49 is a diagram illustrating an exemplary system configuration according to a fifth embodiment;

FIG. 50 is an overview explanatory diagram for explaining a connection distribution method implemented in a network system;

FIG. 51 is a diagram illustrating an exemplary hardware configuration of a wireless connection system;

FIG. 52 is a diagram illustrating an exemplary data structure of replication information stored in an HDD;

FIG. 53 is a diagram illustrating an exemplary functional configuration of the wireless connection system;

FIG. 54 is a diagram for explaining an example of the overall flow of a distribution process performed by the wireless connection system;

FIG. 55 is a diagram illustrating an exemplary flow of a connection destination deciding operation; and

FIG. 56 is a diagram illustrating an exemplary data structure of management tables maintained in the wireless connection system.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

Embodiments of the present invention will be described in detail below with reference to the drawings.

An object of an embodiment is to provide a system, an information processing device, and a computer-readable recording medium that make it possible to determinably figure out the identity of the person who needs to be charged.

The following explanation is given about an example in which the abovementioned system is implemented in a photograph ordering system.

### First Embodiment

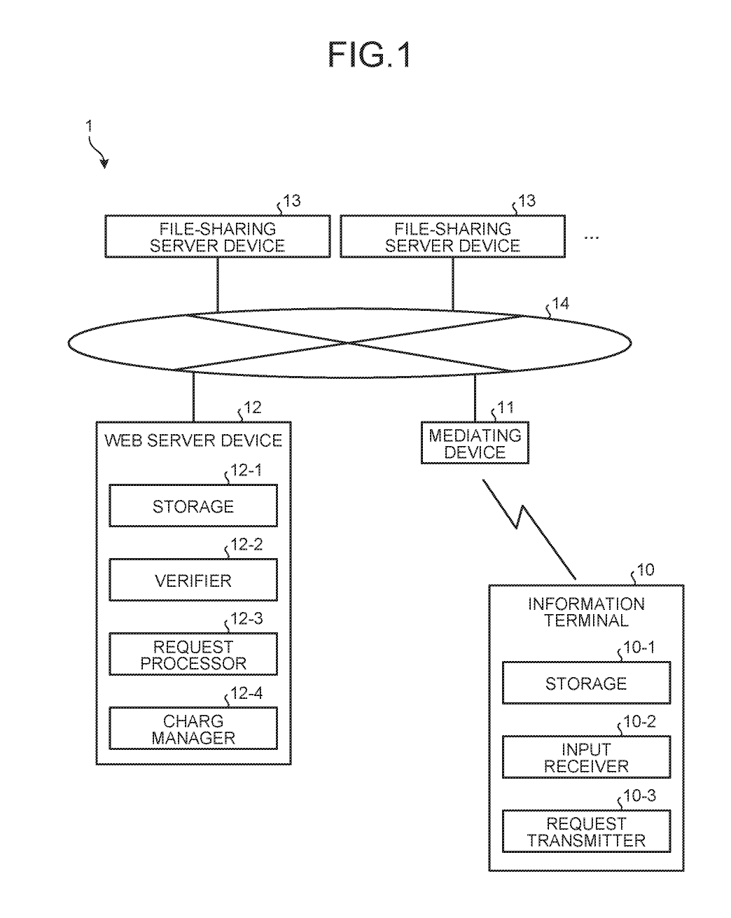

FIG. 1 is a diagram illustrating an exemplary overall configuration of a photograph ordering system according to a first embodiment. A photograph ordering system 1 illustrated in FIG. 1 includes an information terminal 10, a mediating device 11, a web (World Wide Web) server device 12, and file-sharing server devices 13. The mediating device 11, the web server device 12, and the file-sharing server devices 13 are connected to a network 14 such as a local area network (LAN), and perform communication with the devices in the network 14 using Internet protocol (IP) addresses. The information terminal 10 establishes connection for wireless communication with the mediating device 11, and performs communication with the devices in the network 14 using the IP address assigned thereto by the mediating device 11.

The mediating device 11 represents an access point. Moreover, the mediating device 11 has the DHCP server function (DHCP stands for Dynamic Host Configuration Protocol); and assigns an IP address to the information terminal 10, from which a connection request is received, in a static manner or a dynamic manner, and mediates the communication between the information terminal 10 and the devices in the network 14.

The information terminal 10 is, for example, a smartphone or a tablet terminal. The information terminal 10 performs HTTP communication (HTTP stands for HyperText Transfer Protocol) with the web server device 12 via the mediating device 11. For example, the information terminal 10 issues an HTTP request (request data) to the web server device 12 and requests for processes related to viewing or ordering of photographs. Herein, “processes related to viewing or ordering of photographs” are explained as an example of “processes regarding the target for charging” according to the first embodiment.

The web server device 12 represents an example of an “information processing device”. The web server device 12 processes request data received from the information terminal 10. For example, when a request for processes related to viewing or ordering of photographs is received, the web server device 12 performs a providing process that includes a process of acquiring list information of photographs from the file-sharing server devices 13 and transmitting the list information to the information terminal 10, and includes a process of taking an order of the photographs that have been specified in the list information.

The file-sharing server devices 13 represent examples of a “data management device”. The file-sharing server devices 13 manage photograph data, extract photograph data or list information of photographs according to a search condition transmitted by the web server device 12, and transmit the extracted information to the web server device 12.

In the first embodiment, the information terminal 10 includes a storage 10-1, an input receiver 10-2, and a request transmitter 10-3.

The storage 10-1 is used to store information enabling identification of the owner of the information terminal 10 (hereinafter, called “owner identification information”).

The input receiver 10-2 receives, at the time of issuing a request for viewing or ordering photographs, input of identification information that enables identification about whether or not the operator of the information terminal 10 is the owner of the information terminal 10 (hereinafter, called “owner ID (operator identification information)”).

Herein, the “owner identification information” differs from the “owner ID” in the following way. The “owner identification information” represents information that is sufficient to enable identification of the owner (identity) and corresponds to, for example, the mail address (email address) or the MAC address (MAC stands for Media Access Control) registered in the information terminal 10. In contrast, the “owner ID” represents information that is not sufficient to enable identification of the owner and represents, for example, a unique code decided by the owner to suit his or her convenience. The “owner ID” is used to make a distinction about whether or not the operator of the information terminal 10 is the owner thereof.

The request transmitter 10-3 transmits, at the time of issuing a request for viewing or ordering photograph data, the “owner identification information” stored in the storage 10-1 and the “owner ID” received by the input receiver 10-2 to the web server device 12 representing the request destination. In the following explanation, the combination of the “owner identification information” and the “owner ID” is suitably called “pair information (first pair information)”.

The web server device 12 includes a storage 12-1, a verifier 12-2, a request processor 12-3, and a charge manager 12-4.

The storage 12-1 is used to store pair information (second pair information) containing the “owner identification information” that is registered in advance and the “owner ID” that is set in the case in which the owner of the information terminal 10 is also the operator.

The verifier 12-2 collates, in response to a request for viewing or ordering photograph data, the first pair information, which contains the “owner identification information” and the “owner ID” and which is transmitted by the information terminal 10, with the second pair information that contains the “owner identification information” and the “owner ID” and that is stored in the storage 12-1.

When the verifier 12-2 acquires resultant verification information indicating that the sets of pair information (the first pair information and the second pair information) are identical, the request processor 12-3 processes the request for viewing or ordering photograph data as received from the information terminal 10.

The charge manager 12-4 manages, as the information of the person to be charged for viewing or ordering photograph data, the “owner identification information” for which the verification information was acquired.

With such a configuration, at the time of issuing a request for viewing or ordering photograph data, the information terminal 10 transmits the first pair information, which contains the “owner identification information” stored in the information terminal 10 and the “owner ID” input by the operator of the information terminal 10, to the web server device 12 via the mediating device 11.

The web server device 12 collates the second pair information, which is registered in advance, with the first pair information received from the information terminal 10. If the sets of pair information are identical, then the web server device 12 processes the request for ordering photographs, which is issued from the information terminal 10, while managing the “owner identification information” in the second pair information as the information of the person to be charged.

Given below is the explanation of a configuration of the information terminal 10, the web server device 12, and the file-sharing server devices 13. Firstly, the explanation is given about a configuration of the information terminal 10. That is followed by the explanation about a configuration of the web server device 12 and a configuration of the file-sharing server devices 13 in that order.

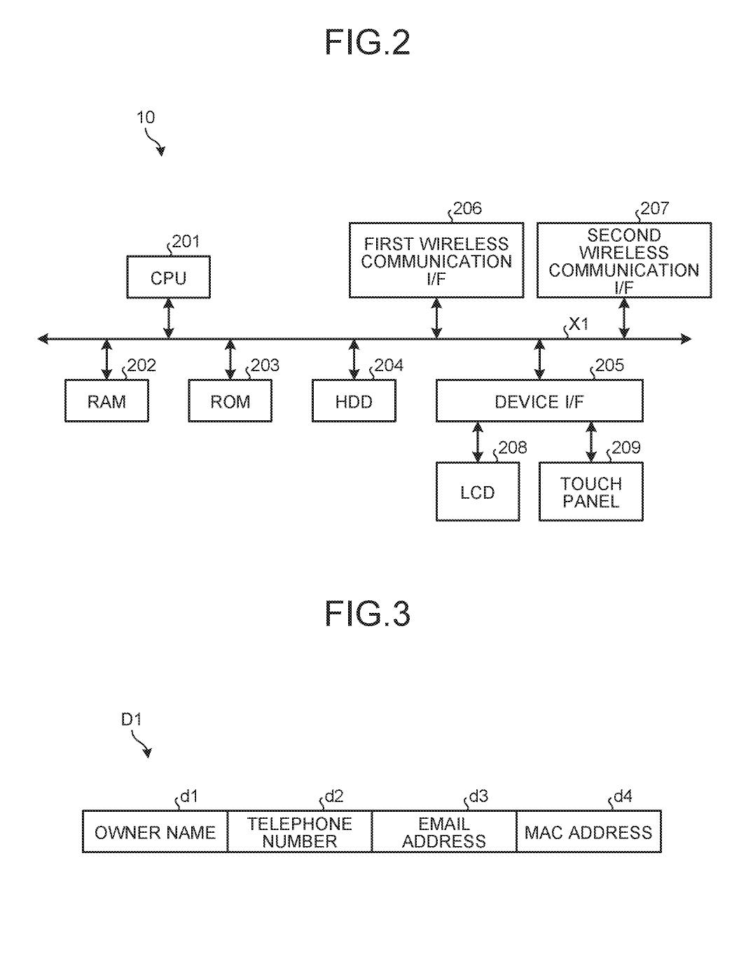

FIG. 2 is a diagram illustrating an exemplary hardware configuration of the information terminal 10. For example, the information terminal 10 is configured as a portable multifunctional device (a smart device) such as a smart phone or a tablet terminal. As illustrated in FIG. 2, the information terminal 10 includes a central processing unit (CPU) 201, a random access memory (RAM) 202, a read only memory (ROM) 203, a hard disk drive (HDD) 204, a device interface (I/F) 205, a first wireless communication I/F 206, and a second wireless communication I/F 207 that are connected to each other by a bus X1. To the device I/F 205 are connected a liquid crystal display (LCD) 208 and a touch panel 209. Other than that, for example, a communication module and a camera module are also connected.

The CPU 201 is a computing unit that comprehensively controls the operations of the entire information terminal 10. The RAM 202 is a volatile storage medium in which reading and writing of information can be done at high speeds, and is used by the CPU 201 as the work area at the time of processing information. In a predetermined area of the RAM 202 is temporarily stored the “owner identification information” that is read as a result of a reading process (described later). The ROM 203 is a non-volatile storage medium meant only for reading purposes, and is used to store computer programs such as firmware. The HDD 204 is a non-volatile storage medium enabling reading and writing of information, and is used to store computer programs such as the operating system (OS) and various applications along with a variety of data. In the information terminal 10 according to the first embodiment, for example, the Android (registered trademark) OS or the iOS (registered trademark) is installed as the OS. The applications include a web browser, a reading program for reading the “owner identification information”, and a communication program for communicating with the mediating device 11. In a predetermined memory area, the “owner identification information” is written as a result of, for example, an initial setting process performed at the time of making a contract for the information terminal 10.

The device I/F 205 is an interface for connecting the LCD 208 and the touch panel 209 to the bus X1.

The LCD 208 is an interface for displaying a variety of information. The touch panel 209 is an interface for receiving a signal of the position touched by the user, and outputting position information of that position.

The first wireless communication I/F 206 is an interface for performing wireless communication according to a first wireless communication method. In the first embodiment, the first wireless communication I/F 206 is assumed to be an interface for performing wireless communication using Bluetooth (registered trademark). Herein, Bluetooth include Bluetooth low energy (BLE) too.

The second wireless communication I/F 207 is an interface for performing wireless communication according to a second wireless communication method. In the first embodiment, the second wireless communication I/F 207 is assumed to be an interface for performing communication using Wi-Fi (registered trademark).

FIG. 3 is a diagram illustrating an exemplary data structure of the “owner identification information”. Herein, owner identification information D1 illustrated in FIG. 3 contains “owner name” d1, “telephone number” d2, “email address” d3, and “MAC address” d4. The “owner name” d1 represents information indicating the name of the owner of the information terminal 10. The “telephone number” d2 represents information indicating the telephone number of the information terminal 10. The “email address” d3 represents information indicating the email address of the information terminal 10. The “MAC address” d4 represents information indicating the MAC address of the second wireless communication I/F 207 of the information terminal 10.

Given below is the explanation of a functional configuration of the information terminal 10. In the information terminal 10, when the CPU 201 loads various computer programs from the ROM 203 or the HDD 204 into the RAM 202 and executes them, it results in the implementation of various functions.

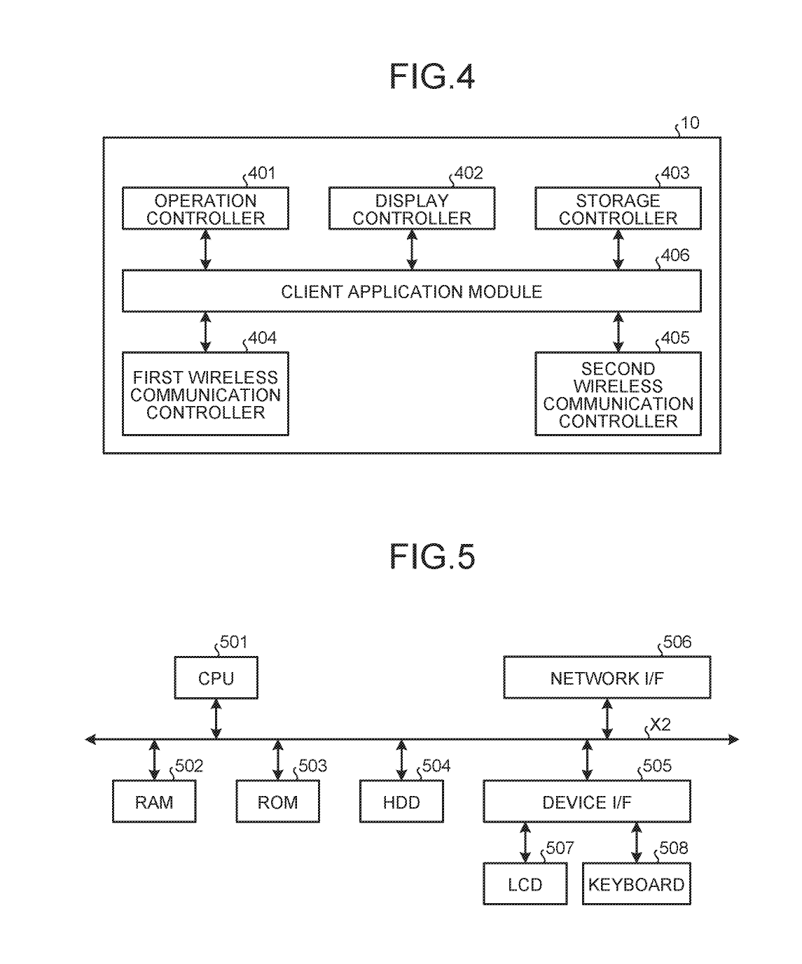

FIG. 4 is a diagram illustrating an exemplary functional configuration of the information terminal 10. As illustrated in FIG. 4, the information terminal 10 includes a process controller 401, a display controller 402, a storage controller 403, a first wireless communication controller 404, a second wireless communication controller 405, and a client application module 406. Herein, the process controller 401, the display controller 402, the storage controller 403, the first wireless communication controller 404, and the second wireless communication controller 405 are mainly embedded in the OS; while the client application module 406 is embedded in an application.

The process controller 401 receives the position information output by the touch panel 209, and notifies the client application module 406 about the position information.

The display controller 402 controls the display of the display information, which is output by the client application module 406, on the LCD 208.

The storage controller 403 controls reading or writing of information with respect to the storage areas such as the ROM 203, the RAM 202, and the HDD 204.

The first wireless communication controller 404 controls the first wireless communication I/F 206 and performs wireless communication using Bluetooth.

The second wireless communication controller 405 controls the second wireless communication I/F 207 and performs wireless communication using Wi-Fi.

The client application module 406 processes various applications. In the first embodiment, in response to the process of a photograph-ordering-application activation button that is displayed on the LCD 208, various functional units for performing processes related to viewing or ordering of photograph data get added to the client application module 406.

The added functional units include, for example, the functional unit of a web browser. Moreover, the added functional units include the functional unit related to the reading process of reading the “owner identification information”, and the functional unit related to establishing communication with the mediating device 11.

FIG. 5 is a diagram illustrating an exemplary hardware configuration of the web server device 12. As illustrated in FIG. 5, the web server device 12 includes a CPU 501, a RAM 502, a ROM 503, an HDD 504, a device I/F 505, and a network I/F 506 that are connected to each other by a bus X2. Moreover, to the device I/F 505 are connected an LCD 507 and a keyboard 508.

The CPU 501 is a computing unit that comprehensively controls the operations of the entire web server device 12. The RAM 502 is a volatile storage medium in which reading and writing of information can be done at high speeds, and is used by the CPU 501 as the work area at the time of processing information. The ROM 503 is a non-volatile storage medium meant only for reading purposes, and is used to store computer programs such as firmware. The HDD 504 is a non-volatile storage medium enabling reading and writing of information, and is used to store various computer programs and a variety of data. The various computer programs include the OS and applications. The various computer programs include web software; data software; and a computer program for performing, in cooperation with the other software, processes related to viewing or ordering of photograph data. The data contains data files of a database and web screen data.

The device I/F 505 is an interface for connecting the LCD 507 and the keyboard 508 to the bus X2. The LCD 507 is an interface for displaying a variety of information. The keyboard 508 is an interface that includes various input keys, and that outputs input-key information of the pressed input keys.

The network I/F 506 is a network interface such as Ethernet (registered trademark) that establishes connection with the network 14 and performs communication with the devices connected to the network 14.

Given below is the explanation of a table structure of the database. The database includes an individual information table, a connection information table, and a photograph order information table. The individual information table is used to manage the second pair information containing the “owner identification information” and the “owner ID”. The connection information table is used to manage connection information indicating the connection status of the information terminal 10 and the file-sharing server devices 13. The photograph order information table is used to manage order information of photograph data. Besides, although the details are not explained, the database includes a table for managing device information that indicates the IP addresses of devices along with the status and the available functions of the devices.

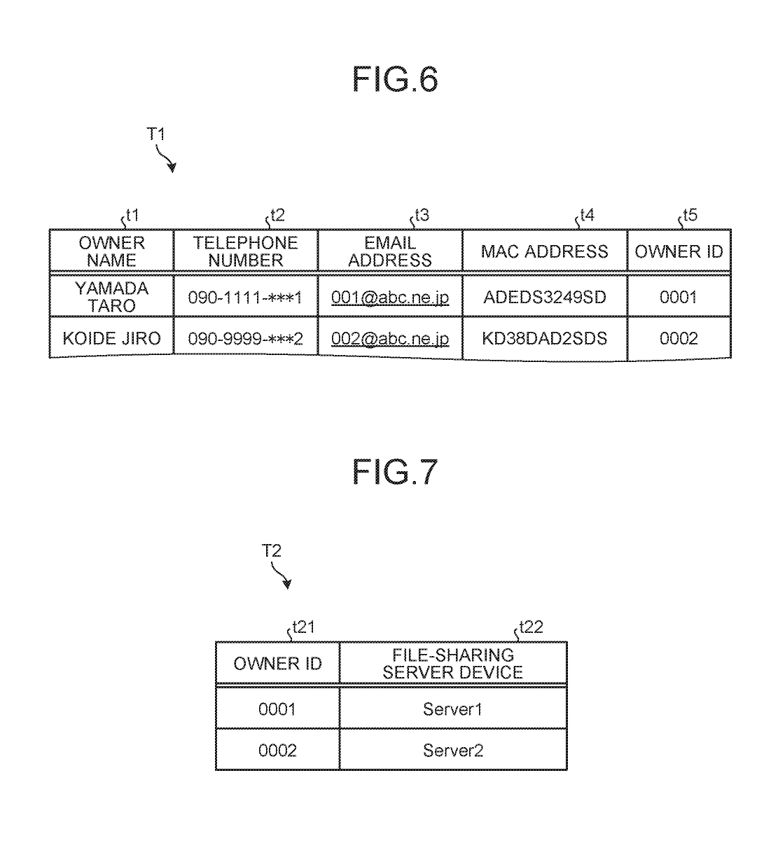

FIG. 6 is a diagram illustrating an exemplary data structure of the individual identification information table. An individual identification information table T1 includes the following setting items: “owner name” t1, “telephone number” t2, “email address” t3, “MAC address” t4, and “owner ID” t5.

FIG. 7 is a diagram illustrating an exemplary data structure of the connection information table. A connection information table T2 illustrated in FIG. 7 includes the following setting items: “owner ID” t21 and “file-sharing server device” t22. In the “file-sharing server device” t22 is set the server name of the file-sharing server device 13 from which photographs are to be viewed using the information terminal 10 having the “owner ID”.

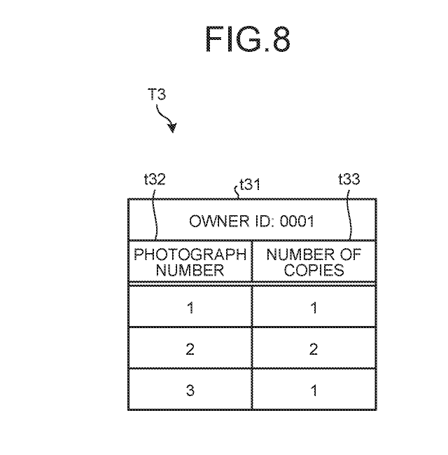

FIG. 8 is a diagram illustrating an exemplary data structure of the photograph order information table. A photograph order information table T3 illustrated in FIG. 8 is maintained for each owner ID. The photograph order information table T3 includes the following setting items: “owner ID” t31, “photograph number” t32, and “number of copies” t33.

Given below is the explanation about a screen structure of web screen information that is stored in an HDD by the web server device 12. The web screen information contains screen information of a “preregistration screen”, screen information of an “owner ID input screen”, screen information of a “search input form screen”, and screen information of a “photograph ordering screen”. The “preregistration screen” is a screen for enabling the administrator of the web server device 12 to register the second pair information in the individual identification information table T1 (see FIG. 6). The “owner ID input screen” is a screen for enabling the operator of the information terminal 10 to input the “owner ID” at the time of issuing a request for viewing or ordering photograph data using the information terminal 10. The “search input form screen” is a screen for enabling the operator of the information terminal 10 to input the search condition for narrowing down the photograph data. The “photograph ordering screen” is a screen for displaying list information of photographs on the information terminal 10 and enabling ordering of photographs. Besides, the web screen information contains screen information such as a top screen that is displayed at the beginning, and contains an error screen that is displayed at the time of an error. In the top screen, various items are included, and links (paths) to the corresponding screens of the items are provided. The items also include “preregistration” and “viewing of photographs”.

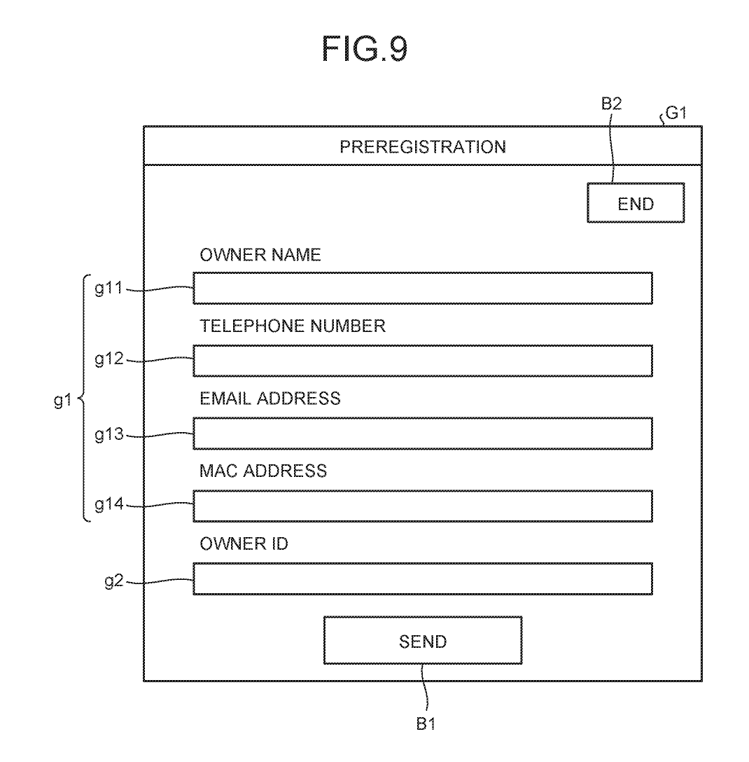

FIG. 9 is a diagram illustrating an exemplary screen structure of the preregistration screen. A preregistration screen G1 illustrated in FIG. 9 includes an “owner identification information” entry field g1 and an “owner ID” entry field g2 as the input fields for inputting the second pair information. In the “owner identification information” entry field g1 includes an “owner name” entry field g11, a “telephone number” entry field g12, an “email address” entry field g13, and a “MAC address” entry field g14. The second pair information is received in advance by the administrator in the form of an application or an email including the “owner identification information” and the “owner ID” from the owner of the information terminal 10.

The preregistration screen G1 further includes a send button B1 and an end button B2. The send button B1 is a process button for giving an instruction to issue a registration request for registering input information that is input in the “owner identification information” entry field g1 and the “owner ID” entry field g2 (i.e., a registration request for registering the second pair information). The end button B2 is a process button for giving an instruction to issue an end request for ending the preregistration screen G1.

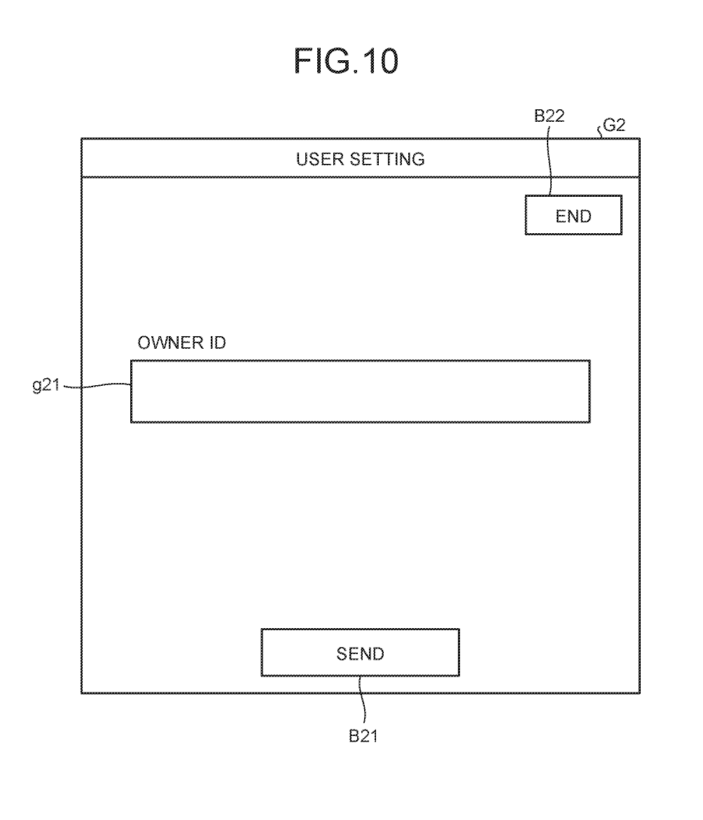

FIG. 10 is a diagram illustrating an exemplary screen structure of the owner ID input screen. An owner ID input screen G2 includes an “owner ID” entry field g21, a send button B21, and an end button B22. The send button B21 is a process button for giving an instruction to issue a verification request (a photograph viewing request) for collating the input information (the owner ID) input in the “owner ID” entry field g21 with the “owner identification information” read from the information terminal 10 in which the owner ID input screen G2 is being displayed. The end button B22 is a process button for giving an instruction to issue an end request for ending the owner ID input screen G2.

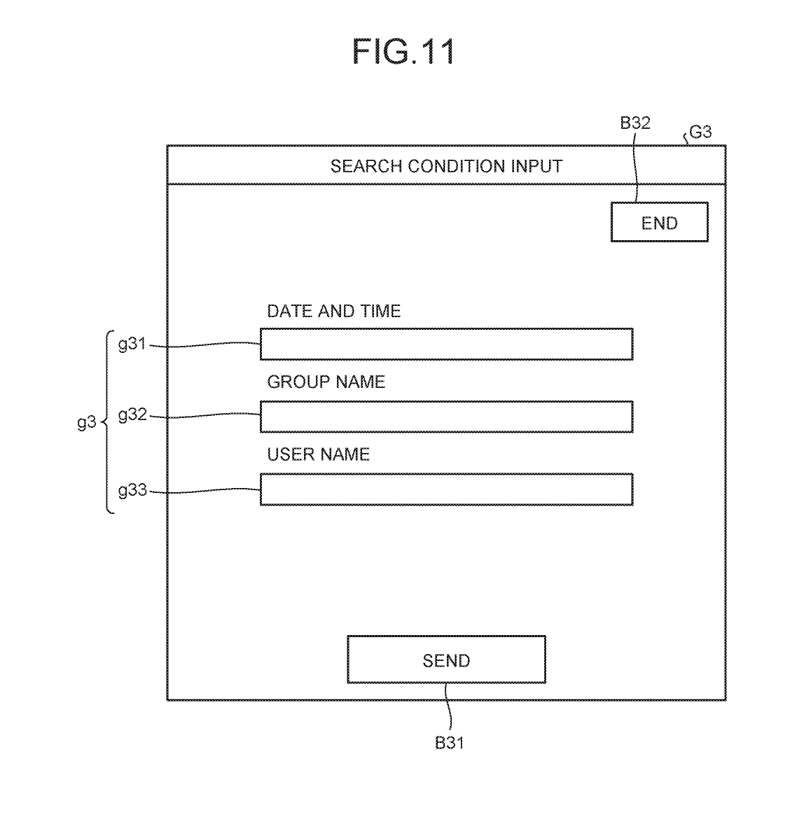

FIG. 11 is a diagram illustrating an exemplary screen structure of the search input form screen. A search input form screen G3 illustrated in FIG. 11 includes a “search condition” entry field g3, a send button B31, and an end button B32. The “search condition” entry field g3 is meant for specifying the search condition to narrow down the photograph data; and includes a “date and time” entry field g31, a “group name” entry field g32, and a “user name” entry field g33. The “date and time” entry field g31 is meant for narrowing down the photograph data according to the date and time of photography; and is used to input the date and time to which the photograph data is to be narrowed down to. The “group name” entry field g32 is meant for narrowing down the photograph data of the group that is allowed for viewing or ordering (for example, the photographs taken in the group); and is used to input the group name to which the photograph data is to be narrowed down to. The “user name” entry field g33 is meant for narrowing down the photograph data of the user who is allowed to view or order (for example, the photographs in which the user appears); and is used to input the user name to which the photograph data is to be narrowed down to.

The send button B31 is a process button for giving an instruction to issue a view request that includes a search condition as input in the “search condition” entry field g3. The end button B32 is a process button for giving an instruction to issue an end request for ending the search input form screen G3.

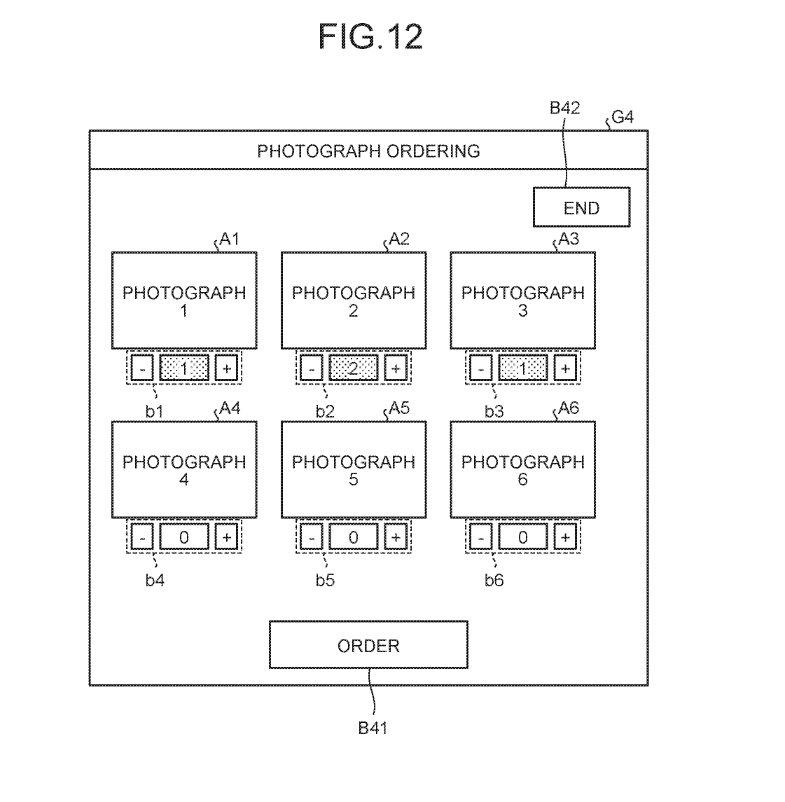

FIG. 12 is a diagram illustrating an exemplary screen structure of the photograph ordering screen. A photograph ordering screen G4 illustrated in FIG. 12 includes thumbnail areas A1, A2, . . . , and A6 for listing thumbnail data of photographs (thinned photograph data); selection display objects b1, b2, . . . , and b6 for selectively displaying the number of copies ordered for each photograph; an order button B41; and an end button B42.

Each of the selection display objects b1, b2, . . . , and b6 includes a “+” button for instructing an increase in the number of selected copies, a “−” button for instructing a decrease in the number of selected copies, and a count display box for displaying the count result of the selected count.

The order button B41 is a process button for giving an instruction to issue an order request to the web server device 12. In response to a process of the order button B41, correspondence information between photograph number information of the photographs, which are placed in the thumbnail display areas A1, A2, . . . , and A6 at the time of the operation, and display count information of the count display boxes is finalized as order information to be included in the order request.

The end button B42 is a process button for giving an instruction to issue an end request for ending the photograph ordering screen G4.

Given below is the explanation of a functional configuration of the web server device 12. In the web server device 12, the CPU 501 loads various computer programs from the ROM 503 or the HDD 504 into the RAM 502 and executes them so that various functions get implemented.

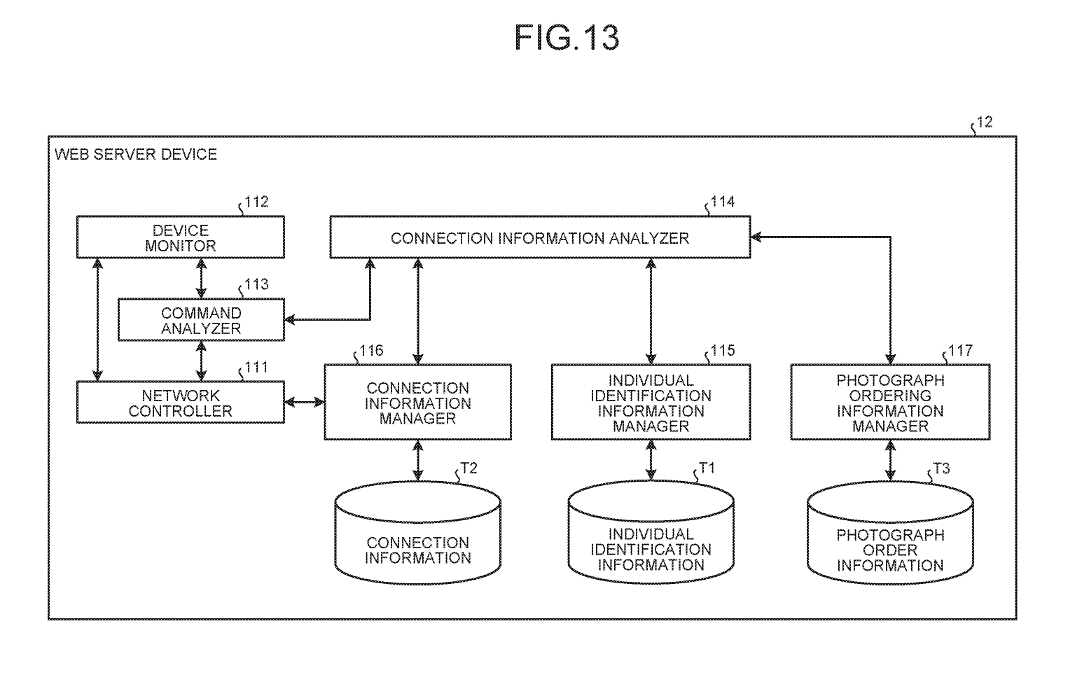

FIG. 13 is a diagram illustrating an exemplary functional configuration of the web server device 12. As illustrated in FIG. 13, the web server device 12 includes a network controller 111, a device monitor 112, a command analyzer 113, a connection information analyzer 114, an individual identification information manager 115, a connection information manager 116, and a photograph ordering information manager 117.

The network controller 111 performs communication with various connection devices in the network 14 via the network I/F 506, and transmits and receives data. For example, the network controller 111 acquires reception data from the network I/F 506 and transmits the reception data to the relevant functional unit; and sets the destination IP address in the data received from various functional units and transmits transmission data to the network I/F 506.

The device monitor 112 monitors the connection devices and the state thereof in the network 14 and manages the available functions. More particularly, the device monitor 112 periodically acquires, via the network controller 111, information about the state of the devices and the available functions from the connection devices in the network 14. Then, based on the latest acquired information, the device monitor 112 manages, in the form of a table, device information indicating the IP addresses of the devices and indicating the state and the available functions of the devices.

The command analyzer 113 analyzes the command included in the request data (an HTTP request), and requests the connection information analyzer 114 to process the request. Moreover, the command analyzer 113 acquires, from the device monitor 112, the device information of the devices having the functions relevant to the processing of the request, and transmits the device information to the connection information analyzer 114. Then, the command analyzer 113 transmits, to the network controller 111, response data (an HTTP response) that is transmitted back by the connection information analyzer 114 in response to the request processing request.

The connection information analyzer 114 (a functional unit that functions as a “request processor” along with mainly the individual identification information manager 115, the connection information manager 116, and the photograph ordering information manager 117) generates response data. For example, when the command is a request for acquiring a predetermined web screen, the connection information analyzer 114 reads the web screen from the HDD 504 and transmits it as response data to the command analyzer 113. Examples of the web screen include the top screen, the preregistration screen G1 (see FIG. 9) whose link is provided in the top screen, and the owner ID input screen G2 (see FIG. 10) whose link is provided in the top screen.

Meanwhile, when the command is a request for registering the individual identification information, the connection information analyzer 114 extracts the second pair information from the request data and instructs the individual identification information manager 115 to register the second pair information. Then, the connection information analyzer 114 reads, from the HDD 504, a web screen indicating the result of registrability based on the result of registrability received in return from the individual identification information manager 115; and transmits the web screen as response data to the command analyzer 113.

When the command is a photograph viewing request, the connection information analyzer 114 extracts the first pair information from the request data and instructs the individual identification information manager 115 to collate the sets of pair information (the first pair information and the second pair information). If the individual identification information manager 115 returns the result indicating that the sets of pair information (the first pair information and the second pair information) are identical, then the connection information analyzer 114 reads the search input form screen G3 (see FIG. 11) from the HDD 504, and transmits it as response data to the command analyzer 113. On the other hand, if the individual identification information manager 115 returns the result indicating that the sets of pair information (the first pair information and the second pair information) are not identical, then the connection information analyzer 114 reads an error screen, which indicates that photographs cannot be viewed, from the HDD 504 and transmits the error screen as response data to the command analyzer 113.

When the command is a request for acquiring list information of photographs, the connection information analyzer 114 extracts the search condition from the request data and instructs the connection information manager 116 to acquire the list information of photographs. When the connection information manager 116 transmits back the list information of photographs, the connection information analyzer 114 reads the photograph ordering screen G4 (see FIG. 12) from the HDD 504, sets the list information of photographs in the photograph ordering screen G4, and notifies the command analyzer 113 about the list information of photographs as response data.

When the command is a photograph ordering request, the connection information analyzer 114 extracts the order information from the request data and instructs the photograph ordering information manager 117 to generate the photograph order information table T3 (see FIG. 8) corresponding to the owner ID of the information terminal 10 that issued the request and to register the order information in the photograph order information table T3. The connection information analyzer 114 reads, from the HDD 504, the web screen that indicates the result of registrability based on the result of registrability transmitted back by the photograph ordering information manager 117, and transmits the web screen as response data to the command analyzer 113.

The individual identification information manager 115 manages the individual identification information table T1 (see FIG. 6) and performs search/registration/updating/deletion of information in the individual identification information table T1. When a search instruction and the first pair information is received from the connection information analyzer 114, the individual identification information manager 115 collates the first pair information with the second pair information that is registered in the individual identification information table T1, and transmits information indicating whether or not there is a match as the search result to the connection information analyzer 114.

The connection information manager 116 acquires the list information of photographs from one of the file-sharing server devices 13 via the network controller 111. Moreover, the connection information manager 116 associates the information terminal 10, which requested for the list information of photographs, with the file-sharing server device 13, from which the list information of photographs is acquired, using the identification information in the connection information table T2 (see FIG. 7), and manages the relation of connection.

The photograph ordering information manager 117 associates “order information” such as the photograph numbers and the ordered number of copies with “owner identification information of the person who ordered” in the photograph order information table T3 (see FIG. 8), and manages that information. In the first embodiment, the photograph ordering information manager 117 sets the order information, which is extracted by the connection information analyzer 114 from the request data (the photograph order request data), as the abovementioned “order information” in the photograph ordering information table T3. Moreover, the photograph ordering information manager 117 acquires the owner identification information corresponding to the owner ID of the information terminal 10, which issued the request data, from the individual identification information manager 115, and sets the acquired owner identification information as the abovementioned “owner identification information of the person who ordered” in the photograph ordering information table T3.

The mediating device 11 is a device having a computer configuration including a CPU, a ROM, and a RAM. Moreover, the mediating device 11 includes a Bluetooth (registered trademark) interface and a Wi-Fi (registered trademark) interface that enable establishing communication with the information terminal 10. The mediating device 11 has the DHCP server function; and assigns an IP address to the information terminal 10, from which a connection request is received, in a static manner or a dynamic manner. Moreover, the mediating device 11 stores the connection destination information (the IP address) of the web server device 12; transmits the connection destination information of the web server device 12 to the information terminal 10 from which a connection request is received; and mediates the communication between the information terminal 10 and the web server device 12.

Each file-sharing server device 13 is a device having a computer configuration including a CPU, a ROM, and a RAM; and includes an Ethernet interface that enables establishing connection with the network 14. The file-sharing server device 13 includes a large-capacity storage device such as an HDD for storing photograph data or thumbnail data; and manages the stored photograph data and the stored thumbnail data according to items such as the date and time of photography, the user name, and the group name. When request data for requesting list information of photographs is received from the web server device 12, the file-sharing server device 13 extracts the photograph numbers and the thumbnail data of the photographs corresponding to the search conditions (the date and time, the user name, and the group name) specified in the request data, and transmits the extracted photograph numbers and thumbnail data to the web server device 12.

Given below is the sequence of processes related to viewing or ordering of photographs as performed in the photograph ordering system 1. Firstly, the explanation is given about the sequence of processes by which the information terminal 10 participates in the network 14 via the mediating device 11.

Firstly, the user presses an activation button that is installed in the information terminal 10 and that is meant for activating a photograph ordering application. In response to the pressing of the activation button meant for activating the photograph ordering application, the information terminal 10 reads a computer program for the photograph ordering application and implements “various functional units that perform processes related to viewing or ordering of photograph data”. Then, the client application module 406 reads the “owner identification information” from the HDD 204 using the storage controller 403, and temporarily stores the “owner identification information” in a predetermined area of the RAM 202.

When the user touches the mediating device 11 using the body of the information terminal 10, the first wireless communication controller 404 starts responding to an advertisement packet signal received by the first wireless communication I/F 206, and establishes wireless communication with the mediating device 11 using Bluetooth that represents the first communication method. As a result of the establishment of wireless communication using Bluetooth, the mediating device 11 transmits, to the information terminal 10, a PIN code (PIN stands for Personal Identification Number) of the WPS method (WPS stands for Wi-Fi Protected Setup) of Wi-Fi that represents the second communication method. Then, the information terminal 10 and the mediating device 11 perform setup using the PIN code, thereby resulting in the establishment of wireless communication using Wi-Fi between the information terminal 10 and the mediating device 11. During the establishment of Wi-Fi communication, the mediating device 11 assigns an IP address to the information terminal 10, thereby enabling the information terminal 10 to perform communication with the devices in the network 14.

Given below is the sequence of processes performed by the information terminal 10 and the web server device 12 at the time when the information terminal 10 accesses the web server device 12 after the establishment of Wi-Fi communication. In the following explanation, although not explicitly mentioned, it is assumed that the communication performed between the information terminal 10 and the mediating device 11 is performed using Wi-Fi.

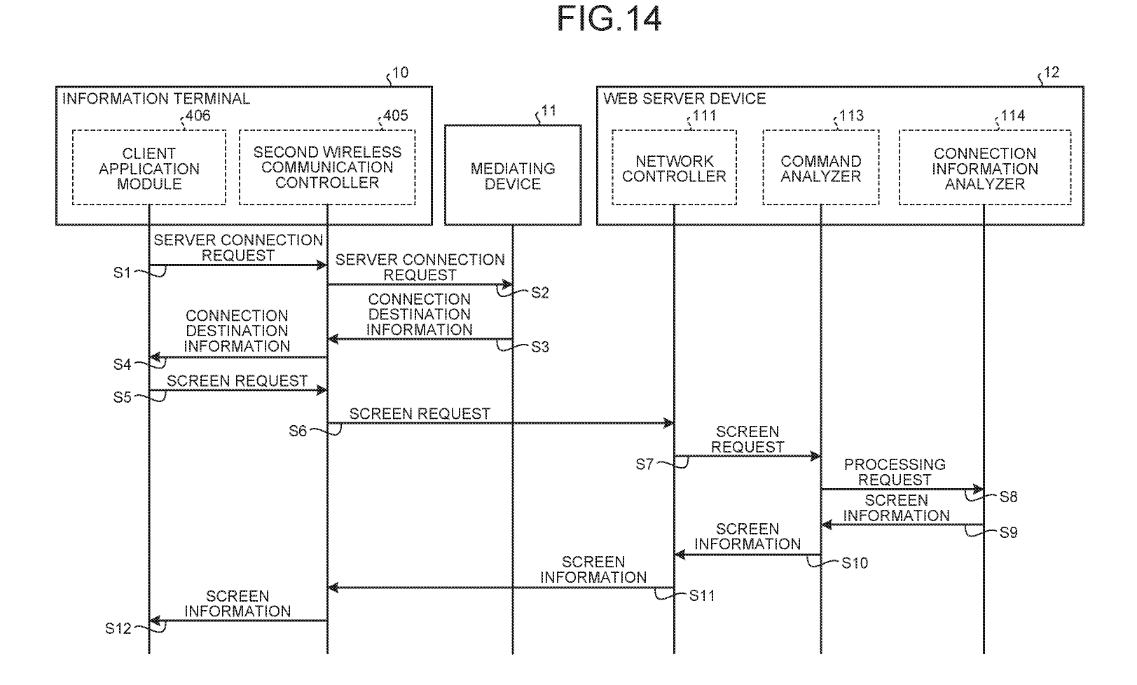

FIG. 14 is a diagram illustrating an exemplary sequence of processes performed by the information terminal 10 and the web server device 12 at the time when the information terminal 10 accesses the web server device 12.

Firstly, in the information terminal 10, the client application module 406 instructs the second wireless communication controller 405 to issue a server connection request (S1).

The second wireless communication controller 405 issues a server connection request to the mediating device 11 via the second wireless communication I/F 207 (S2).

Upon receiving the server connection request from the information terminal 10, the mediating device 11 transmits pre-stored connection destination information (IP address) of the web server device 12 to the information terminal 10 that issued the request (S3).

In the information terminal 10, the second wireless communication controller 405 acquires the connection destination information, which is transmitted by the mediating device 11, via the second wireless communication I/F 207; and notifies the client application module 406 about acquiring the connection destination information (S4).

Then, the client application module 406 instructs the second wireless communication controller 405 to issue a screen request to the web server device 12 (S5).

The second wireless communication controller 405 issues a screen request to the destination indicated by the connection destination information of the web server device 12 via the second wireless communication I/F 207 (S6). As a result, the screen request is transmitted from the mediating device 11 to the network 14 in which the web server device 12 is installed, and then reaches the web server device 12.

In the web server device 12, the network controller 111 reads the reception data received by the network I/F 506, and transmits the reception data to the command analyzer 113 (S7).

The command analyzer 113 analyzes the command in the reception data, transmits the analysis information to the connection information analyzer 114, and requests the connection information analyzer 114 to process the analysis information (S8).

From the analysis information indicating the screen request, the connection information analyzer 114 determines that the requested web screen is the top screen and transmits a response indicating the top screen to the command analyzer 113 (S9).

According to the notification from the connection information analyzer 114, the command analyzer 113 instructs the network controller 111 to respond using the top screen (S10).

According to the instruction from the command analyzer 113, the network controller 111 transmits the top screen to the source of request via the network I/F 506 (S11). With that, the top screen is transmitted from the mediating device 11 to the information terminal 10, and is delivered to the information terminal 10.

In the information terminal 10, the second wireless communication controller 405 acquires the top screen, which is transmitted from the mediating device 11, via the second wireless communication I/F 207; and notifies the client application module 406 about acquiring the top screen (S12). With that, the client application module 406 displays the top screen on the LCD 208 using the display controller 402.

Also in the case in which screen transition is to be performed to change the top screen displayed on the LCD 208; basically the flow of processes from Steps S5 to S12 is followed, so that the information terminal 10 acquires a web screen from the web server device 12 and displays it on the LCD 208.

Given below is the explanation of a sequence of a preregistration process after the display in the information terminal 10 is changed to the preregistration screen by selecting the preregistration item in the top screen.

Regarding the preregistration operation, the administrator of the web server device 12 receives registration application information of the “owner identification information” and the “owner ID” from the owner of the information terminal 10 via telephone, or an email, or a registration application form; and the preregistration process is performed from the information terminal 10 of the administrator. Meanwhile, in order to prevent unauthorized registration, the web server device 12 can authenticate the administrator at the time of transmitting a registration screen.

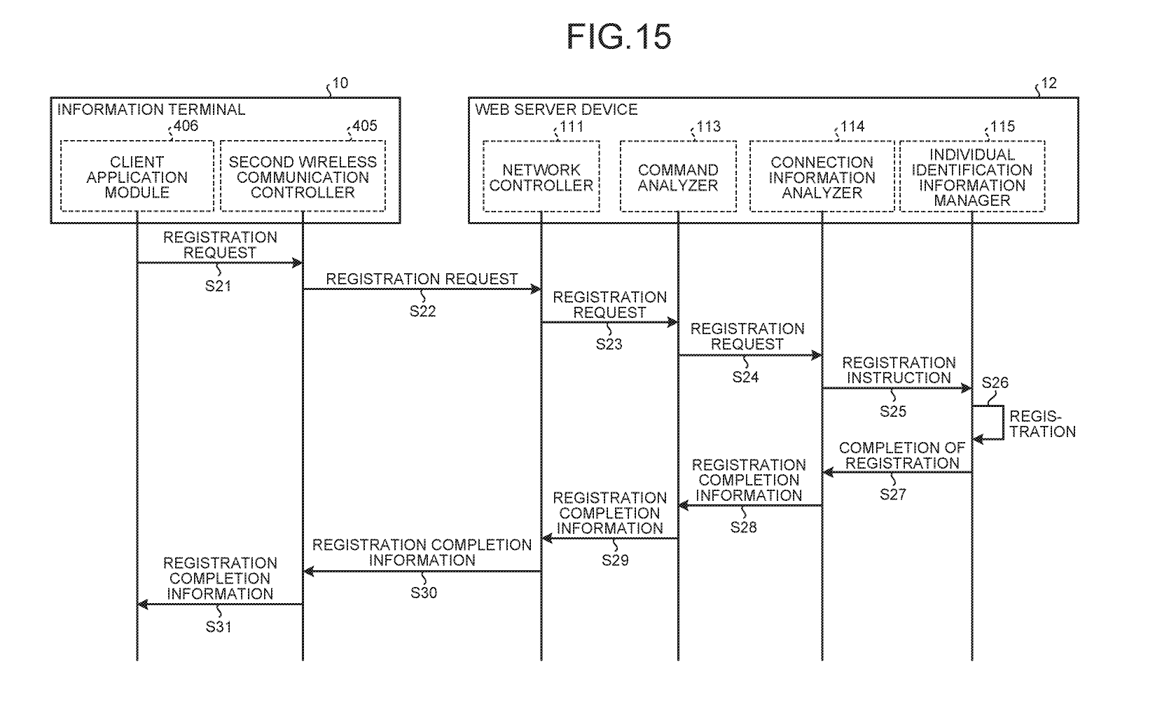

FIG. 15 is a diagram illustrating an exemplary sequence of the preregistration process performed by the information terminal 10 of the administrator and the web server device 12. Meanwhile, the processes related to the communication with the mediating device 11 are not illustrated in FIG. 15. Moreover, although not explicitly mentioned, it is assumed that the mediating device 11 mediates the communication between the information terminal 10 and the web server device 12.

Firstly, in the information terminal 10, the administrator inputs the “owner identification information” and the “owner ID” in a registration screen and presses a registration button, so that the client application module 406 instructs the second wireless communication controller 405 to issue a registration request to the web server device 12 (S21).

The second wireless communication controller 405 issues a registration request to the destination indicated by the connection destination information of the web server device 12 via the second wireless communication I/F 207 (S22). As a result, the registration request is transmitted from the mediating device 11 to the network 14 in which the web server device 12 is installed, and then reaches the web server device 12.

In the web server device 12, the network controller 111 reads the reception data received by the network I/F 506, and transmits the reception data to the command analyzer 113 (S23). Then, the command analyzer 113 analyzes the command specified in the reception data, and transmits analysis information to the connection information analyzer 114 (S24).

The connection information analyzer 114 extracts, from the analysis information indicating the registration request, the “owner identification information” and the “owner ID” included in the request data; and instructs the individual identification information manager 115 to register that information (S25).

The individual identification information manager 115 registers the “owner identification information” and the “owner ID” in a corresponding manner in the individual identification information table T1 (S26).

Upon completing the registration, the individual identification information manager 115 transmits back information indicating the completion of registration to the connection information analyzer 114 (S27).

The connection information analyzer 114 transmits back information indicating the completion of registration as response information to the command analyzer 113 (S28).

The command analyzer 113 instructs the network controller 111 to transmit registration completion information (S29).

The network controller 111 transmits back registration completion information to the information terminal 10 (S30).

The second wireless communication controller 405 notifies the client application module 406 about the registration completion information (S31).

Given below is the explanation of a sequence of a viewing process after the display in the information terminal 10 is changed to the owner ID input screen by selecting the item for viewing in the top screen.

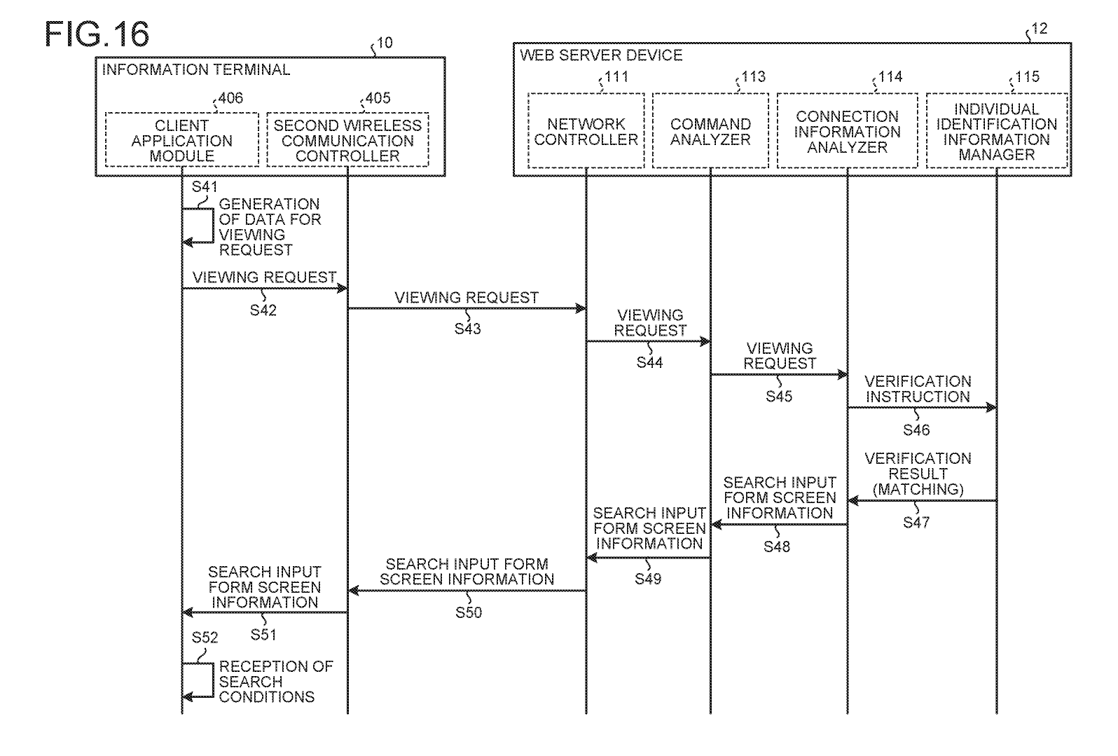

FIGS. 16 to 18 are diagrams illustrating an exemplary sequence of a viewing operation. Meanwhile, the processes related to the communication with the mediating device 11 are not illustrated in FIG. 15. Moreover, although not explicitly mentioned, it is assumed that the mediating device 11 mediates the communication between the information terminal 10 and the web server device 12.

Firstly, when the send button is input in the owner ID input screen, the client application module 406 generates data of a photograph viewing request (S41). More particularly, the client application module 406 generates data of a photograph viewing request including the “owner identification information” that is temporarily stored in the RAM 202 at the time of activating the photograph ordering application, and including the owner ID that is input by the user in the owner ID input screen.

Then, the client application module 406 instructs the second wireless communication controller 405 to issue a photograph viewing request to the web server device 12 (S42).

Subsequently, the second wireless communication controller 405 issues a photograph viewing request to the destination indicated by the connection destination information of the web server device 12 via the second wireless communication I/F 207 (S43).

In the web server device 12, the network controller 111 reads the reception data received by the network I/F 506, and transmits the reception data to the command analyzer 113 (S44).

The command analyzer 113 analyzes the command specified in the reception data, and transmits analysis information to the connection information analyzer 114 (S45).

The connection information analyzer 114 extracts, from the analysis information indicating the photograph viewing request, the first pair information containing the “owner identification information” and the “owner ID” as included in the request data; and performs a photograph viewing operation, which is specified in the request data, in the following manner. Firstly, the connection information analyzer 114 transmits the first pair information to the individual identification information manager 115 and requests for verification (S46). The individual identification information manager 115 searches the individual identification information table T1 for the record having the same combination as the first pair information, and transmits the verification result to the connection information analyzer 114 (S47).

When the verification result indicates “matching”, the connection information analyzer 114 transmits, as a response to the source of request, screen information of the search input form screen to the command analyzer 113 (S48).

The command analyzer 113 instructs the network controller 111 to transmit the search input form screen (S49).

The network controller 111 transmits the search input form screen to the information terminal 10, which is the source of request, via the network I/F 506 (S50).

In the information terminal 10, the second wireless communication controller 405 acquires the search input form screen via the second wireless communication I/F 207, and notifies the client application module 406 about acquiring the search input form screen (S51). With that, the client application module 406 displays the search input form screen on the LCD 208 using the display controller 402, and receives input of search conditions via the process controller 401 (S52).

Meanwhile, if the verification result at Step S47 indicates “not matching”, then the connection information analyzer 114 transmits, as a response to the source of the photograph viewing request, screen information of an error screen indicating a warning that photographs cannot be viewed to the command analyzer 113. As a result, the screen information of the error screen indicating a warning gets transmitted by the network controller 111 to the information terminal 10 representing the source of request, and the error screen is displayed on the LCD 208 of the information terminal 10.

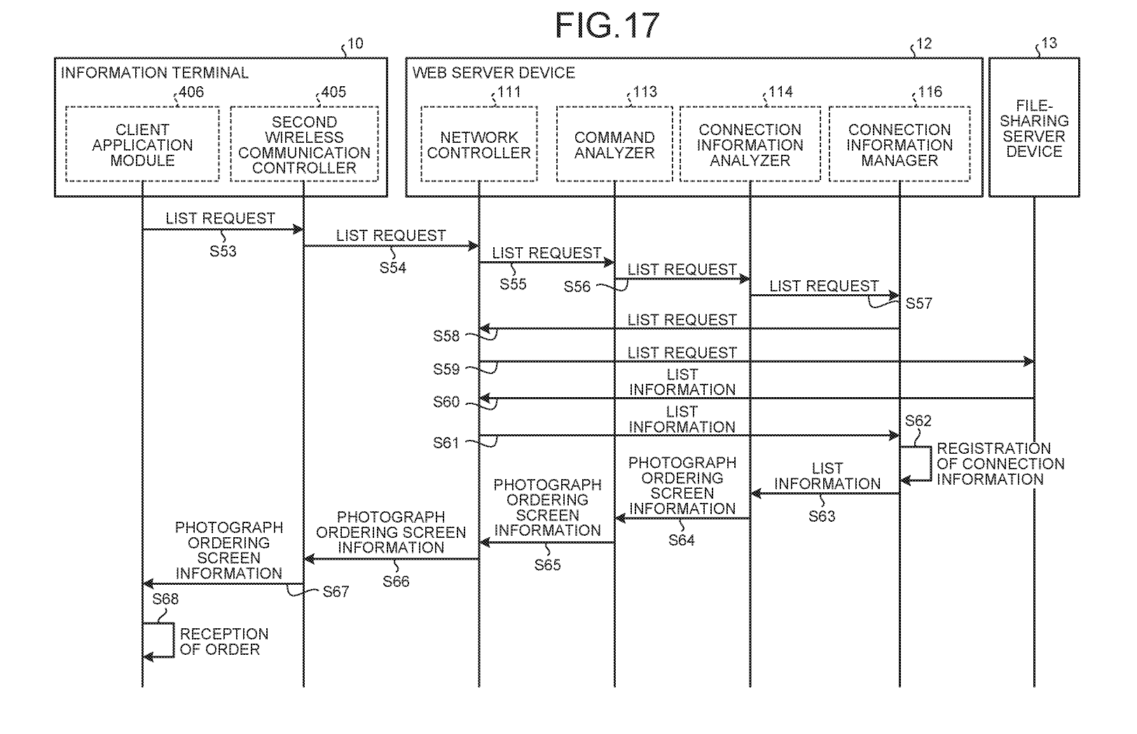

Explained below with reference to FIG. 17 is a sequence of processes following the reception of a search condition at Step S52.

When the user presses a send button on the search input form screen, the client application module 406 instructs the second wireless communication controller 405 to issue a photograph list acquiring request to the web server device 12 (S53). The data of the photograph list acquiring request contains the search condition input by the user.

Then, the second wireless communication controller 405 transmits a photograph list acquiring request to the destination indicated by the connection destination information of the web server device 12 via the second wireless communication I/F 207 (S54).

In the web server device 12, the network controller 111 reads the reception data received by the network I/F 506, and transmits the reception data to the command analyzer 113 (S55).

The command analyzer 113 transmits analysis information to the connection information analyzer 114, and requests the connection information analyzer 114 to process the analysis information (S56).

The connection information analyzer 114 extracts, from the analysis information indicating the photograph list acquiring request, the “search condition” and the “owner ID” included in the request data; transmits the “search condition” and the “owner ID” to the connection information manager 116; and requests the connection information manager 116 to perform a photograph list acquiring process as specified in the request data (S57).

The connection information manager 116 generates a photograph list acquiring request and instructs the network controller 111 to transmit the photograph list acquiring request to the file-sharing server device 13 (S58).

The network controller 111 acquires connection destination information of the file-sharing server device 13 from the device monitor 112, and transmits the photograph list acquiring request to the file-sharing server device 13 via the network I/F 506 (S59).

Upon receiving the photograph list acquiring request from the web server device 12, the file-sharing server device 13 transmits the photograph numbers and the thumbnail data of the requested photographs to the web server device 12 (S60). More particularly, the file-sharing server device 13 extracts the photograph numbers and the thumbnail data of the requested photographs according to the search condition included in the photograph list acquiring request, and transmits the extracted information to the web server device 12.

In the web server device 12, the network controller 111 reads the reception data, which is received from the file-sharing server device 13, from the network I/F 506 and transmits the reception data to the connection information manager 116 (S61).

The connection information manager 116 registers the “owner ID” in the connection information table T2 for the purpose of associating the photograph acquiring destination with the individual identification information (S62). Then, the connection information manager 116 transmits, to the connection information analyzer 114, list information representing the result of the requested photograph list acquiring process (S63).

The connection information analyzer 114 transmits, to the command analyzer 113 as a response to the source of the photograph list acquiring request, the photograph ordering screen having the list information set therein (S64).

The command analyzer 113 instructs the network controller 111 to transmit the photograph ordering screen having the list information set therein (S65).

The network controller 111 transmits the photograph ordering screen having the list information set therein to the information terminal 10, which represents the source of request, via the network I/F 506 (S66).

In the information terminal 10, the second wireless communication controller 405 acquires the photograph ordering screen, which has the list information set therein, via the second wireless communication I/F; and notifies the client application module 406 about acquiring the photograph ordering screen (S67). With that, the client application module 406 displays the photograph ordering screen, which has the list information set therein, on the LCD 208 via the display controller 402, and receives an ordering process from the user via the process controller 401 (S68).

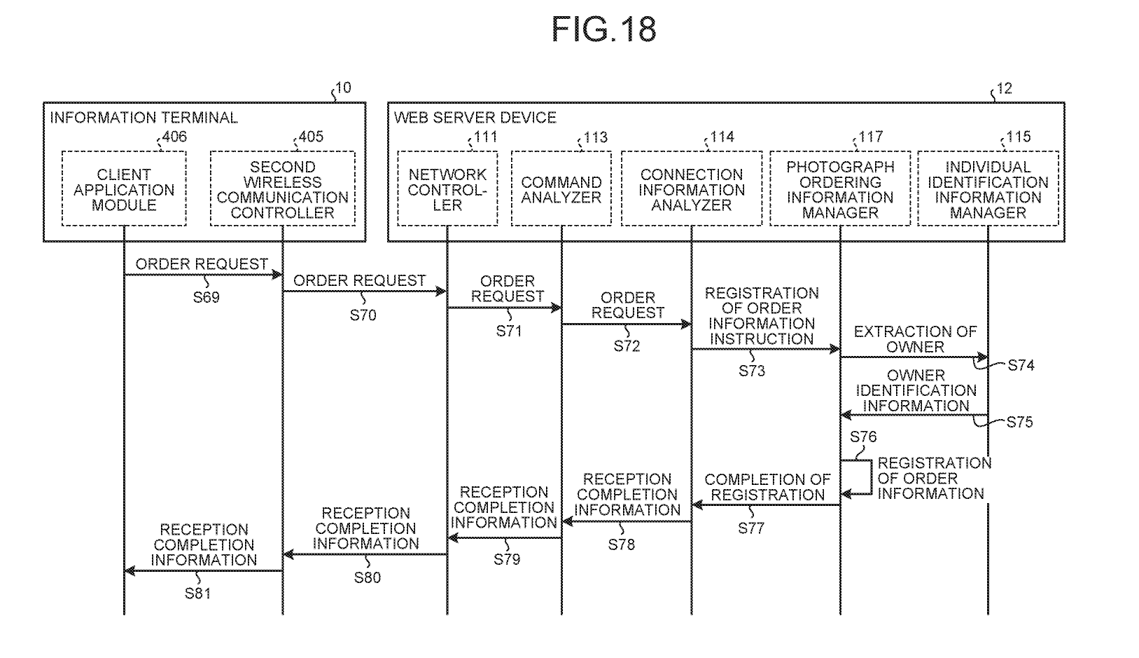

Explained below with reference to FIG. 18 is a sequence of processes following the reception of an ordering process at Step S68.

When the user presses the order button on the photograph ordering screen, the client application module 406 instructs the second wireless communication controller 405 to issue an order request to the web server device 12 (S69). The data of the order request contains order information input by the user.

Then, the second wireless communication controller 405 transmits the order request to the destination indicated by the connection destination information of the web server device 12 via the second wireless communication I/F 207 (S70).

In the web server device 12, the network controller 111 reads the reception data received by the network I/F 506, and transmits the reception data to the command analyzer 113 (S71).

The command analyzer 113 analyzes the command specified in the reception data, transmits analysis information to the connection information analyzer 114, and requests the connection information analyzer 114 to process the analysis information (S72).

The connection information analyzer 114 extracts, from the analysis information indicating the order request, the order information and the “owner ID” included in the request data, and requests the photograph ordering information manager 117 to register the “owner identification information” and the “order information” (S73).

The photograph ordering information manager 117 transmits the “owner ID” to the individual identification information manager 115 and requests the individual identification information manager 115 to extract the “owner identification information” (S74).

The individual identification information manager 115 extracts the relevant “owner identification information” from the individual identification information table T1 and transmits the “owner identification information” to the photograph ordering information manager 117 (S75).

The photograph ordering information manager 117 registers the “owner identification information” and the “order information” in a corresponding manner in the photograph order information table T3 (S76).

Then, the photograph ordering information manager 117 notifies the connection information analyzer 114 about the completion of registration (S77). Subsequently, the connection information analyzer 114 transmits reception completion information to the client application module 406 according to a flow illustrated in Steps S78 to S81.

Given below is the explanation of a reading process of reading the “owner identification information” in the case in which, in the information terminal 10, the OS and the client application module 406 constitute a “read restriction canceller” for cancelling read restrictions imposed on the “owner identification information” and constitute a “notifying unit” for notifying the operator of the information terminal 10 about the information indicating that the web server device 12 would not perform processes regarding the target for charging.

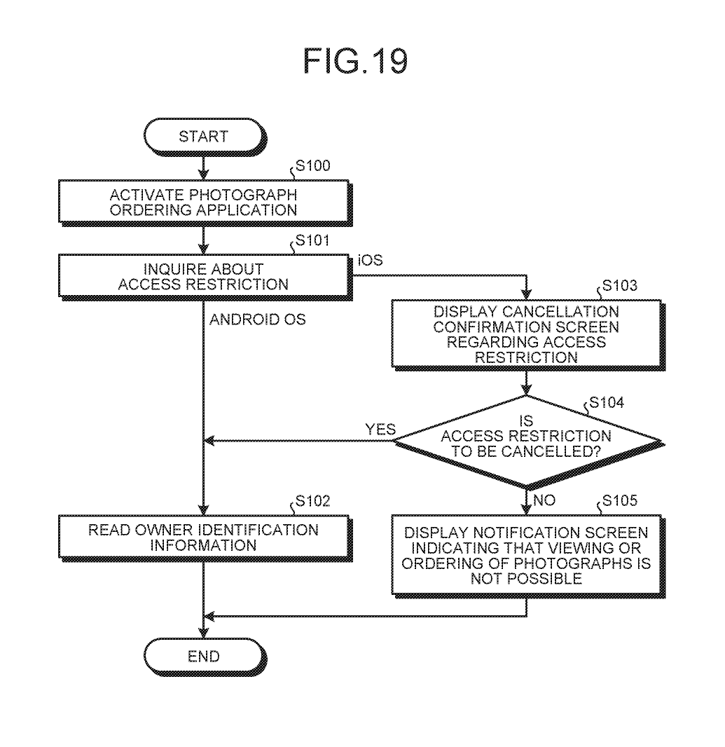

FIG. 19 is a diagram illustrating an exemplary flow of a reading process of reading the “owner identification information” from the information terminal 10. Firstly, due to a notification from the process controller 401, the client application module 406 detects the pressing of the activation button of the photograph ordering application; loads a computer program for the photograph ordering application from the HDD 204 into the RAM 202 using the storage controller 403; and activates the photograph ordering application (S100).

Then, the client application module 406 inquires at the OS about the access restriction to device setting information such as the “owner identification information” for which the setting of access restriction (including “read restriction”) is different according to the OS type (S101).

When the android OS is installed in the information terminal 10, there is no access restriction with respect to the device setting information. Hence, the OS gives permission for the access. In that case, the client application module 406 reads the “owner identification information” of the device setting information using the storage controller 403, and temporarily stores the “owner identification information” in a predetermined area of the RAM 202 (S102).

When the iOS is installed in the information terminal 10, there is access restriction with respect to the device setting information. Hence, cancellation confirmation screen information for confirming whether or not to cancel the access restriction is returned from the OS. The display controller 402 displays the cancellation confirmation screen on the LCD 208 (S103).

Then, the OS receives, via the process controller 401, a process signal of either a “cancel” button or a “do not cancel” button as input by the operator in the cancellation confirmation screen, and determines whether or not to cancel the access restriction (S104).

When a process signal of the “cancel” button is received by the process controller 401, the OS cancels the access restriction with respect to the device setting information and notifies the client application module 406 about the same (Yes at Step S104). In that case, the system control returns to Step S102, and the client application module 406 reads the “owner identification information” of the device setting information and temporarily stores the “owner identification information” in a predetermined area of the RAM 202.

On the other hand, when a process signal of the “do not cancel” button is received by the process controller 401, the OS notifies the client application module 406 about not cancelling the access restriction with respect to the device setting information (No at Step S104). In that case, the client application module 406 displays, on the LCD 208 via the display controller 402, a notification screen indicating that photographs cannot be viewed or ordered as an exemplary notification indicating that the processes regarding the target for charging would not be performed (S105).

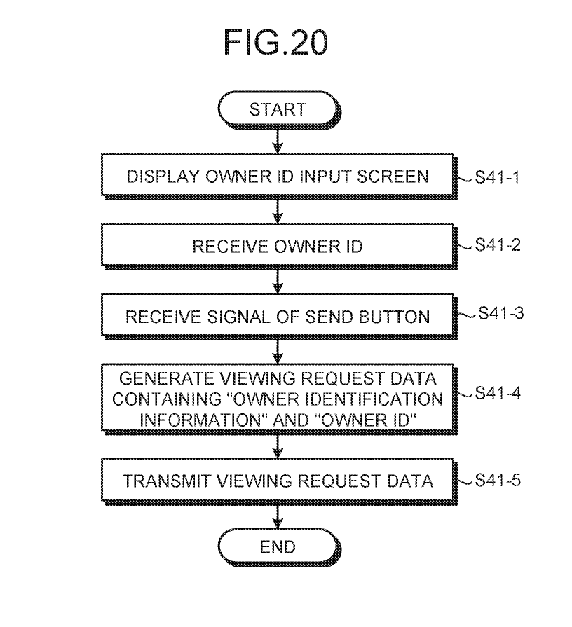

FIG. 20 is a diagram illustrating an exemplary flow of a setting process of setting the owner ID in the information terminal 10. Firstly, the client application module 406 displays the owner ID input screen G2 (see FIG. 10), which is transmitted by the web server device 12, on the LCD 208 via the display controller 402 (S41-1).

Then, the client application module 406 receives input of the “owner ID” in the “owner ID” entry field g2 of the owner ID input screen G2 via the process controller 401 (S41-2).

Subsequently, the client application module 406 receives a process signal of the send button B21 of the owner ID input screen G2 via the process controller 401 (S41-3).

Then, the client application module 406 generates viewing request data that contains the “owner identification information” that is temporarily stored in the RAM 202, and contains the “owner ID” that is received at Step S41-2 (S41-4).

Subsequently, the client application module 406 transmits the viewing request data to the web server device 12 via the second wireless communication controller 405 (S41-5).

In the first embodiment, the administrator of the web server device 12 receives registration application information of the “owner identification information” and the “owner ID” from the owner of the information terminal 10 via telephone, or an email, or a registration application form; and registers the pair information containing the “owner identification information” and the “owner ID” (i.e., the second pair information) using his or her own information terminal 10. Alternatively, the configuration can be such that the second pair information is automatically registered based on the first pair information transmitted from the information terminal 10 of the user. In that case too, it is desirable that the administrator receives registration application information of the “owner identification information” and the “owner ID” from the owner of the information terminal 10 via telephone, or an email, or a registration application form; and authenticates the second pair information that has been automatically registered. That enables prevention of registration of the second pair information from the information terminal 10 by a person other than the owner of the information terminal 10.

In the first embodiment, the explanation about a process of ordering photograph data is given with reference to the photography ordering screen. However, taking the order of data is not limited to the initial instance of order taking. For example, an order change button can be set in the photography ordering screen, so that an already-taken order can be changed.

In the first embodiment, photograph data is illustrated as an example of the data provided by the photograph ordering system. However, the data provided by the photograph ordering system is not limited to photograph data. That is, other than the photograph data, the data can be document data such as texts, image data such as artwork, animation data, or program files.

In the first embodiment, the mediating device 11 as well as the information terminal 10 implements two wireless communication methods, and the information terminal 10 establishes connection with the web server device 12 in the network 14 using the two wireless communication methods. However, this connection method is only exemplary. Alternatively, for example, the information terminal 10 can acquire the connection destination information of the web server device 12 from the mediating device 11 using near field communication (NFC), and establish connection with the web server device 12 in the network 14 using some other wireless communication method such as Wi-Fi. Still alternatively, instead of using a plurality of wireless communication methods, connection with the web server device 12 in the network 14 can be established using a single wireless communication method.

As described above, according to the first embodiment, by acquiring the “owner identification information” from the information terminal 10, it becomes possible to clearly know the identity of the person who is to be charged, thereby enabling prevention of fraudulent orders given by personation.

### Second Embodiment

In a second embodiment, the explanation is given for a connection distribution method in which the connection from the information terminal 10 to the mediating device 11 is assigned by an allocating device. In the following explanation, the constituent elements identical to those in the first embodiment are referred to by the same reference numbers, and their explanation is not repeated.

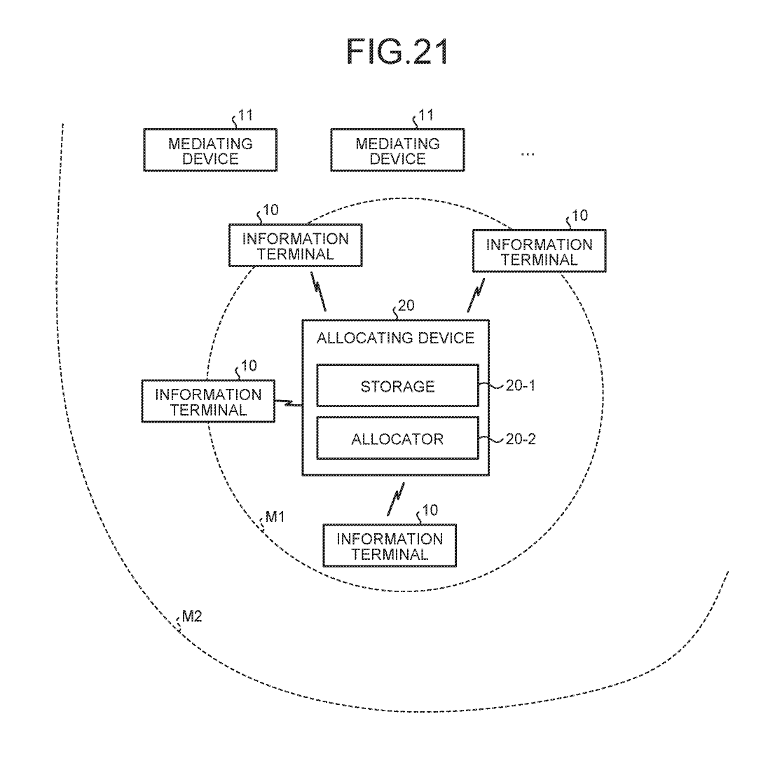

FIG. 21 is a diagram illustrating an exemplary network configuration according to the second embodiment. In FIG. 21 is illustrated a configuration of a wireless network that is used by information terminals to establish connection with mediating devices. As far as the network (see FIG. 1) is concerned, since the configuration is identical to the configuration according to the first embodiment, the network 14 is not illustrated in FIG. 21.

In FIG. 21, a plurality of mediating devices 11, a plurality of information terminals 10, and an allocating device 20 are illustrated as devices related to the concerned network. In the first embodiment, a unit for performing wireless communication according to the first wireless communication method is provided in the mediating device 11 (see FIG. 1). In contrast, in this network configuration, a unit for performing wireless communication according to the first wireless communication method is provided in the allocating device 20. A unit for performing wireless communication according to the second wireless communication method is provided in the mediating devices 11.

In FIG. 21, a communication range M1 indicates the communication range of the allocating device 20 with respect to the first wireless communication method, and a communication range M2 indicates the communication range of the mediating devices 11 with respect to the second wireless communication method. Regarding the first communication method and the second communication method, the types can be appropriately decided. In the following explanation, as an example, the first communication method is assumed to be Bluetooth communication method, and the second communication method is assumed to be Wi-Fi wireless communication method.

The mediating devices 11 represent access points meant for connecting the information terminals 10 to the web server device 12 (see FIG. 1) in the network 14, and fulfill an identical role to the role of the mediating device 11 according to the first embodiment (see FIG. 1).

The allocating device 20 assigns the connection destination of each information terminal 10 to one of the mediating devices 11. More particularly, the allocating device 20 includes a storage 20-1 and an allocator 20-2. The storage 20-1 is used to store the “connection information” of the mediating devices 11. When a request to transmit the “connection information” is received from one of the information terminals 10, the allocator 20-2 delivers the “connection information”, which is decided as the allocation destination, to the information terminal 10 that issued the request.

Each information terminal 10 performs first wireless communication (Bluetooth communication) with the allocating device 20. Moreover, the information terminal 10 requests the allocating device 20 to transmit the “connection information”, and acquires the “connection information” transmitted in response by the allocating device 20. Furthermore, the information terminal 10 establishes second wireless communication (Wi-Fi wireless communication) with the mediating device 11 that corresponds to the “connection information” acquired from the allocating device 20, and accesses the web server device 12 via the mediating device 11 with which connection has been established.

Given below is the explanation of a specific configuration of the allocating device 20. Regarding the other devices, since the configuration is substantially identical to the configuration according to the first embodiment, the illustration in the drawings and the explanation is not repeated.

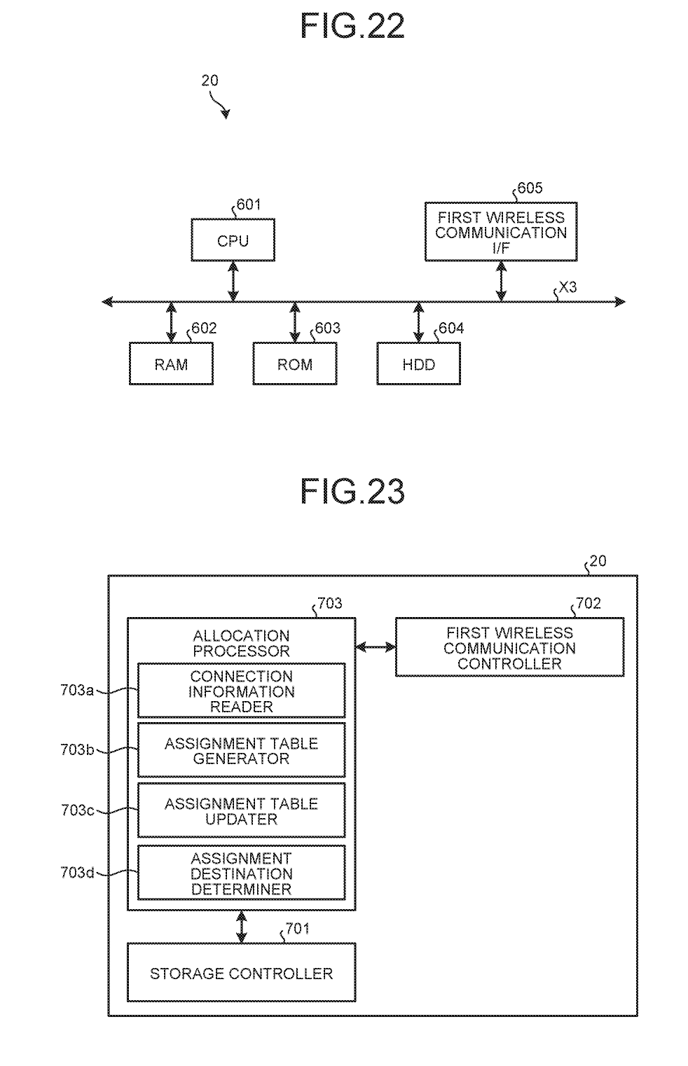

FIG. 22 is a diagram illustrating an exemplary hardware configuration of the allocating device 20. As illustrated in FIG. 22, the allocating device 20 includes a CPU 601, a RAM 602, a ROM 603, an HDD 604, and a first wireless communication I/F 605 that are connected to each other by a bus X3.

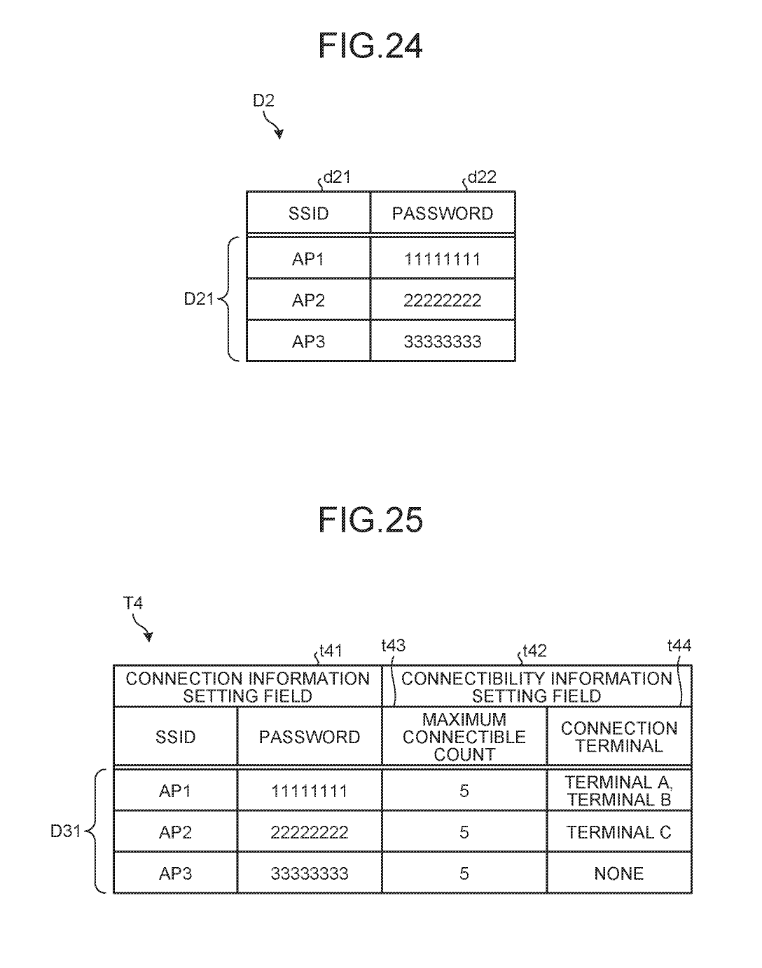

The CPU 601 is a computing unit that comprehensively controls the operations of the entire allocating device 20. The RAM 602 is a volatile storage medium in which reading and writing of information can be done at high speeds, and is used by the CPU 601 as the work area at the time of processing information. The ROM 603 is a non-volatile storage medium meant only for reading purposes, and is used to store computer programs such as firmware. The HDD 604 is a non-volatile storage medium enabling reading and writing of information, and is used to store various computer programs and a variety of data. For example, various computer programs include an allocation-destination deciding program for deciding the allocation destination, and the variety of data contains connection information D2 (see FIG. 24).

The first wireless communication I/F 605 is a Bluetooth communication interface.

Given below is the explanation of a functional configuration of the allocating device 20. In the allocating device 20, when the CPU 601 loads various computer programs from the ROM 603 or the HDD 604 into the RAM 602 and executes them, it results in the implementation of various functions.

FIG. 23 is a diagram illustrating an exemplary functional configuration of the allocating device 20. As illustrated in FIG. 23, the allocating device 20 implements functions such as a storage controller 701, a first wireless communication controller 702, and an allocation processor 703.

The storage controller 701 controls reading or writing of information with respect to the storage areas such as the ROM 603, the RAM 602, and the HDD 604.

The first wireless communication controller 702 controls the first wireless communication I/F 605, and performs wireless communication using Bluetooth with the communication destination.

The allocation processor 703 performs, subject to reception of a request to transmit the “connection information” from one of the information terminals 10 by the first wireless communication controller 702, an allocation destination deciding process for deciding one of a plurality of mediating devices 11 as the connection destination for the information terminal 10. Then, as a response to the request for the “connection information”, the allocation processor 703 transmits connection information of the decided allocation destination to the first wireless communication controller 702.

More particularly, the allocation processor 703 includes a connection information reader 703a, an allocation table generator 703b, an allocation table updater 703c, and an allocation destination determiner 703d.

The connection information reader 703a makes the storage controller 701 read the connection information D2 (see FIG. 24) from the HDD 604, and then reads the connection information D2 from the storage controller 701.

The allocation table generator 703b generates an allocation table T4 (see FIG. 25), and sets the connection information D2, which is read by the connection information reader 703a, in the allocation table T4.

The allocation table updater 703c updates the data of the allocation table T4.

The allocation destination determiner 703d refers to the allocation table T4 and decides on the allocation destination.

FIG. 24 is a diagram illustrating an exemplary data structure of the connection information stored in the HDD 604. The connection information D2 illustrated in FIG. 24 includes service set identifier (SSID) information d21 and encryption password information d22. The SSID information d21 and the encryption password information d22 are stored in a mutually corresponding manner. As an example, in the SSID information d21 and the encryption password information d22, SSID information and password information of three mediating devices 11 is held.

FIG. 25 is a diagram illustrating an exemplary data structure of the allocation table T4. The allocation table T4 illustrated in FIG. 25 includes a connection information setting field t41 and a connectibility information setting field t42. The connection information setting field t41 includes setting fields for setting the data of the SSID information d21 and the password information d22 of the connection information D2 (FIG. 24). The connectibility information setting field t42 includes a maximum connectible count setting field t43 meant for setting the maximum connectible count (number of devices) for each mediating device 11; and includes a connection terminal setting field t44 meant for setting, for each mediating device 11, identification information (such as the MAC address) of the information terminals 10 connected to that mediating device 11.

In a data portion D31 of the allocation table T4 is illustrated a setting example at a particular point of time during the processes. The records in the data portion D31 are assumed to have a record number n equal to 1, 2, and 3 in that order from top. In the connection information setting field t41 (the “SSID” field and the “password” field) and in the maximum connectible count setting field t43 is set the “connection information” and the maximum connectible count, respectively, of each mediating device 11 as registered in the connection information D2 of the HDD 604. The maximum connectible counts can be registered in a corresponding manner to the sets of connection information in the connection information D2. Depending on the communication connection or communication termination from the information terminals 10 to the mediating devices 11, the connection terminal setting field t44 is updated as needed to the identification information of the information terminals 10 that are currently connected for communication. In the connection terminal setting field t44 illustrated in FIG. 25, in order to make the terminals easily distinguishable; “terminal A”, “terminal B”, and “terminal C” are illustrated as identification information of the information terminals 10.

Given below is the explanation about the communication connection and the communication termination between the information terminals 10 and the mediating devices 11. Firstly, the explanation is given for a sequence of the communication connection and the communication termination between the information terminals 10 and the mediating devices 11. That is followed by the explanation of a sequence of the communication connection and the communication termination as performed by each functional unit.

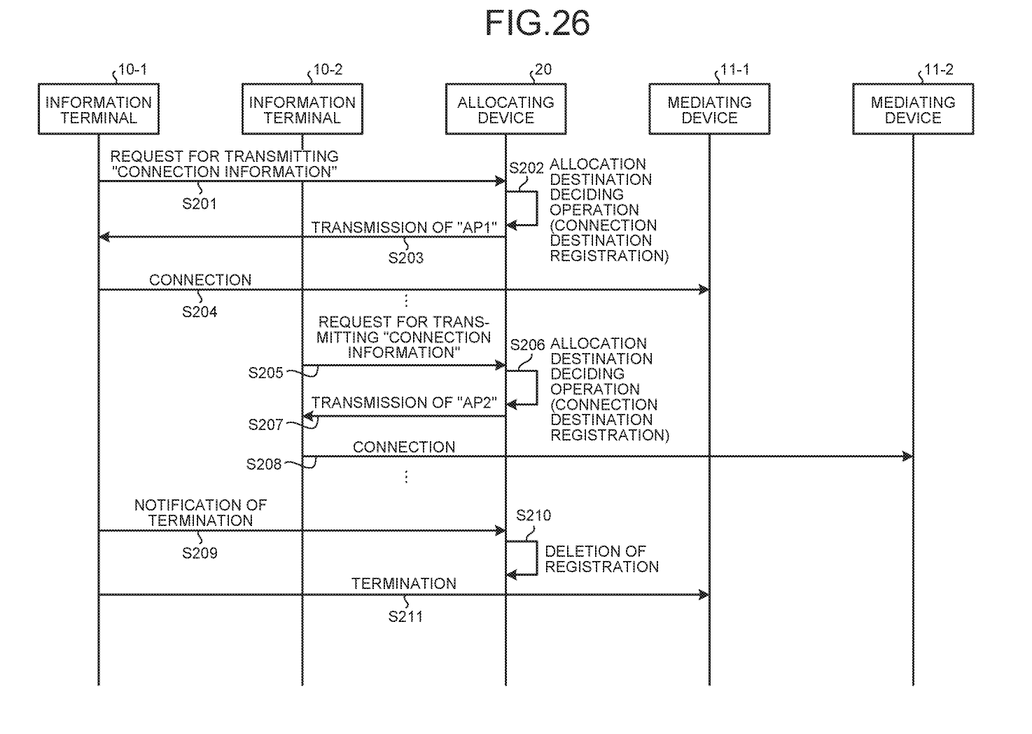

FIG. 26 is a sequence diagram for explaining the communication connection and the communication termination between the information terminals 10 and the mediating devices 11. In the following explanation, the communication connection and the communication termination between the information terminals 10 and the mediating devices 11 is given under the following assumptions: an “information terminal 10-1” is the information terminal 10 having the identification information “terminal A”; an “information terminal 10-2” is the information terminal 10 having the identification information “terminal B”; a “mediating device 11-1” is the mediating device 11 having “SSID=AP1”; and a “mediating device 11-2” is the mediating device 11 having “SSID=AP2”.

Firstly, the user who is operating the information terminal 10-1 enters the communication range M1 of the allocating device 20 and presses an application activation button so that a request to transmit the connection information of the mediating device 11 is issued from the information terminal 10-1 to the allocating device 20 (S201).

In response to the request, the allocating device 20 performs an allocation destination deciding process for deciding on the mediating device 11 that represents the allocation destination and registering the result (S202), and transmits the processing result to the information terminal 10-1 that issued the request (S203).

If the connection information “AP1” is received as the processing result, then the information terminal 10-1 establishes connection with the mediating device 11-1 having the connection information “AP1” (S204). Meanwhile, if some other connection information is received as the processing result, then the information terminal 10-1 establishes connection with the mediating device 11 having that connection information. For example, if the connection information “AP2” is received as the processing result, then the information terminal 10-1 establishes connection with the mediating device 11-2 having the connection information “AP2”.

Apart from the user of the information terminal 10-1, a plurality of users enter the communication period M1 during the same connection time period and press the respective application activation buttons so as to request the allocating device 20 to transmit connection information.

For example, the user who is operating the information terminal 10-2 enters the communication range M1 of the allocating device 20 and presses an application activation button so that a request to transmit the connection information of the mediating device 11 is issued from the information terminal 10-2 to the allocating device 20 (S205).

In response to the request, the allocating device 20 performs an allocation destination deciding process in an identical manner (S206), and transmits the processing result to the information terminal 10-2 that issued the request (S207).

If the connection information “AP2” is received as the processing result, then the information terminal 10-2 establishes connection with the mediating device 11-2 having the connection information “AP2” (S208). Meanwhile, if some other connection information is received as the processing result, then the information terminal 10-2 establishes connection with the mediating device 11 having that connection information.

Subsequently, when the user of the information terminal 10-1 presses an application termination button, the information terminal 10-1 notifies the allocating device 20 about the termination of connection with the mediating device 11 (S209).

In response to the notification about the termination of connection as received from the information terminal 10-1, the allocating device 20 deletes the registration information of the currently-connected information terminal 10-1 (S210), so that the connection between the information terminal 10-1 and the mediating device 11 is terminated (S211).

Although not illustrated in FIG. 26, regarding the information terminal 10-2 too, when the user thereof presses an application termination button, the connection between the information terminal 10-2 and the mediating device 11 is terminated in an identical manner to the case of the information terminal 10-1.

Herein, as an example, although the connection with the mediating device 11 is terminated after notifying the allocating device 20 about the termination, the order can be reversed.

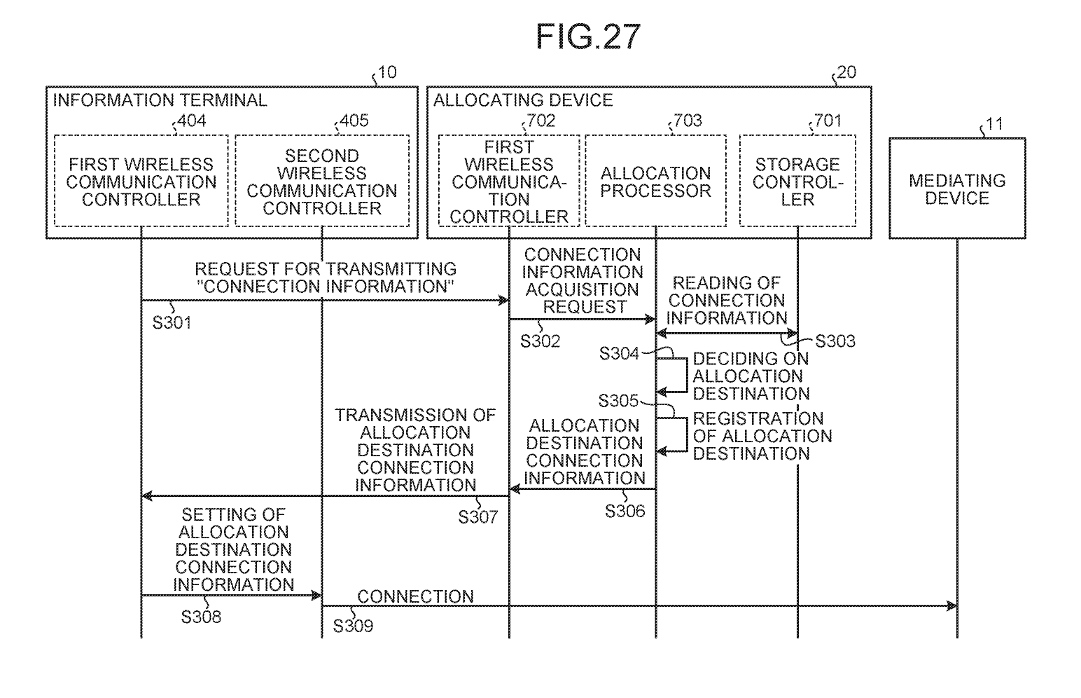

FIG. 27 is a diagram illustrating an exemplary sequence of processes for the communication connection as performed by the functional units in the information terminal 10 and the allocating device 20. Herein, it is assumed that the first wireless communication controller 404 (see FIG. 4) has been activated in the information terminal 10. For example, when the client application module 406 (see FIG. 4) detects the pressing of an application activation button, the first wireless communication controller 404 (see FIG. 4) gets activated.

Moreover, it is assumed that Bluetooth communication has been established between the information terminal 10 and the allocating device 20. For example, in the information terminal 10, in response to an advertisement packet signal that is transmitted from the allocating device 20 and that is received by the first wireless communication I/F 206 (see FIG. 2), the first wireless communication controller 404 establishes Bluetooth communication with the first wireless communication controller 702 of the allocating device 20.

Firstly, the first wireless communication controller of the information terminal 10 (corresponding to the first wireless communication controller 404 (see FIG. 4)) requests the first wireless communication controller 702 (see FIG. 3) of the allocating device 20 to transmit connection information of the mediating device 11 (S301).

The first wireless communication controller 702 transmits, to the allocation processor 703, the identification information of the information terminal 10 that issued the request; and requests the allocation processor 703 to acquire the connection information (S302).

The allocation processor 703 reads the connection information D2 (see FIG. 24) from the HDD 604 using the storage controller 701 (S303), and decides on the allocation destination for the information terminal 10 (S304). More particularly, in the allocation processor 703, at the time of activation thereof, the connection information reader 703a reads the connection information D2 from the HDD 604, and the allocation table generator 703b sets the connection information D2 in the allocation table T4 (see FIG. 25). Then, the allocation destination determiner 703d refers to the setting information of the allocation table T4 and decides on the allocation destination.

Moreover, the allocation processor 703 additionally registers the identification information of the information terminal 10 in the allocation table T4 using the storage controller 701 (S305), and transmits the connection information of the decided allocation destination to the first wireless communication controller 702 (S306). More particularly, in the allocation processor 703, the allocation table updater 703c additionally registers the identification information of the information terminal 10, which issued the request, in the data portion of the connection terminal setting field t44 corresponding to the decided allocation destination in the allocation table T4. More particularly, the allocation destination determiner 703d transmits, to the first wireless communication controller 702, the connection information corresponding to the allocation destination as set in the connection information setting field t41.

The first wireless communication controller 702 transmits the connection information to the first wireless communication controller 404 (see FIG. 4) of the information terminal 10 that issued the request (S307).

Upon receiving the connection information, the first wireless communication controller 404 of the information terminal 10 sets the connection information in the second wireless communication controller 405 (see FIG. 4) via the client application module 406 (S308).

The second wireless communication controller 405 establishes a second wireless communication connection (a wireless LAN connection) with the mediating device 11 that corresponds to the set connection information (S309).

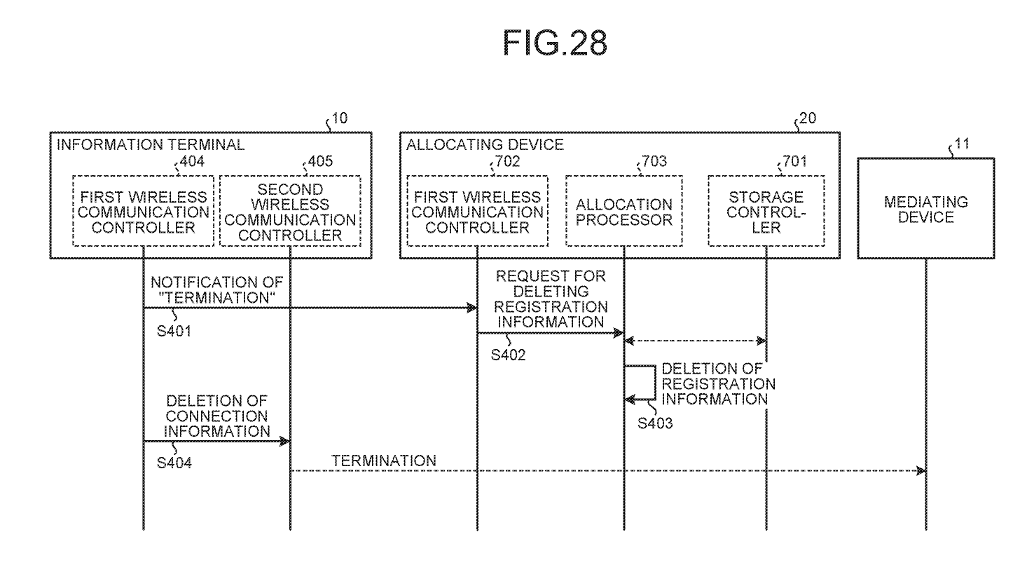

FIG. 28 is a diagram illustrating an exemplary sequence of processes for the communication termination as performed by the functional units in the information terminal 10 and the allocating device 20.

Firstly, the first wireless communication controller of the information terminal 10 (corresponding to the first wireless communication controller 404 (see FIG. 4)) notifies the first wireless communication controller 702 (see FIG. 23) of the allocating device 20 about terminating the connection with the mediating device 11 (S401). More particularly, the first wireless communication controller 404 of the information terminal 10 receives, from the client application module 406 (see FIG. 4), a deletion request for deleting information in response to the pressing of a connection termination button of the application. Then, the first wireless communication controller 404 requests the first wireless communication controller 702 (see FIG. 23) of the allocating device 20 to delete the identification information of the concerned information terminal 10.

In the allocating device 20, the first wireless communication controller 702 transmits, to the allocation processor 703, the identification information of the information terminal 10, which issued the request, and a deletion request for deleting the identification information (S402).

The allocation processor 703 uses the storage controller 701 and deletes the identification information of the information terminal 10, which issued the request, from the data portion of the connection terminal setting field t44 in the allocation table T4 (see FIG. 25) that is stored in the RAM 602 (S403). More particularly, the allocation table updater 703c deletes the identification information of the information terminal 10, which issued the request, from the data portion of the connection terminal setting field t44 in the allocation table T4.

In the information terminal 10, the first wireless communication controller 404 deletes the connection information of the second wireless communication controller 405 (see FIG. 4) via the client application module 406 (S404). As a result, the second wireless communication connection (wireless LAN connection) between the information terminal 10 and the mediating device 11, which was established according to the connection information, gets terminated.

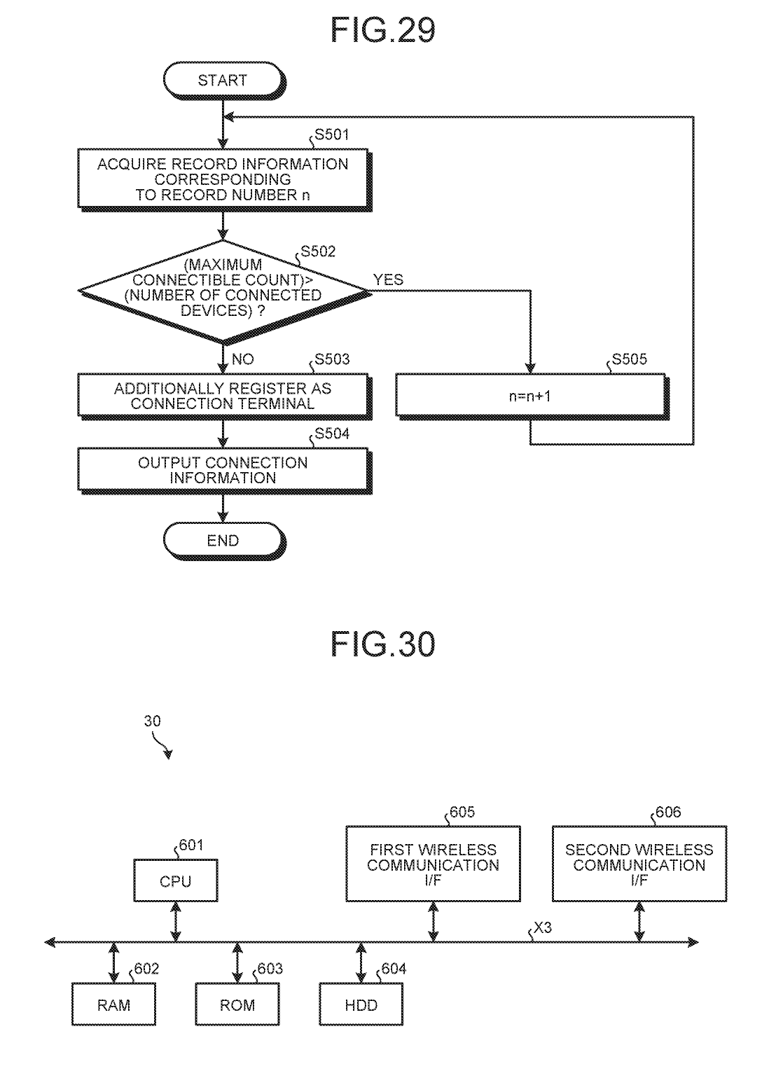

FIG. 29 is an explanatory diagram for explaining the deciding process performed by the allocation processor 703. In the following explanation, the information terminals 10 are assumed to have the following identification information: terminal A, terminal B, terminal C, and terminal D. Moreover, the mediating devices 11 are assumed to be identified by the following SSIDs: “AP1”, “AP2”, and “AP3”.

Firstly, the allocation processor 703 acquires record information corresponding to a record number n from the allocation table T4 (see FIG. 25) (S501). Initially, n=1 holds true and, in the setting example illustrated in the data portion D31 in FIG. 25, record information of “AP1” in the first row is acquired.

Then, the allocation processor 703 refers to the acquired record information and determines whether or not the number of terminals that are currently connected to the concerned mediating device 11 has reached the maximum connectible count (S502). More particularly, the allocation processor 703 reads, from the acquired record information, the information set in the maximum connectible count setting field t43 (i.e., the maximum connectible count) and the information set in the connection terminal setting field t44 (i.e., the identification information of the currently-connected information terminals 10); and compares the maximum connectible count with the number of currently-connected information terminals 10. For example, in the example of the record information of “AP1” illustrated in FIG. 25, the data of the maximum connectible count setting field t43 indicates “five (devices)” and the data of the connection terminal setting field t44 indicates “terminal A” and “terminal B”. In that case, since the number of currently-connected devices is “two (devices)” that is smaller than the maximum connectible count of “five (devices)”, it is determined that the number of connected terminals has not reached the maximum connectible count.

When it is determined at Step S502 that the number of connected terminals has not reached the maximum connectible count, the allocation processor 703 performs a registration process for adding the identification information of the information terminal 10, which issued the request, in the identification information set in the connection terminal setting field t44 of the concerned record (S503). In the example of the record information of “AP1” illustrated in FIG. 25, the identification information (as an example, terminal D) of the concerned information terminal 10 is registered in addition to “terminal A” and “terminal B” in the connection terminal setting field t44, and increments the count of connected terminals to the concerned mediating device 11 by one to three.

Then, the allocation processor 703 reads the SSID information and the password information of the connection information setting field t41 of the concerned record, and transmits the read information (connection information) as resultant information to the first wireless communication controller 702 (S504).

Meanwhile, when it is determined at Step S502 that the number of connected terminals has reached the maximum connectible count, the allocation processor 703 increments the value of n by one (S505), and repeatedly performs the processes from Step S501 onward. More particularly, in the setting example of the data portion D31 illustrated in FIG. 25, the processes are again performed with respect to the record information of “AP2” in the second row. Meanwhile, when n=3 holds true, the processes are again performed with respect to the record information of “AP3” in the third row.

Herein, the deciding process is performed for the record numbers n=1, 2, and 3 in that order. Hence, when the mediating device 11 having the connection information “AP1” reaches the maximum connectible count, the connection is assigned to the mediating device 11 having the connection information “AP2”. Similarly, when the mediating device 11 having the connection information “AP2” reaches the maximum connectible count, the connection is assigned to the mediating device 11 having the connection information “AP3”. However, the sequence of deciding the allocation destination is not limited to this sequence. For example, every time a request to transmit connection information is issued by the information terminal 10, the allocation destination is assigned in the sequence of “AP1”, “AP2”, “AP3”, “AP1”, “AP2”, and so on. That is, for every connection, the allocation destination can be repeatedly switched among “AP1”, “AP2”, and “AP3” in that order.

When the mediating devices 11 having the connection information “AP1”, “AP2”, and “AP3” all reach the maximum connectible count, any further connection is rejected. For example, the allocation processor 703 waits until the connection of any one information terminal 10 with respect to the mediating device 11 is terminated and, when the connection is terminated, again performs the deciding operation. Meanwhile, when the mediating devices 11 having the connection information “AP1”, “AP2”, and “AP3” all reach the maximum connectible count, the first wireless communication controller 702 can be notified that connection could not be established, and the first wireless communication controller 702 can be instructed to transmit display information indicating that connection could not be established to the first wireless communication controller 404 of the information terminal 10.

As described above, in the second embodiment, an allocating device manages the number of connections established by each mediating device with information terminals. Then, if there is a new connection request from an information terminal, the allocating device decides on one of the mediating devices as the allocation destination of that information terminal. Moreover, the allocating device updates, as needed, the number of connections of the mediating device to which the concerned information terminal is assigned. Hence, every time a connection request is received from an information terminal, a mediating device having scope in the connections can be decided as the allocation destination. Since an information terminal gets connected to a mediating device having scope in the connections, the user of that information terminal can establish connection with the information processing devices in the network in a more comfortable way.

Note A1

A system including:

a plurality of mediating devices that mediates connection with respect to a communication network;

an allocating device configured to allocate mediation of connection with respect to the communication network to one of the plurality of mediating devices; and an information terminal configured to establish

connection for communication with the mediating device which represents the allocation destination allocated by the allocating device, wherein

the allocating device includes
a determiner configured to, as a mediation destination for mediating the connection with respect to the communication network, determine one of the plurality of mediating devices, and
a transceiver configured to receive a connection request from the information terminal and transmit, to the information terminal, connection information which is to be used in establishing connection for communication with the mediating device decided by the determiner, and

the information terminal includes a communication connection unit configured to establish connection for communication with the mediating device, which is determined by the determiner, using the connection information transmitted from the allocating device.

Note A2

The system according to Note A1, wherein the determiner determines the mediation destination based on the connection count of the information terminals connected to each of the plurality of mediating devices.

Note A3

The system according to Note A1, wherein the determiner determines the mediation destination in such a way that the upper-limit connection count of each of the plurality of mediating devices is not exceeded.

Note A4

The system according to Note A1, wherein, when the connection count of each of the plurality of mediating devices exceeds the upper-limit connection count, the determiner rejects establishment of further connection by the information terminal.

Note A5

An allocating device including:

a determiner configured to determine, as a mediation destination for mediating connection with respect to a communication network, one of a plurality of mediating devices; and

a transceiver configured to receive a connection request from an information terminal for establishing connection with the communication network and transmit, to the information terminal, connection information which is to be used in establishing connection for communication with the mediating device determined by the determiner.

Note A6

A non-transitory computer-readable recording medium with an executable program stored thereon, wherein the program instructs a computer to perform:

determining, as a mediation destination for mediating connection with respect to a communication network, one of a plurality of mediating devices; and

receiving a connection request from an information terminal for establishing connection with the communication network and transmitting, to the information terminal, connection information which is to be used in establishing connection for communication with the mediating device determined.

### Third Embodiment

In a third embodiment, as a modification example of the second embodiment, the explanation is given for a case in which information of connection terminals is registered in the mediating devices 11 from an allocating device 30.

FIG. 30 is an exemplary hardware configuration of the allocating device 30 according to the third embodiment. The allocating device 30 illustrated in FIG. 30 further includes a second wireless communication I/F 606 in the allocating device 20 according to the second embodiment. The second wireless communication I/F 606 is an interface for Wi-Fi wireless communication.

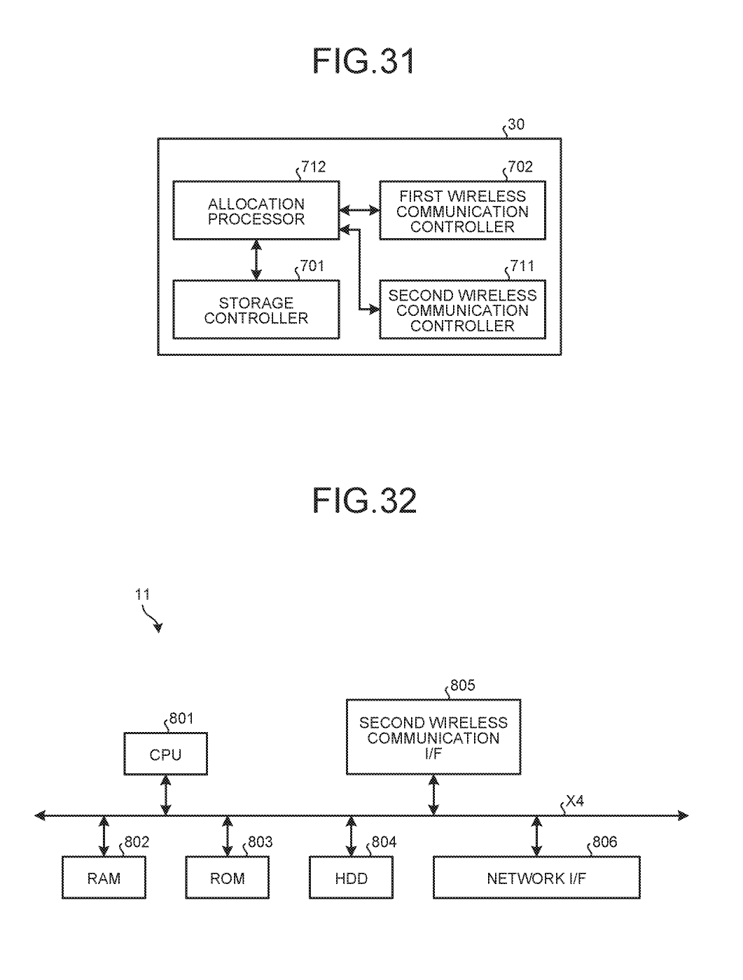

FIG. 31 is a diagram illustrating an exemplary functional configuration of the allocating device 30. In the allocating device 30, when the CPU 601 loads various computer programs from the ROM 603 or the HDD 604 into the RAM 602 and executes them, it results in the implementation of various functions. The allocating device 30 illustrated in FIG. 31 includes the storage controller 701, the first wireless communication controller 702, a second wireless communication controller 711, and an allocation processor 712.

The second wireless communication controller 711 controls the second wireless communication I/F 606 and transmits data to and receives data from the communication destination.

The allocation processor 712 is configured by further equipping the allocation processor 712 according to the second embodiment to have a function of updating the information of the connection terminals of the mediating devices 11.

FIG. 32 is a diagram illustrating an exemplary hardware configuration of the mediating device 11. As illustrated in FIG. 32, the mediating device 11 includes a CPU 801, a RAM 802, a ROM 803, an HDD 804, a second wireless communication I/F 805, and a network I/F 806 that are connected to each other by a bus X4.

The CPU 801 is a computing unit that comprehensively controls the operations of the entire mediating device 11. The RAM 802 is a volatile storage medium in which reading and writing of information can be done at high speeds, and is used by the CPU 801 as the work area at the time of processing information. The ROM 803 is a non-volatile storage medium meant only for reading purposes, and is used to store computer programs such as firmware. The HDD 804 is a non-volatile storage medium enabling reading and writing of information, and is used to store various computer programs and a variety of data. For example, various computer programs include various communication programs, a relay program, and a registration information updating program. Besides, a DHCP server program is also included. The data contains a data file of a registration table, and contains connection destination information of the web server device 12.

The second wireless communication I/F 805 is an interface for Wi-Fi wireless communication.

The network I/F 806 is a network interface such as Ethernet (registered trademark) for establishing connection with the network 14 and performing communication with the devices connected to the network 14.

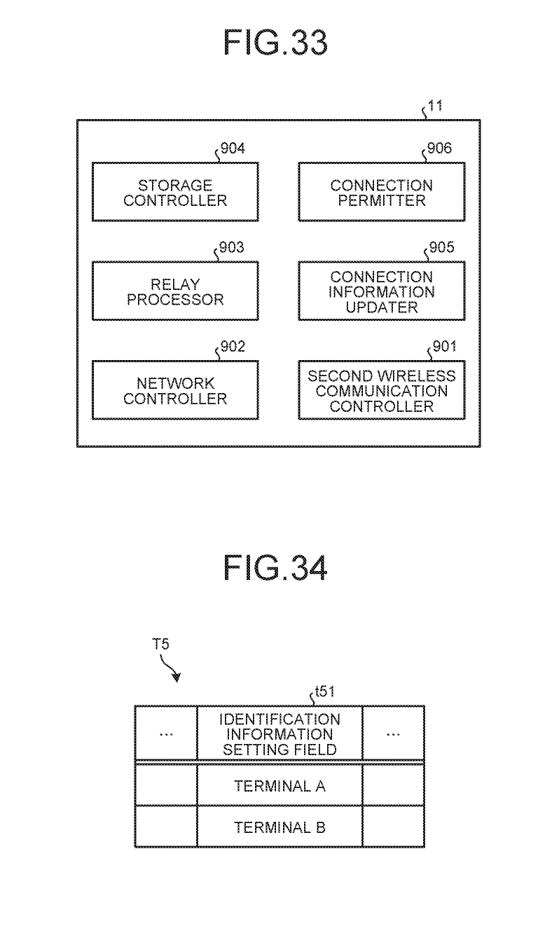

FIG. 33 is a diagram illustrating an exemplary functional configuration of the mediating device 11. In the mediating device 11, when the CPU 801 loads various computer programs from the ROM 803 or the HDD 804 into the RAM 802 and executes them, it results in the implementation of various functions. The mediating device 11 illustrated in FIG. 33 includes a second wireless communication controller 901, a network controller 902, a relay processor 903, a storage controller 904, a connection information updater 905, and a connection permitter 906.

The second wireless communication controller 901 controls the second wireless communication I/F 805 of the mediating device 11, and transmits data to and receives data from the communication destination.

The network controller 902 controls the network I/F 806 of the mediating device 11, and transmits data to and receives data from the communication destination.

The relay processor 903 performs a relay operation. The storage controller 904 controls reading or writing of information with respect to the storage areas such as the ROM 803, the RAM 802, and the HDD 804 of the mediating device 11.

The connection information updater 905 updates the registration information in the registration table using the storage controller 904.

The connection permitter 906 allows the establishment of the second wireless communication connection from information terminals, excluding predetermined devices such as the allocating device 30, based on the registration information in the registration table.

FIG. 34 is a diagram illustrating an exemplary data structure of a registration information table of the mediating device 11. A registration information table T5 illustrated in FIG. 34 includes an identification information setting field t51 for setting identification information (such as the MAC address) of the information terminals 10. In FIG. 34 is illustrated an example in which the identification information “terminal A” and “terminal B” is registered.

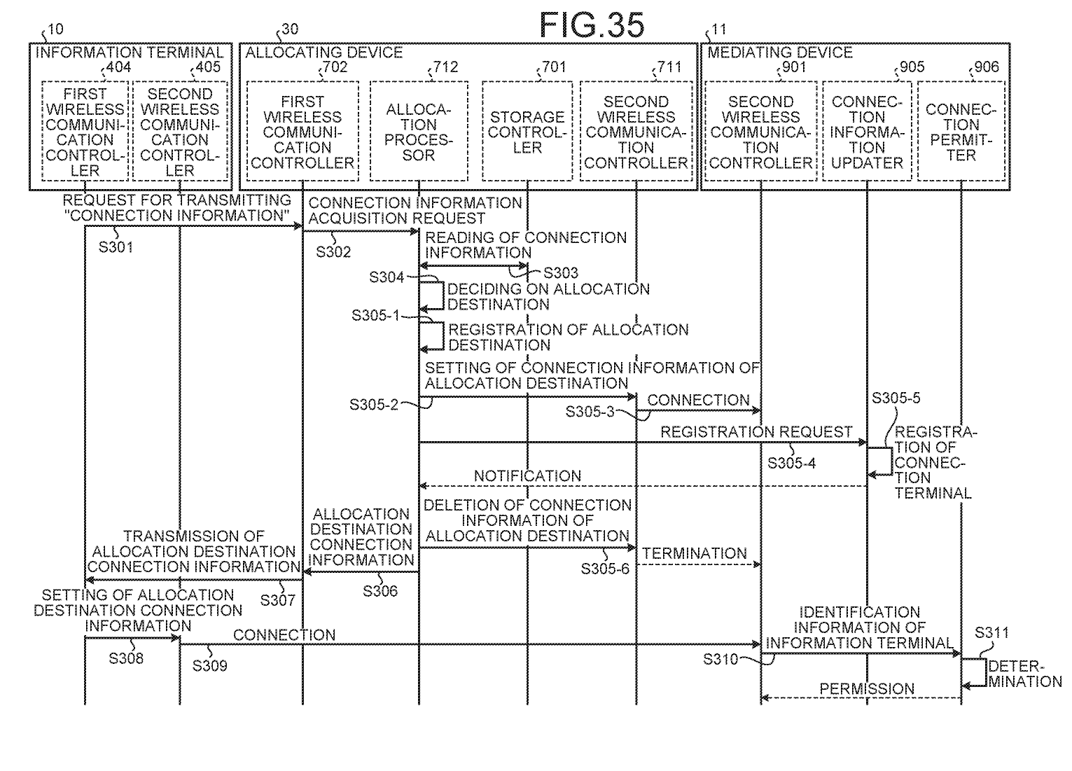

FIG. 35 is a diagram illustrating an exemplary sequence of a communication process performed by the functional units of the information terminal 10, the allocating device 30, and the mediating device 11. In the following explanation, the steps identical to the steps illustrated in FIG. 27 are referred to by the same step numbers, and the explanation is mainly given about the different steps than the steps in FIG. 27.

After deciding the allocation destination at Step S304, the allocation processor 712 additionally stores the identification information of the information terminal 10 in the allocation table T4 via the storage controller 701 (S305-1). More particularly, in the allocation processor 712, the allocation table updater (corresponding to the allocation table updater 703c illustrated in FIG. 23) additionally registers the identification information of the information terminal 10, which issued the request, with respect to that data portion of the connection terminal setting field t44 which corresponds to the decided allocation destination.

Moreover, the allocation processor 712 sets the connection information of the decided allocation destination in the second wireless communication controller 711 (S305-2).

As a result, the second wireless communication controller 711 establishes Wi-Fi connection with the second wireless communication controller 901 of the mediating device 11 of the allocation destination (S305-3). Since the allocating device 30 whose identification information is registered in advance represents the source of connection, the establishment of connection is allowed.

When the connection is established, the allocation processor 712 requests the connection information updater 905 of the mediating device 11, which represents the connection destination, to perform registration (S305-4). In response, the connection information updater 905 registers the identification information of the information terminal 10, which issued the request, in the registration information table T5 using the storage controller 904 (see FIG. 33) (S305-5).

After the registration is completed, the allocation processor 712 deletes the connection information set in the second wireless communication controller 711 (S305-6). As a result, Wi-Fi connection between the allocating device 20 and the mediating device 11 is terminated.

Then, in an identical manner to the steps illustrated in FIG. 27, the information terminal 10, which issued the request, establishes Wi-Fi connection with the mediating device 11 that corresponds to the connection information (Steps S306 to S309).

Meanwhile, in the mediating device 11 according to the third embodiment, when the second wireless communication controller 901 receives a request for Wi-Fi connection from the information terminal 10, the connection permitter 906 receives the identification information of the information terminal 10 that issued the request (S310), and determines whether or not the identification information has been registered in the registration information table T5 (S311). More particularly, the connection permitter 906 reads the identification information of the information terminals 10, which is registered in the registration information table T5, using the storage controller 904, and determines whether or not the read information contains the identification information of the information terminal 10 that issued the request. If the identification information of the information terminal 10 that issued the request is included, then the connection permitter 906 allows the establishment of the Wi-Fi connection.

Meanwhile, at Step S304, if the allocation destination cannot be found as a result of all mediating devices 11 reaching the maximum connectible count, the allocating device 30 can be configured to terminate the connection between the information terminal 10 and the mediating device 11.

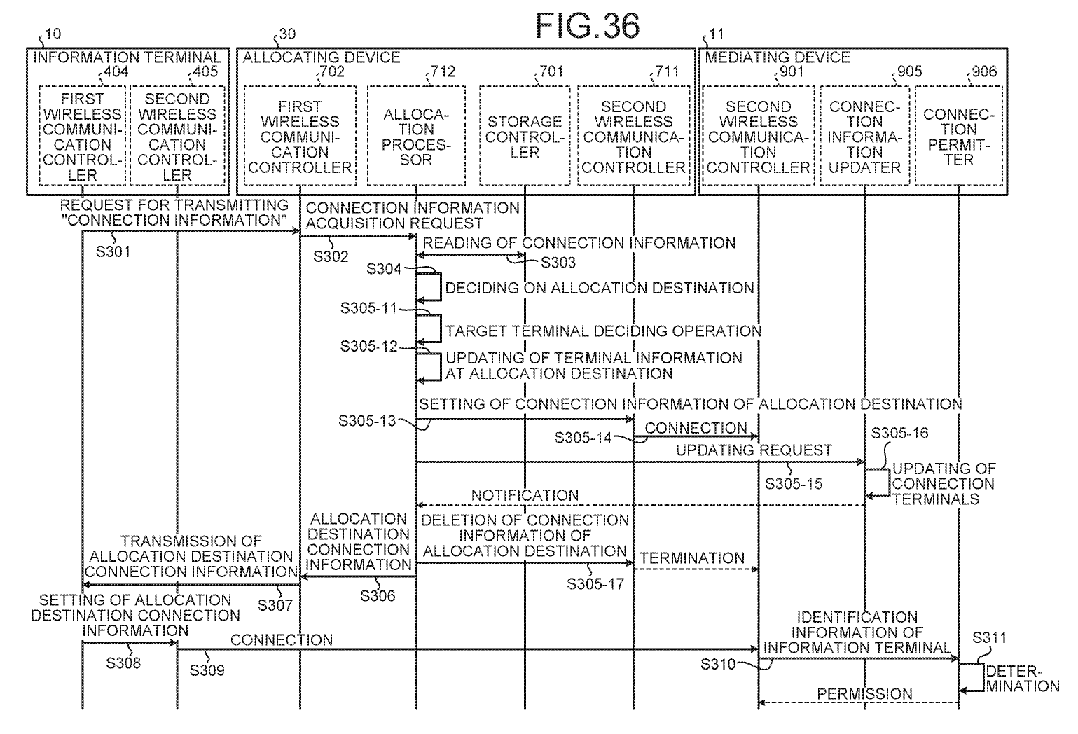

FIG. 36 is a diagram illustrating an exemplary sequence of a communication process performed in the case of deleting the identification information of the information terminal, which is registered in the mediating device 11, from the allocating device 30. If no allocation destination is found while deciding on the allocation destination at Step S304, then the allocation processor 712 firstly performs a target terminal deciding process for deciding the target terminal for deletion (S305-11). In the target terminal deciding operation, the target terminal for deletion is decided according to an arbitrary decision method such as according to the sequence of registration of connection terminals in the allocation table T4, or according to a predetermined priority of connection terminals, or according to descending order of elapsed time since registration.

After deciding on the target terminal for deletion, from among the currently-connected connection terminals set in the connection terminal setting field t44 of the allocation table T4, the allocation processor 712 updates the target terminal for deletion to have the identification information of the information terminal 10 that issued the request to transmit the “connection information” at Step S301 (S305-12).

Moreover, the allocation processor 712 sets, in the second wireless communication controller 711, the connection information regarding connection to the mediating device 11 to which the target terminal for deletion was assigned in the allocation table (S305-13).

As a result of that setting, based on the connection information, the second wireless communication controller 711 establishes Wi-Fi connection with the second wireless communication controller 901 of the mediating device 11 to which the target terminal for deletion was assigned (S305-14).

Once the connection is established, the allocation processor 712 requests the connection information updater 905 of the concerned mediating device 11 to update the registration information (S305-15). In response to the request, the connection information updater 905 deletes the identification information of the target terminal for deletion from the registration information table T5 using the storage controller 904, and newly registers the identification information of the information terminal 10 that issued the request mentioned earlier (S305-16).

When the completion of registration is notified, the allocation processor 712 deletes the concerned connection information set in the second wireless communication controller 711 (S305-17). It results in the termination of the Wi-Fi connection between the allocating device 30 and the mediating device 11.

Meanwhile, herein, the explanation is given for a case in which, at a timing at which a request to transmit the connection information is received from the information terminal 10, the allocating device 30 deletes the identification information of the concerned information terminal as registered in the mediating device 11. However, the timing for deleting the identification information of the concerned information terminal from the mediating device 11 is not limited to that timing. Alternatively, for example, after transmitting the decided connection information to the information terminal 10, the allocating device 30 can measure the elapsed time and, after the elapse of a predetermined period of time, can delete the identification information of the concerned information terminal from the mediating device 11.

Note A7

The system according to any one of Notes A1 to A4, wherein

the allocating device further includes an information terminal registerer configured to register identification information of the information terminal in the mediating device determined by the determiner, and

the mediating device establishes communication only with the information terminal whose identification information has been registered by the information terminal registerer.

Note A8

The system according to Note A7, wherein the allocating device further includes a deleter configured to delete the identification information of the information terminal from the mediating device to which the information terminal is currently connected.

Note A9

The system according to Note A8, wherein, when a notification of termination of connection is received from an information terminal, the deleter deletes the identification information of the information terminal from the mediating device to which the information terminal is currently connected.

Note A10

The system according to Note A8 or A9, wherein

the deleter deletes the identification information of currently-connected information terminals from a mediating device in order of priority, and

the information terminal registerer registers the identification information of the information terminal in the mediating device from which the identification information of information terminals has been deleted by the deleter.

Note A11

The allocating device according to Note A5, wherein the allocating device further includes an information terminal registerer configured to register identification information of the information terminal in the mediating device determined by the determiner.

Note A12

The system according to Note A11, wherein the allocating device further includes a deleter configured to delete the identification information of the information terminal from the mediating device to which the information terminal is currently connected.

Note A13

The system according to Note A6, wherein the program further causes the computer to perform registering identification information of the information terminal in the mediating device determined.

Note A14

The system according to Note A13, wherein the program further causes the computer to perform deleting the identification information of the information terminal from the mediating device to which the information terminal is currently connected.

### Fourth Embodiment

In a fourth embodiment, the explanation is given for an example in which a plurality of access points is installed for each mediating device (wireless base station) 11, and a connection distribution method is implemented by which the concentration of connection of information terminals with respect to a single access point is distributed among other access points of the same wireless base station 11 by prompting some of the information terminals to perform roaming. The following explanation is mainly given about the connection distribution method.

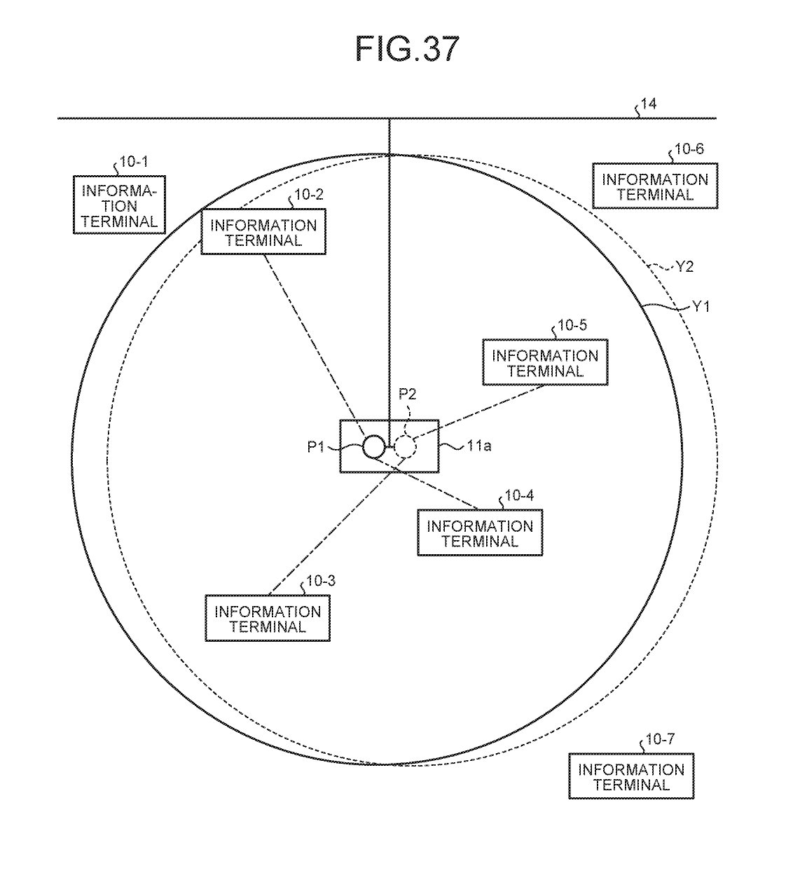

FIG. 37 is a diagram illustrating an exemplary network configuration of the connection distribution method according to the fourth embodiment. In FIG. 37 is illustrated a wireless base station 11a having two access points P1 and P2 as an example of a wireless base station according to the fourth embodiment. Herein, although only two access points are illustrated for ease of explanation, there can be three or more access points. To the wired network (i.e., the network 14) of the wireless base station 11a, the web server device 12 (see FIG. 1) and the file-sharing server device 13 (see FIG. 1) are connected although not illustrated in FIG. 37.

The access points have mutually different communication channels (frequency bands) set therein, thereby preventing reception errors in the information terminals 10 attributed to radio wave interference. Moreover, the access points have common connection information (SSID information and encryption password information) set therein, thereby enabling the information terminals 10 to perform roaming.

Herein, cells Y1 and Y2 represent the ranges of access for the transmission radio waves at the access points P1 and P2, respectively. The ranges of access represented by the cells Y1 and Y2 overlap in some part. The range over which the cells Y1 and Y2 overlap is called an “overlapping range”, and the range of only either the cell Y1 or the cell Y2 other than overlapping range is called an “individual range”.

On the periphery of the wireless base stations 11a, a plurality of information terminals (information terminals 10-1, 10-2, . . . , and 10-7) is illustrated.

The information terminals 10-1, 10-6, and 10-7 are present at such positions which neither belong to the cell Y1 nor belong to the cell Y2. At those positions, wireless connection can neither be established with the access point P1 nor be established with the access point P2.

The information terminals 10-2, 10-3, 10-4, and 10-5 are present in the overlapping area. In the overlapping area, wireless connection can be established either with the access point P1 or with the access point P2. Herein, as an example, it is illustrated that the information terminals 10-2 and 10-4 establish wireless connection with the access point P1, and the information terminals 10-3 and 10-5 establish wireless connection with the access point P2. Meanwhile, the access point to which an information terminal establishes wireless connection varies according to the communication status between the access points and the information terminals. Hence, the communication status is not limited to the example given above.

With such a configuration, the wireless base station 11a monitors the number of information terminals 10 that have established wireless connection with each access point. If it is detected that there is a concentration of connections at a particular access point and that the other access points are available for connection, then the wireless base station 11a enhances or attenuates the radio wave transmission output of each access point. At the access point at which the connections have concentrated, the connected information terminals perform roaming due to a decline in the radio field intensity, and establish connection with another access point having a higher radio field intensity implying availability for connection.

Given below is the detailed explanation about the control of the radio wave transmission output as performed by the wireless base station 11a and about the roaming performed by the information terminals 10.

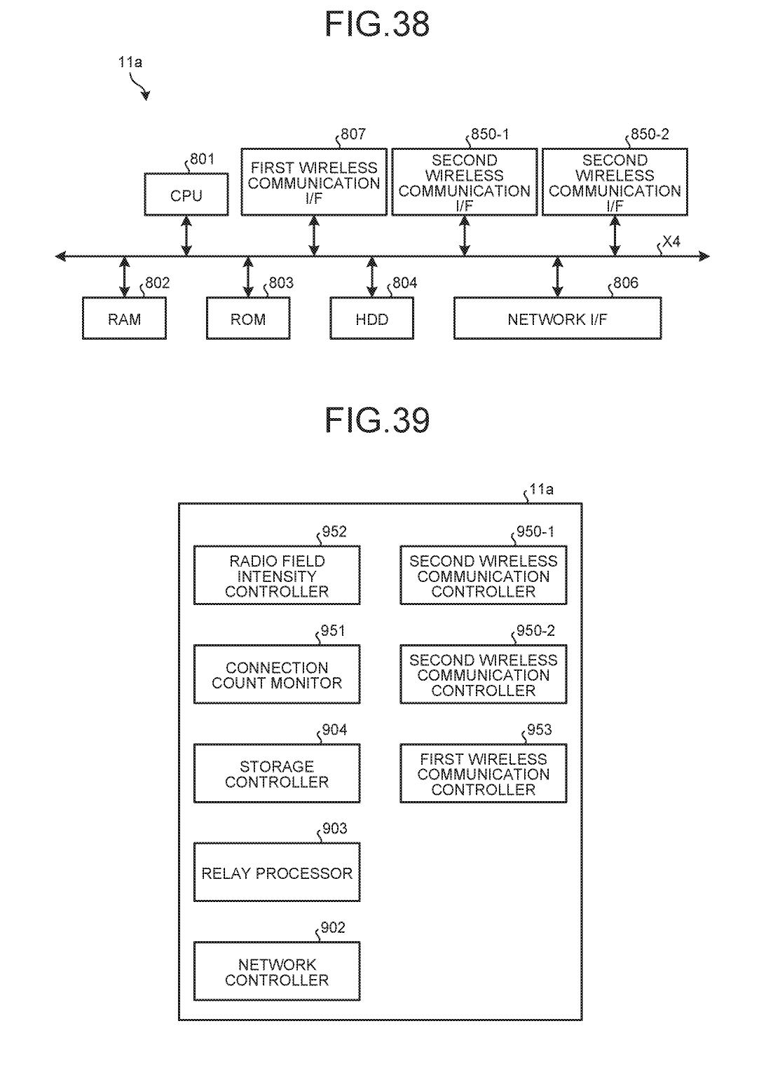

FIG. 38 is a diagram illustrating an exemplary hardware configuration of the wireless base station according to the fourth embodiment. The wireless base station 11a illustrated in FIG. 38 includes the CPU 801, the RAM 802, the ROM 803, the HDD 804, second wireless communication I/Fs 850-1 and 850-2, the network I/F 806, and a first wireless communication I/F 807 that are connected to each other by the bus X4.

The CPU 801 is a computing unit that comprehensively controls the operations of the entire wireless base station 11a. The RAM 802 is a volatile storage medium in which reading and writing of information can be done at high speeds, and is used by the CPU 801 as the work area at the time of processing information. The ROM 803 is a non-volatile storage medium meant only for reading purposes, and is used to store computer programs such as firmware. The HDD 804 is a non-volatile storage medium enabling reading and writing of information, and is used to store various computer programs and a variety of data. For example, various computer programs include a connection count updating program and a connection distribution processing program. The data contains a data file of a connection count monitoring table.

The second wireless communication I/Fs 850-1 and 850-2 are interfaces for Wi-Fi wireless communication and have mutually different communication channels set therein so that beacon frames are transmitted and received from the respective antennas via different communication channels.

The network I/F 806 is a network interface of Ethernet (registered trademark) for establishing wired connection with the network 14.

The first wireless communication I/F 807 is an interface for Bluetooth communication, and is used in transmitting connection information (SSID information and encryption password information) to the information terminals 10.

FIG. 39 is a diagram illustrating an exemplary functional configuration of the wireless base station. In the wireless base station 11a, when the CPU 801 loads various computer programs from the ROM 803 or the HDD 804 into the RAM 802 and executes them, it results in the implementation of various functions. The wireless base station 11a illustrated in FIG. 39 includes the network controller 902, the relay processor 903, the storage controller 904, a connection count monitor 951, a radio field intensity controller 952, a first wireless communication controller 953, and second wireless communication controllers 950-1 and 950-2. Herein, mainly the connection count monitor 951, the radio field intensity controller 952, and the second wireless communication controllers 950-1 and 950-2 may be collectively referred to as a “roaming processor”.

The network controller 902 controls the network I/F 806 of the wireless base station 11a, and transmits data to and receives data from the communication destination in the network 14.

The relay processor 903 performs a relaying operation.

The storage controller 904 controls reading or writing of information with respect to the storage areas such as the ROM 803, the RAM 802, and the HDD 804 of the wireless base station 11a.

The connection count monitor 951 refers to the connection count monitoring table and monitors the connection count. For example, the connection count monitor 951 updates the connection count monitoring table using the storage controller 904, reads the connection count from the connection count monitoring table using the storage controller 904, and monitors whether or not the connection count has not exceeded the upper limit.

The radio field intensity controller 952 outputs a switching range (switching range information) of the radio wave transmission output to the second wireless communication controllers 950-1 and 950-2.

The first wireless communication controller 953 controls the first wireless communication I/F 807 and performs wireless communication using Bluetooth. When there is a response to the Bluetooth communication from the information terminal 10, the first wireless communication controller 953 transmits the connection information to the information terminal 10 via the first wireless communication I/F 807.

The second wireless communication controller 950-1 controls the second wireless communication I/F 850-1, while the second wireless communication controller 950-2 controls the second wireless communication I/F 850-2. For example, when the switching range information of the radio wave transmission output is received from the radio field intensity controller 952, the second wireless communication controller 950-1 (the second wireless communication controller 950-2) controls the radio wave transmission output of the second wireless communication I/F 850-1 (the second wireless communication I/F 850-2) based on the switching range information.

Moreover, when the second wireless communication controllers 950-1 and 950-2 establish connection for communication with the information terminal 10, they notify the connection count monitor 951 using a signal indicating the connection with the information terminal 10. When the connection with the information terminal 10 is terminated, the second wireless communication controllers 950-1 and 950-2 notify the connection count monitor 951 using a signal indicating the termination.

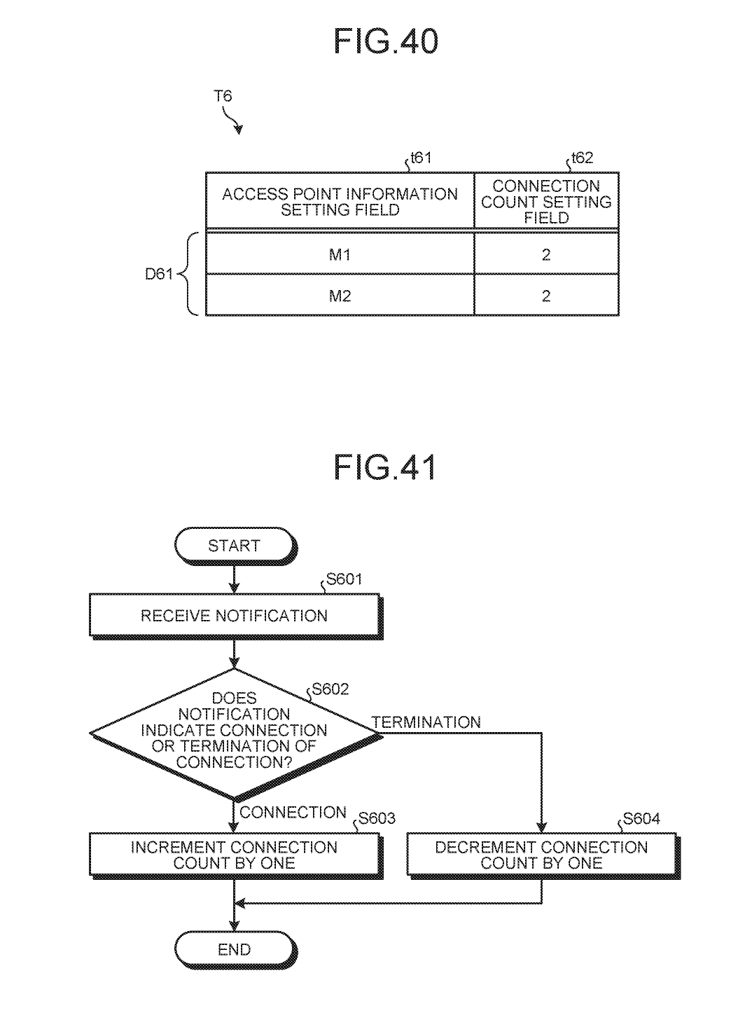

FIG. 40 is a diagram illustrating an exemplary data structure of the connection count monitoring table. A connection count monitoring table T6 illustrated in FIG. 40 includes an access point information setting field t61 and a connection count setting field t62.

In the connection count monitoring table T6, a setting example at a particular point of time during the processes (a setting example of the state illustrated in FIG. 37) is given in a data portion D61. In the access point information setting field t61 of the data portion D61, identification information (M1) of the access point P1 and identification information (M2) of the access point P2 of the wireless base station 11a is registered. In the connection count setting field t62, the connection count of two is set as the number of information terminals 10 connected to the access point P1, and the connection count of two is set as the number of information terminals 10 connected to the access point P2.

FIG. 41 is a diagram illustrating an exemplary flow of an updating process performed by the connection count monitor 951 to update the connection count in the connection count monitoring table T6. The connection count monitor 951 monitors notifications from the second wireless communication controllers 950-1 and 950-2 as needed, and repeatedly performs the updating process every time a notification is received.

Firstly, when a notification is received either from the second wireless communication controller 950-1 or from the second wireless communication controller 950-2 (S601), the connection count monitor 951 determines whether the notification indicates connection of the information terminal 10 or indicates termination of connection of the information terminal 10 (S602).

If the notification indicates connection, then the connection count monitor 951 uses the storage controller 904 and, in the connection count monitoring table T6 (see FIG. 40), increments by one the count indicating the number of information terminals 10 that are currently connected to the concerned access point (the access point from which the notification is received) (S603). More particularly, the connection count monitor 951 acquires the identification information of the access point from the source of notification and reads, from the connection count monitoring table T6, the record in which the acquired identification information is set. Moreover, the connection count monitor 951 increments by one the connection count included in the record and updates the connection count monitoring table t6. For example, if a new information terminal 10 gets connected to the access point P1, then the count indicating the number of information terminals 10 connected to the access point P1 is updated from two to three in the connection count monitoring table T6.

Meanwhile, if the notification indicates termination of connection, then the connection count monitor 951 uses the storage controller 904 and, in the connection count monitoring table T6, decrements by one the count indicating the number of information terminals 10 that are currently connected to the concerned access point (the access point from which the notification is received) (S604).

Then, the connection count monitor 951 again monitors notifications from the second wireless communication controllers 950-1, 950-2, and so on; and, when a notification is received, performs the updating process from Step S601 onward.

Given below is the explanation of a connection distribution process performed by the wireless base station 11a. Herein, as an example, it is assumed that the number of information terminals connected to an access point exceeds the upper limit, and the explanation is given for a process of distributing the connections among other access points.

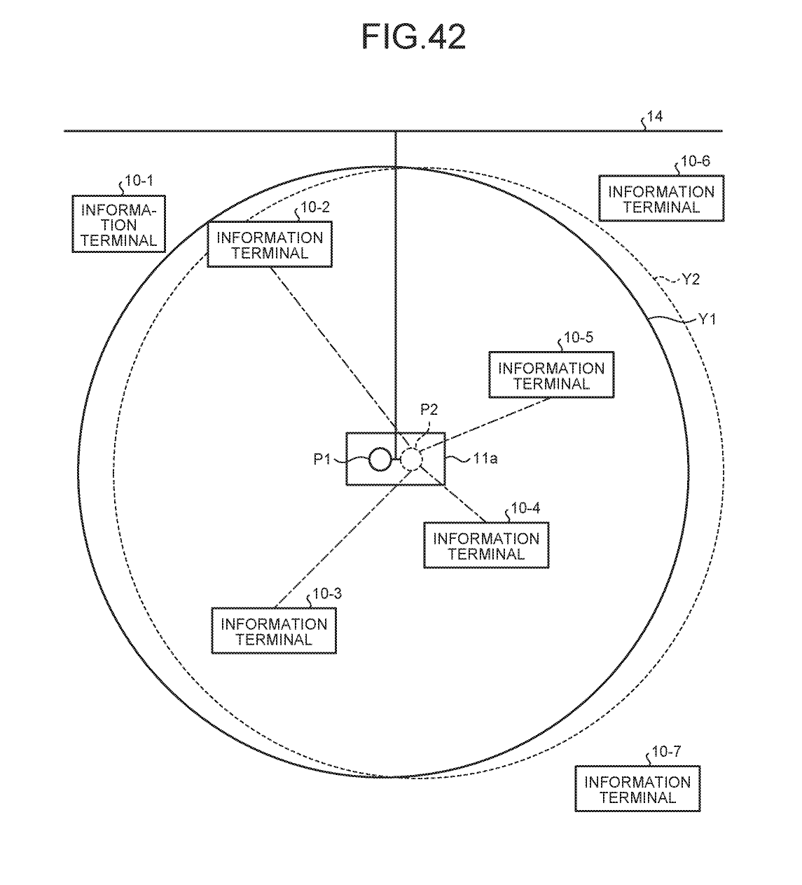

FIG. 42 is a diagram illustrating an exemplary state in which the number of information terminals connected to an access point is exceeding the upper limit. In the example illustrated in FIG. 42, the access point P2 has four information terminals connected thereto, while the access point P2 has no information terminal connected thereto.

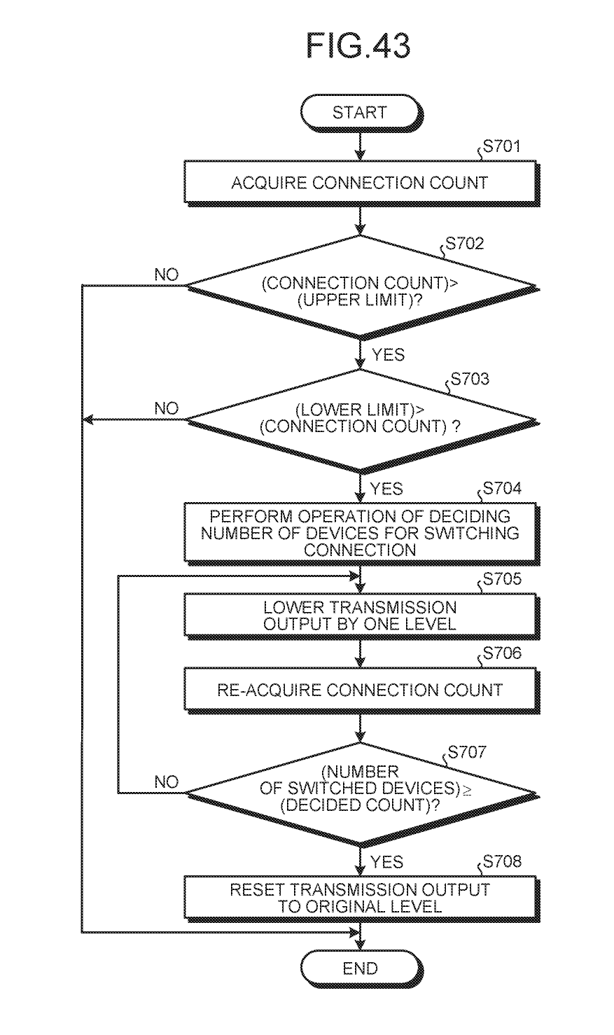

FIG. 43 is a diagram illustrating an exemplary flow of the connection distribution process performed by the wireless base station 11a. Herein, the flow of the connection distribution process illustrated in FIG. 43 is explained with reference to the state illustrated in FIG. 42.

Firstly, the wireless base station 11a (the connection count monitor 951) refers to the connection count monitoring table T6 and acquires the connection count at each access point (S701).

Then, the wireless base station 11a (the connection count monitor 951) determines whether or not the connection count at each access point exceeds the upper limit (S702). If no connection count exceeds the upper limit (No at Step S702), then the processes are ended.

If there is a connection count that exceeds the upper limit (Yes at Step S702), then the wireless base station 11a (the connection count monitor 951) further determines whether or not the connection count at any access point has fallen below the lower limit (S703). If no connection count has fallen below the lower limit (No at Step S703), then the processes are ended.

If there is a connection count that has fallen below the lower limit (Yes at Step S703), then the wireless base station 11a (the connection count monitor 951) performs a process of deciding the number of devices for switching the connection (S704). For example, assume that the access points P1 and P2 have the connection count of two as the upper limit and have the connection count of one as the lower limit. In the example illustrated in FIG. 42, the access point P2 has four information terminals connected thereto, thereby exceeding the upper limit of two devices. Moreover, the access point P1 has no information terminals connected thereto, thereby falling below the lower limit of one device. Hence, in this case, the wireless base station 11a (the connection count monitor 951) decides to switch two (or three) information terminals from the access point P2 to the access point P1 for connection.

Then, the wireless base station 11a (the radio field intensity controller 952) lowers by one level the radio wave transmission output of the access point from which the information terminals are switched, and waits for a certain period of time (S705). More particularly, the radio field intensity controller 952 outputs, as switching range information, switching range information lowered by one level to the second wireless communication controller (in this example, the second wireless communication controller 950-2) functioning as the concerned access point (in this example, the access point P2). As a result, the second wireless communication controller (the second wireless communication controller 950-2) lowers by one level the radio wave transmission output of the second wireless communication I/F (in this example, the second wireless communication I/F 850-2).

Herein, it is assumed that the waiting period at least needs to include the period of time in which information terminals perform roaming due to a decline in the electrical field intensity; access other access points; and the consequent change in the connection count of the access points is reflected in the connection count monitoring table T6.

Then, the wireless base station 11a (the connection count monitor 951) again acquires the connection count of devices at each access point after the updating of the connection count monitoring table T6 (S706), and determines whether or not switching of devices is completed for a count equal to or greater than the decided number of devices for switching connection (S707). In the example illustrated in FIG. 42, since the number of devices for switching connection is decided to be two, it is determined whether or not switching of two devices or more (preferably three devices or less) is completed.

If it is determined that switching of devices is completed for a count equal to or greater than the decided number of devices for switching connection (No at Step S705); then the system control returns to Step S705, and the wireless base station 11a (the radio field intensity controller 952) further lowers by one level the radio wave transmission output of the access point from which the information terminals are switched, and waits for a certain period of time (S705). The processes from Steps S705 to S707 are repeatedly performed until switching of devices is completed for a count equal to or greater than the decided number of devices for switching connection.

At Step S707, when it is determined that switching of devices is completed for a count equal to or greater than the decided number of devices for switching connection (Yes at Step S705), the wireless base station 11a (the radio field intensity controller 952) resets the radio wave transmission output to the original state (S708).

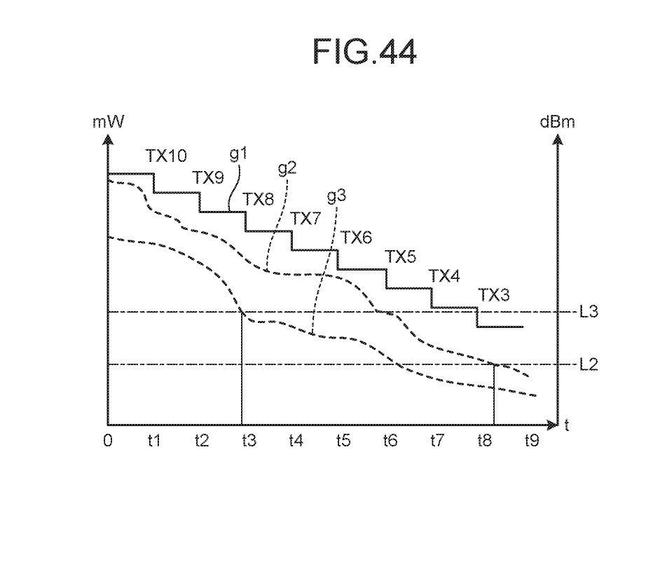

FIG. 44 is a diagram for explaining the relationship between the variation in the radio wave transmission output at an access point (as an example, the access point P2) and the roaming of information terminals accompanying the variation. In FIG. 44, the horizontal axis represents time (t), the left-side vertical axis represents the radio wave transmission output (mW) at the access point P2, and the right-side access point represents the reception radio field intensity (dBm) in the information terminals. Moreover, an example of the relationship between the transmission output on the transmitting side and the radio field intensity on the receiving side is illustrated in the form of graphs.

Regarding a graph g1 indicating the transmission output, as an example, it is illustrated that the transmission output is lowered at each level, that is, transmission outputs TX10, TX9, . . . , TX3 go on decreasing in that order at each level.

In a graph g2 indicating the radio field intensity, the radio field intensity in the information terminal 10-3 (see FIG. 42) is illustrated. In a graph g3 indicating the radio field intensity, the radio field intensity in the information terminal 10-2 (see FIG. 42) is illustrated. As illustrated in the graphs g2 and g3, the radio field intensity decreases in tandem with a decrease in the transmission output (the graph g1) by one level. Meanwhile, the information terminal 10-3 has a higher radio field intensity than the information terminal 10-2 because of the proximity of the information terminal 10-3 to the access point P2. Moreover, the fluctuation illustrated in the graphs g2 and g3 is attributed to the effect of foreign waves, or nearby wireless base stations, or fading.

Moreover, in FIG. 44, as an example of the threshold values of the radio field intensity of the information terminals 10-3 and 10-2 that start roaming, roaming threshold values L2 and L3 are illustrated as dashed-dotted lines. The roaming threshold values L2 and L3 are values specific to the information terminals 10-3 and 10-2, respectively, and are sometimes varied too. The case in which the roaming threshold values are varied is described later. Herein, the explanation is given under the assumption that the roaming threshold values are fixed.

In the example illustrated in FIG. 44, the transmission output decreases one level at a time from TX10. When the transmission output decreases to TX8, the reception radio field intensity in the information terminal 10-2 falls below the roaming threshold value L3 thereof. The information terminal 10-2 detects this decline, and starts roaming. Meanwhile, the transmission output goes on decreasing one level at a time from TX8. When the transmission output decreases to TX3, the reception radio field intensity in the information terminal 10-3 falls below the roaming threshold value L2 thereof. The information terminal 10-3 detects this decline, and starts roaming.

In this way, in the access point at which there is a concentration of connections, the radio wave transmission output is gradually lowered one level at a time. Then, at the timing of TX8 (elapsed time t3 to t4), firstly, the information terminal 10-2 switches connection to another access point that is available for connection. Subsequently, at the timing of TX3 (elapsed time t8 to t9), the information terminal 10-3 switches connection to another access point that is available for connection. In the access point at which there is a concentration of connections, when the switching of terminals to be switched is completed, the transmission output is reset to the original state (for example, TX10).

Meanwhile, herein, the explanation is given for an example in which, from among four information terminals connected to the access point P2, roaming is performed in order starting from the information terminal positioned farthest from the access point P2. However, the sequence of roaming is arbitrary. That is, depending on the radio field intensity at the position of each information terminal and depending on the roaming threshold value set in each information terminal, there are times when the sequence of roaming changes.

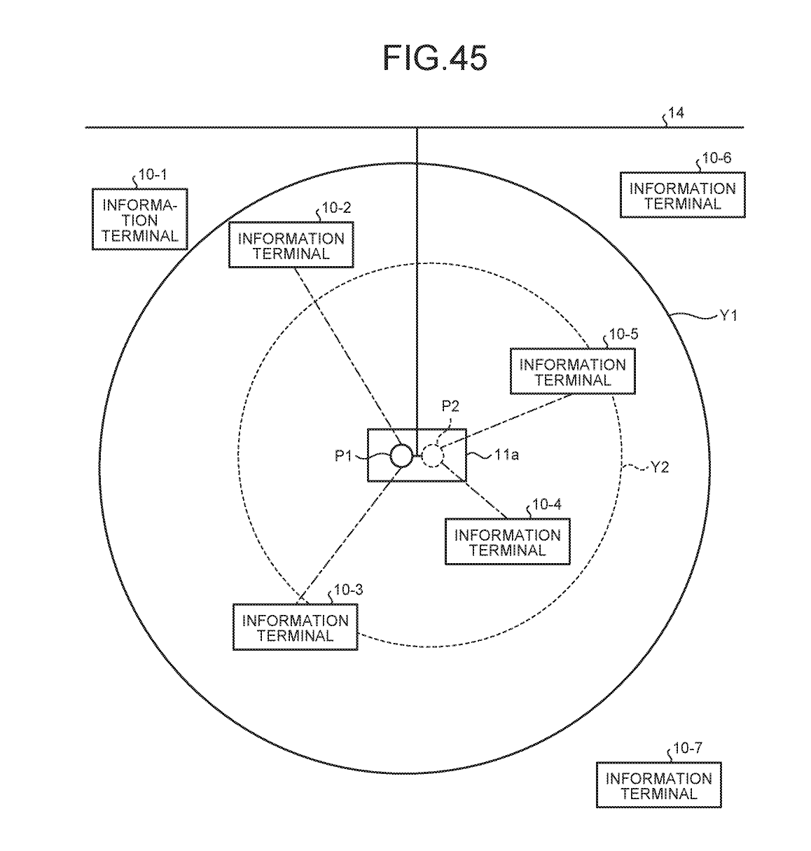

FIG. 45 is a diagram illustrating an example of the post-distribution connection status. In the example illustrated in FIG. 45, two information terminals that were connected to the access point P2 (see FIG. 42) have switched connection to the access point P1. Meanwhile, depending on the range of decrease in the radio field intensity and depending on the arrangement relationship of the information terminals, it is possible to have a situation in which three information terminals that were connected to the access point P2 switch connection to the access point P1.

Herein, as an example, the explanation is given for a case in which the access points P1 and P2 have the same upper limit and the same lower limit set therein. However, alternatively, the upper limit and the lower limit can be set to individual values for each access point. For example, assume that the access point P1 has the upper limit of five devices and has the lower limit of one device, and that the access point P2 has the upper limit of four devices and has the lower limit of two devices. When the access point P1 has seven devices connected thereto and when the access point P1 has one device connected thereto, the connections to the access point P1 exceed the upper limit by two, and the connections to the access point P2 fall below the lower limit by one. Hence, regarding the number of devices to be switched, two devices (or three devices) are switched from the access point P1 to the access point P2.

Herein, in order to make the explanation easily understandable, the explanation for the connection distribution operation for each wireless base station is given with reference to two access points. Alternatively, three or more access points can be provided for each wireless base station, and connections can be arbitrarily distributed from an access point having a large number of connections to access points having smaller numbers of connections.

Meanwhile, regardless of the upper limit and the lower limit of each wireless base station, a wireless base station can decide on the switching of terminals in such a way that all access points have equal number of devices connected thereto.

Meanwhile, when it is determined that the signal-to-noise ratio (SNR) has declined in the frequency band of process of an access point due to the impact of foreign waves, a wireless base station can lower the upper limit and the lower limit of the connection count of that access point and then decide on the number of terminals to be switched.

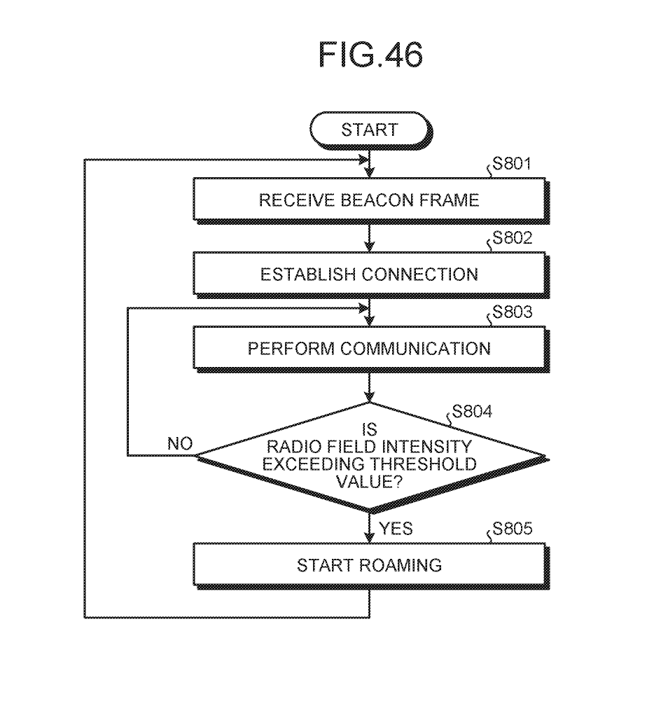

FIG. 46 is a diagram illustrating an exemplary flow of the roaming process performed by the information terminal 10. In this flow is illustrated the roaming process performed when the information terminal 10 is positioned in the overlapping area.

Firstly, the information terminal 10 activates an application and starts receiving beacon frames from the access points P1 and P2 (S801). At the time of receiving the beacon frames, the information terminal 10 appropriately adjusts the reception channels and receives the beacon frames transmitted from the access points.

The information terminal 10 compares the radio field intensity of the beacon frames with the RSSI (which stands for Received Signal Strength Indication), and performs channel matching with respect to the access point having the stronger radio field intensity and establishes wireless connection with that access point (S802).

As an example, assume that wireless connection is established with the access point P1. Then, the information terminal 10 starts the communication (S803).

The information terminal 10 determines, during the communication process too, whether or not the radio field intensity is exceeding the roaming threshold value based on the beacon frame transmitted from the access point P1 (S804). If the radio field intensity is not exceeding the roaming threshold value (No at S804), then the information terminal 10 continues with the communication as performed at Step S803.

When the radio field intensity exceeds the roaming threshold value due to the lowering of the radio field intensity of the access point P1 by the wireless base station 11a (Yes at S804), the information terminal 10 starts the roaming process (S805). Then, the system control returns to Step S801, and the information terminal 10 again receives a beacon frame from each access point and establishes wireless connection with (switches connection to) the access point having the higher radio field intensity (as an example, establishes wireless connection with the access point P2).

Subsequently, even if the wireless base station 11a resets the radio field intensity of the access point P1 to the original level, as long as the radio field intensity of the access point P2 with which the post-roaming connection was established does not exceed the roaming threshold value, the information terminal 10 maintains the connection with the access point P2.

Meanwhile, due to the effect of foreign waves, or nearby wireless base stations, or fading; the radio waves of beacon frames do not remain at a stable value and undergo fluctuation. Moreover, since the access points too are positioned close to each other, regarding the RSSI values of the access points as measured by each information terminal, the RSSI values of the closer access points can be acquired. Hence, each information terminal gets distributed to one of the access points also according to the position of that information terminal at the timing of measuring the RSSI, and gets connected to that access point.

The information terminal can also set, as another roaming threshold value, the radio field intensity within the support rate of the access points.

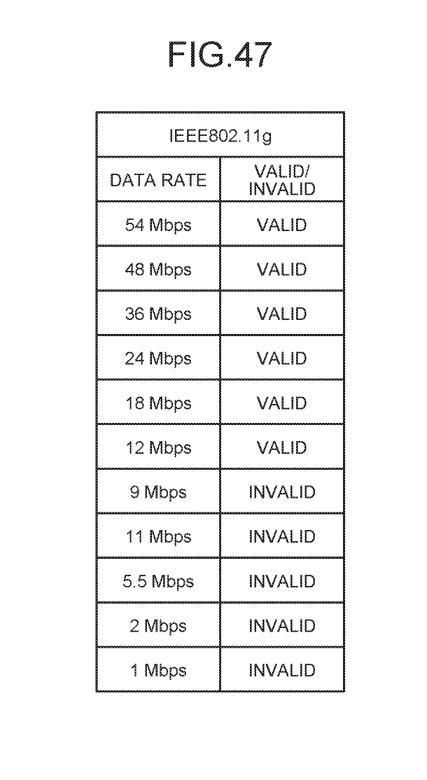

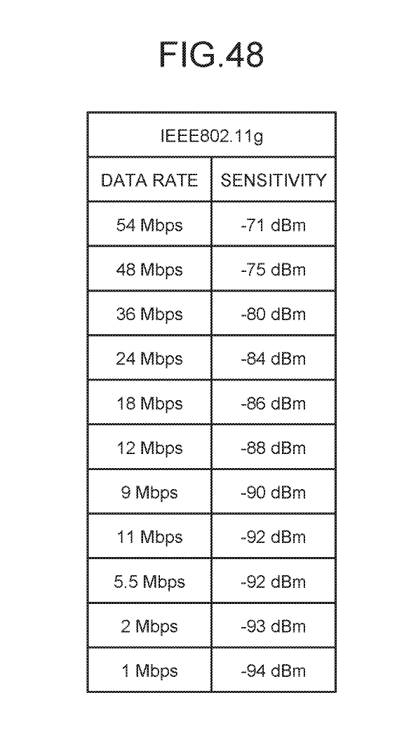

FIG. 47 is a diagram illustrating examples of the support rate that is individually set in each access point. FIG. 48 is a diagram illustrating an exemplary relationship between the data rate and the sensitivity in the information terminal.

In the individual settings of the access points as illustrated in FIG. 47, the data rate in the range of 12 Mbps to 54 Mbps is supported as a valid support rate, while the data rate equal to or lower than 9 Mbps is considered invalid. In the setting done in the information terminal as illustrated in FIG. 48, communication is possible at the data rate between 1 Mbps to 54 Mbps, and each data rate has a sensitivity associated thereto.

Assume that the access points and the information terminals have the settings as illustrated in FIGS. 47 and 48, respectively. If, for example, the receiving sensitivity in the information terminal is around −80 dBm, since transmission of up to 36 Mbps is possible at −80 dBm, the information terminal shifts the data rate to 36 Mbps at the time of transmission. When the receiving sensitivity drops down to around −90 dBm, since transmission of up to 9 Mbps becomes possible, the information terminal shifts the data rate to 9 Mbps at the time of transmission. Meanwhile, at the access point representing the communication partner, since communication at the data rate equal to or lower than 9 Mbps is considered invalid, it is not possible to communicate with the information terminal at 9 Mbps. Thus, by setting the radio field intensity within the support rate of the access point as the roaming threshold value, for example, by setting the sensitivity of −90 dBm corresponding to the data rate of 9 Mbps; it is ensured that the information terminal can perform roaming in a more stable manner.

In this way, from among the data rates supported by the access points, also by setting the lower data rates as invalid, the information terminals can be prompted to perform roaming.

In the fourth embodiment, the explanation is given for an example in which the connection count monitor 951 refers to the connection count monitoring table T6 and monitors the number of information terminals at each access point; and, when the conditions are met, the radio field intensity controller 952 controls the transmission output of the access points. However, that is not the only possible case. Alternatively, for example, the connection count monitor 951 acquires the identification information of the connection terminals from the second wireless communication controllers 950-1 and 950-2, and counts the number of connection terminals at each access point. When the number of connection terminals at an access point meets the condition, the radio field intensity controller 952 can control the transmission output of that access point. In this case, the connection count monitor 951 repeatedly acquires the identification information of the connection terminals from the second wireless communication controllers 950-1 and 950-2 at regular time intervals.

As described above, when it is detected that there is concentration of connections at one access point and that other access points are available for connection, the wireless base station 11a attenuates, for example, the radio wave transmission output of the access point at which the connections are concentrated, and prompts the information terminals that are connected to the concerned access point to perform roaming. As a result of stepwise attenuation of the radio wave transmission output of the concerned access point, from among arbitrary information terminals connected to the access point, roaming can be sequentially started from the information terminals that have reached the roaming threshold value. As a result, from the access terminal in which the connections are concentrated, the connections of information terminals can be switched to other access points in a stepwise manner, thereby making it possible to control the number of information terminals to be switched to the other access points.

Consequently, the access point to which information terminals are connected can be distributed among a plurality of access points.

Note B1

A system including:

a plurality of access points meant for connecting an information terminal to a communication network;

an information terminal configured to perform roaming when radio field intensity of radio waves transmitted from the currently-connected access point from among the plurality of access points reaches a roaming threshold value;

an acquirer configured to acquire connection count information indicating a connection count of information terminals at each of the plurality of access points;

a determiner configured to determine, based on the connection count information acquired by the acquirer, a switching count of information terminals for switching connection from the currently-connected access point to another access point from among the plurality of access points; and

a controller configured to control the transmission output of the radio waves of the plurality of access points until information terminals equal in number to the switching count perform the roaming process and switch connection from the currently-connected access point to another access point.

Note B2

The system according to Note B1, wherein the determiner determines the switching count in such a way that some of the information terminals connected to an access point having the connection count exceeding an upper limit switch connection to an access point having the connection count smaller than a lower limit.

Note B3

The system according to Note B1 or B2, wherein the controller performs control to lower, in a stepwise manner, the transmission output of the radio waves of the access point which, from among the plurality of access points, represents the source of switching connection.

Note B4

The system according to Note B3, wherein, when information terminals equal in number to the switching count finish switching the connection from the currently-connected access point to another access point, the controller performs control to reset the transmission output of the radio waves of the plurality of access points to the original level.

Note B5

The system according to Note B1, wherein the radio field intensity within the support rate of the access points is set as the roaming threshold value.

Note B6

The system according to Note B1, wherein each of the plurality of access points share connection information meant for establishing communication with the information terminal and have mutually different communication channels for communicating with information terminals.

Note B7

A mediating device including:

a plurality of access points meant for connecting an information terminal to a communication network;

an acquirer configured to acquire connection count information indicating a connection count of information terminals at each of the plurality of access points;

a determiner configured to determine, based on the connection count information acquired by the acquirer, a switching count of information terminals for switching connection from the currently-connected access point to another access point from among the plurality of access points; and

a controller configured to control transmission output of radio waves of the plurality of access points until information terminals equal in number to the switching count perform a roaming process and switch the connection from the currently-connected access point to another other access point.

### Fifth Embodiment

In the first embodiment, the web server device 12 (the connection information manager 116) establishes connection with a plurality of file-sharing server devices 13, and provides the data of one of the file-sharing server devices 13 to the information terminal. In a fifth embodiment, another embodiment is described about a system for distributing connections to the file-sharing server device 13.

The system according to the fifth embodiment includes a distributor (a determiner) that, in response to a connection request from an information terminal, distributes the connection destination of that information terminal.

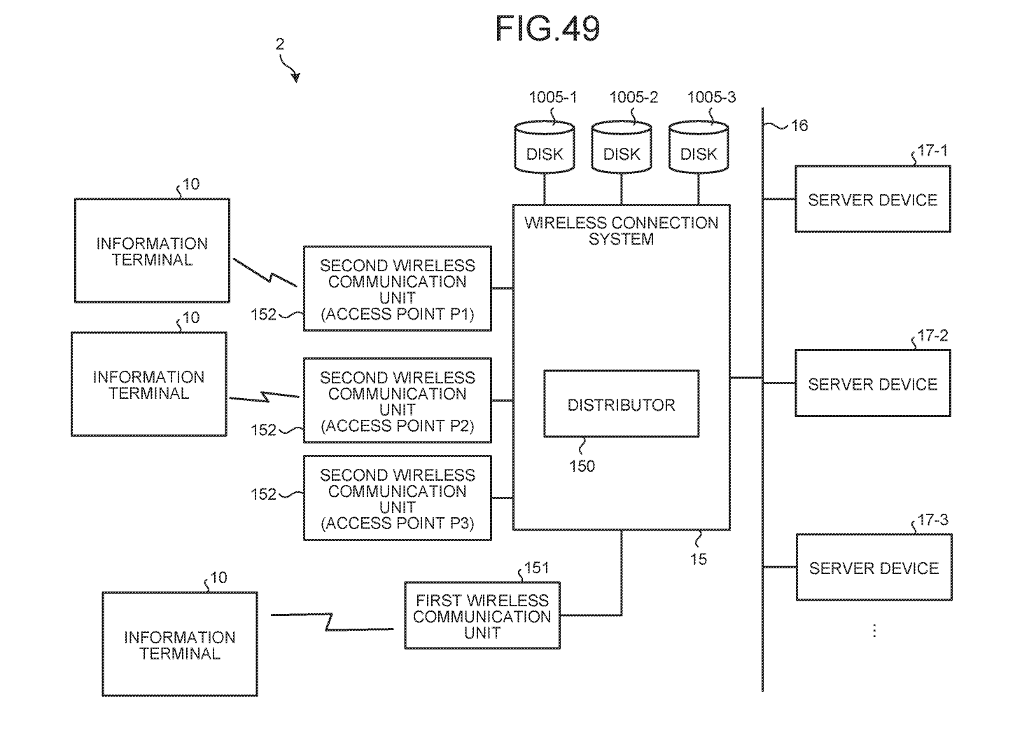

FIG. 49 is a diagram illustrating an exemplary system configuration according to the fifth embodiment. A network system 2 illustrated in FIG. 49 includes a wireless connection system 15 functioning as the mediating device 11 according to the first embodiment (see FIG. 1). The wireless connection system 15 includes a distributor 150.

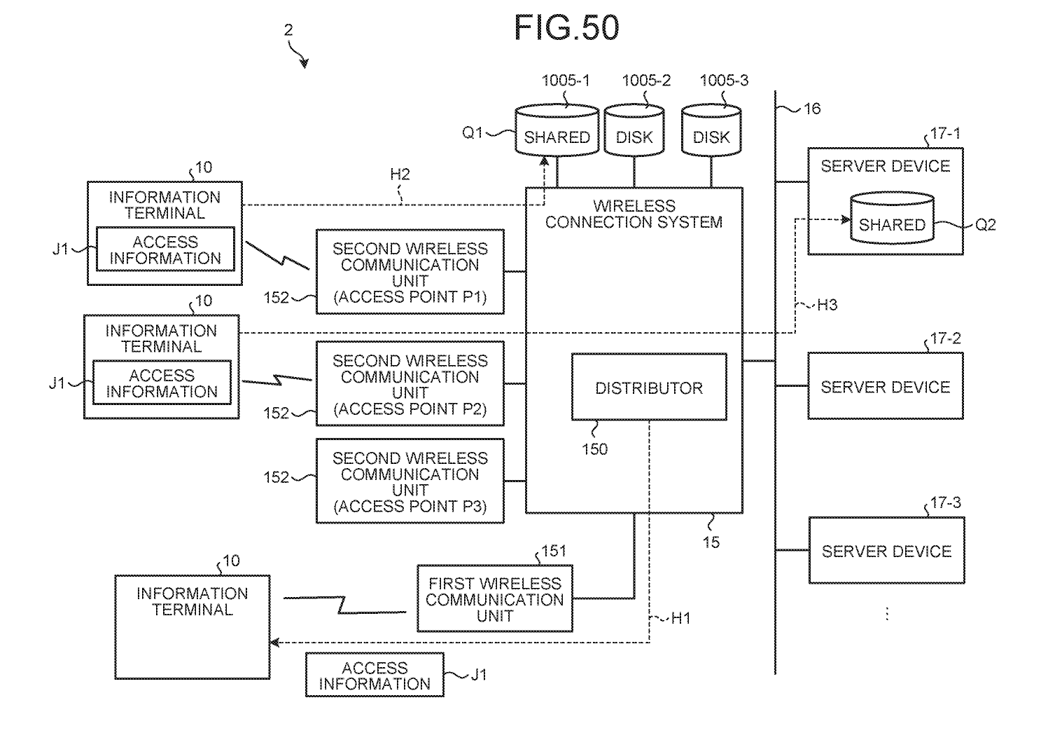

The distributor 150 transmits, to the information terminal 10 that issued a connection request, access information J1 (see FIG. 50) of the connection destination to be accessed, and distributes the connection destination of that information terminal 10. The access information J1 represents the connection information (SSID information and encryption password information) of an access point, or represents the connection destination information of the web server device 12 (uniform resource identifier (URI) information of the web server device 12), or represents URI information of a shared folder (described later).

Besides, in an identical manner to the first embodiment, the wireless connection system 15 includes a first wireless communication unit (an example of a “first communicating unit”) 151 and a second wireless communication unit (an example of a “second communicating unit”) 152. As an example, the first wireless communication unit 151 is a Bluetooth wireless communication unit, and the second wireless communication unit 152 is a Wi-Fi wireless communication unit.

The first wireless communication unit 151 is used to transmit the access information J1 to the information terminal 10.

The second wireless communication unit 152 is made to function as an access point of a LAN 16. In the example illustrated in FIG. 49, three second wireless communication units 152 are installed, each of which is made to function as one of three access points P1, P2, and P3. Herein, although three second wireless communication units 152 are installed as an example, there can be an arbitrary number of second wireless communication units 152.

Moreover, the wireless connection system 15 includes disks 1005-1, 1005-2, and 1005-3, which represent auxiliary storage devices meant for replicating the shared folder. Herein, although three disks are installed as an example, there can be an arbitrary number of disks.

The wireless connection system 15 is connected to the LAN 16, to which the following devices are also connected: the web server device 12 (see FIG. 1); and a plurality of server devices 17-1, 17-2, 17-3, and so on that represent a plurality of file-sharing server devices 13 (see FIG. 1).

FIG. 50 is an overview explanatory diagram for explaining the connection distribution method implemented in the network system 2. When a connection request is received from the information terminal 10 via the first wireless communication unit 151, the distributor 150 decides on the connection destination for the concerned information terminal 10. After deciding on the connection destination, the distributor 150 transmits the access information J1, which is meant for accessing the connection destination, to the information terminal 10, which issued the connection request, via the first wireless communication unit 151 as indicated by an arrow H1. The connection destination is decided by selecting one of a plurality of preset connection destinations meant for the same intended purpose. With reference to FIG. 50, the three access points P1 to P3 and two shared folders Q1 and Q2 represent examples of a plurality of preset connection destinations meant for the same intended purpose. Of those, the two shared folders Q1 and Q2 are provided in the disk 1005-1 and the server device 17-1, respectively, as a result of replication of an original folder.

The information terminal 10 refers to the access information J1 received via the first wireless communication unit 151, and accesses the concerned access point or the concerned shared folder. For example, in the case of establishing connection with an access point, the information terminal 10 establishes connection with the access point corresponding to the connection information specified in the access information J1. In the case of accessing a shared folder, the information terminal 10 updates the URI information of the data browsing destination, which is written as link information in the source code of an HTML page, with the URI information specified in the access information J1, and then accesses the shared folder specified by the updated URI information.

In this way, in the fifth embodiment, connection destinations meant for the same intended purpose are provided in advance, and the connection destination of each information terminal 10 is distributed using the distributor 150. As a result, even in the case in which a plurality of information terminals 10 accesses the same folder, the connection destinations meant for the same intended purpose are distributed in such a way that the shared folder in the disk 1005-1 is accessed by one information terminal 10 via the access point P1 as indicated by an arrow H2 and the shared folder in the server device 17-1 is accessed by one information terminal 10 via the access point P2 as indicated by an arrow H3. That enables achieving distribution of the load in the network system 2.

As illustrated in FIG. 50, in the network system 2, it is mainly the wireless connection system 15 that is responsible for achieving the load distribution.

Given below is the more detailed explanation about the configuration of the wireless connection system 15 and the operations performed therein. Regarding the specific explanation of the configuration and the operations of the network system 2 except for the wireless connection system 15, the first embodiment can be referred to.

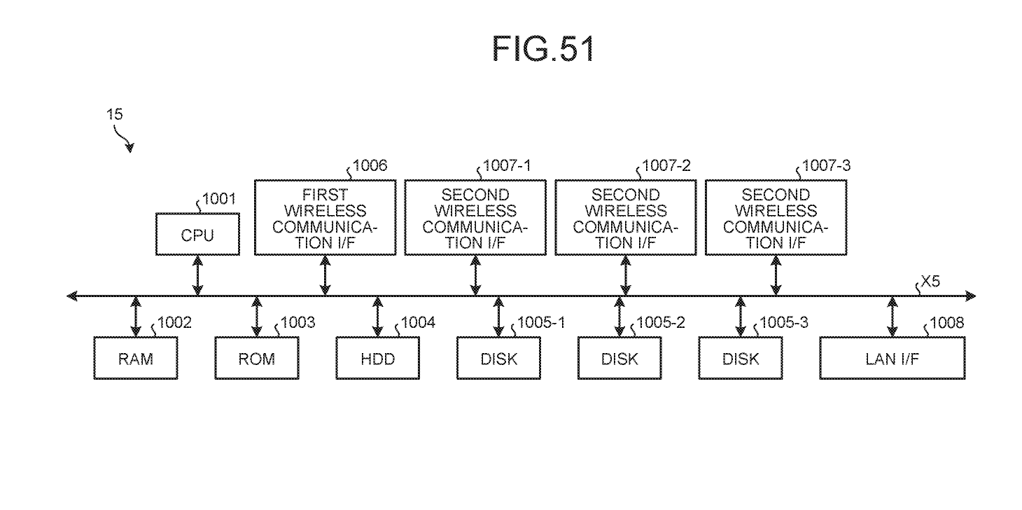

FIG. 51 is a diagram illustrating an exemplary hardware configuration of the wireless connection system 15. The wireless connection system 15 illustrated in FIG. 51 includes a CPU 1001, a RAM 1002, a ROM 1003, an HDD 1004, the disks 1005-1 to 1005-3, a first wireless communication I/F 1006, second wireless communication I/Fs 1007-1 to 1007-3, and a LAN I/F 1008 that are connected to each other by a bus X5.

The CPU 1001 is a computing unit that comprehensively controls the operations of the wireless connection system 15. The RAM 1002 is a volatile storage medium in which reading and writing of information can be done at high speeds, and is used by the CPU 1001 as the work area at the time of processing information. The ROM 1003 is a non-volatile storage medium meant only for reading purposes, and is used to store computer programs such as firmware. The HDD 1004 is a non-volatile storage medium enabling reading and writing of information, and is used to store various computer programs and a variety of data. For example, various computer programs include a distribution program. The data contains replication information used in the distribution process and contains data files of various management tables.

The disks 1005-1 to 1005-3 are detachably-attachable auxiliary storage devices.

The first wireless communication I/F 1006 is an interface meant for Bluetooth communication.

The second wireless communication I/Fs 1007-1 to 1007-3 are wireless LAN interfaces.

The LAN I/F 1008 is a LAN interface for establishing wired connection with the LAN 16.

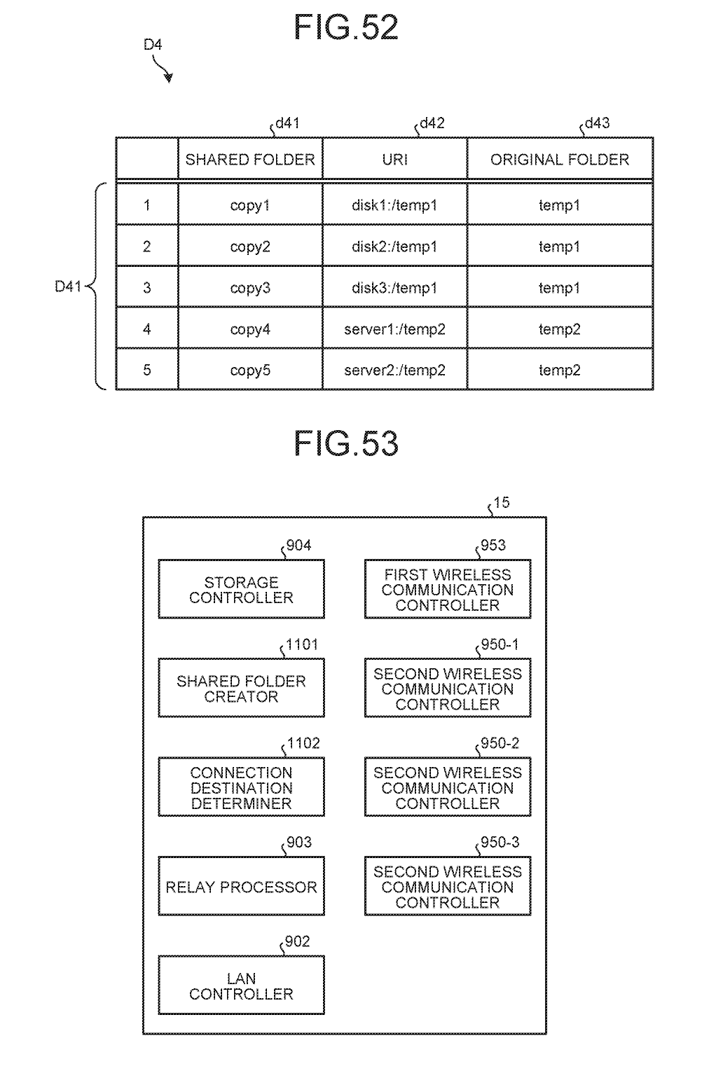

FIG. 52 is a diagram illustrating an exemplary data structure of replication information stored in the HDD 1004. Herein, replication information D4 illustrated in FIG. 52 contains name information d41, replication-destination URI information d42, and replication-source original folder information d43. The name information d41 represents name information of the shared folders that have been generated by replication. The replication-destination URI information d42 represents URI information indicating the replication destinations of the generated shared folders. The replication-source original folder information d43 represents information such as the name of the folder that is replicated into shared folders. Herein, the information is stored in a corresponding manner.

In a data portion D41 of the information, as an example, the replication information of five replicated shared folders is illustrated in order of priority. For example, the first row of the data portion D41 indicates that an original folder “temp1” is replicated at an URI “disk1:/temp1” with a shared folder name of “copy1”. The first to third rows represent the replication information about the original folder “temp1”, and are listed in order of priority. The fourth row in the data portion D41 indicates that an original folder “temp2” is replicated at an URI “server1:/temp2” with a shared folder name of “copy4”. The fourth and fifth rows represent the replication information about the original folder “temp2”, and are listed in order of priority. Meanwhile, replication information and priority order information can be managed in different files as long as they are associated to each other.

In this setting example of the data portion D41, the original folder “temp1” is replicated as shared folders in the disks 1005-1 to 1005-3, and the original folder “temp2” is replicated as shared folders in the server devices 17-1 and 17-2.

Herein, there is no particular restriction on the location of storage of an original folder. For example, the location of storage can be included in either the wireless connection system 15 or the file-sharing server device 13. Alternatively, the location of storage can be included in the web server device 12. Meanwhile, “server1” represents any one of the server devices in the LAN 16, and is used as the file-sharing server device 13 as a result of replication of a shared folder therein.

FIG. 53 is a diagram illustrating an exemplary functional configuration of the wireless connection system 15. In the wireless connection system 15, when the CPU 1001 loads various computer programs from the ROM 203 or the HDD 204 into the RAM 202 and executes them, it results in the implementation of various functions. The wireless connection system 15 illustrated in FIG. 53 includes the LAN controller 902, the relay processor 903, the storage controller 904, a shared folder creator 1101, a connection destination determiner 1102, the first wireless communication controller 953, and second wireless communication controllers 950-1 to 950-3.

The LAN controller 902 controls the LAN I/F 1008 and transmits data to and receives data from the communication partners in the LAN 16.

The relay processor 903 performs a relaying process between the wireless LAN and the LAN 16.

The storage controller 904 controls reading or writing of information with respect to the storage areas such as the ROM 1003, the RAM 1002, the HDD 1004, and the disks 1005-1 to 1005-3 of the wireless connection system 15.

The shared folder creator 1101 receives data of the original folders “temp1” and “temp2”, and creates shared folders thereof in the disks 1005-1 to 1005-3.

When a connection request is received from an information terminal, the connection destination determiner 1102 decides on the connection destination of that information terminal in such a way that the connection destination is distributed with other information terminals. The type of the connection destination to be decided is either an access point, or a shared folder representing the replication destination of an original folder, or a web server device.

Regarding an access point, when the access points P1 to P3 are available, one of those access points is decided as the connection destination.

Regarding a shared folder representing a replication destination, for each original folder, one of a plurality of shared folders in which the original folder is replicated is decided as the connection destination. For example, when the shared data set in the replication information D4 (see FIG. 52) is replicated, regarding the original folder “temp1”, one row from among the first to third rows is decided as the connection destination; and, regarding the original folder “temp2”, one row from the fourth and fifth rows is decided as the connection destination.

Regarding the web server device 12, when a plurality of web server devices is installed, one of them is decided as the connection destination. When only one web server device is installed, it is used as the connection destination.

Regarding the method for deciding the connection destination, as long as the connections can be distributed, any decision method can be implemented. For example, the connection destination can be varied according to the sequence in which the targets for connection (access points, shared folders, and server devices) are listed, or an available connection destination can be decided based on the connection count and the data transfer volume at that point of time.

The first wireless communication controller 953 controls the first wireless communication I/F 1006. In the fifth embodiment, when a connection request is received from the information terminal 10 using Bluetooth communication, the first wireless communication controller 953 transmits, to the information terminal 10 as a response to the connection request, the “connection information (the SSID information and the encryption password information)” decided by the connection destination determiner 1102, or the “connection destination information (the URI of a web server device)”, or the URI information of a shared folder.

The second wireless communication controllers 950-1 to 950-3 control the second wireless communication I/Fs 1007-1 to 1007-3, respectively. The second wireless communication controllers 950-1 to 950-3 function as the access points P1 to P3, respectively, and hold the connection information (the SSID information and the encryption password information) specific to the respective wireless LANs.

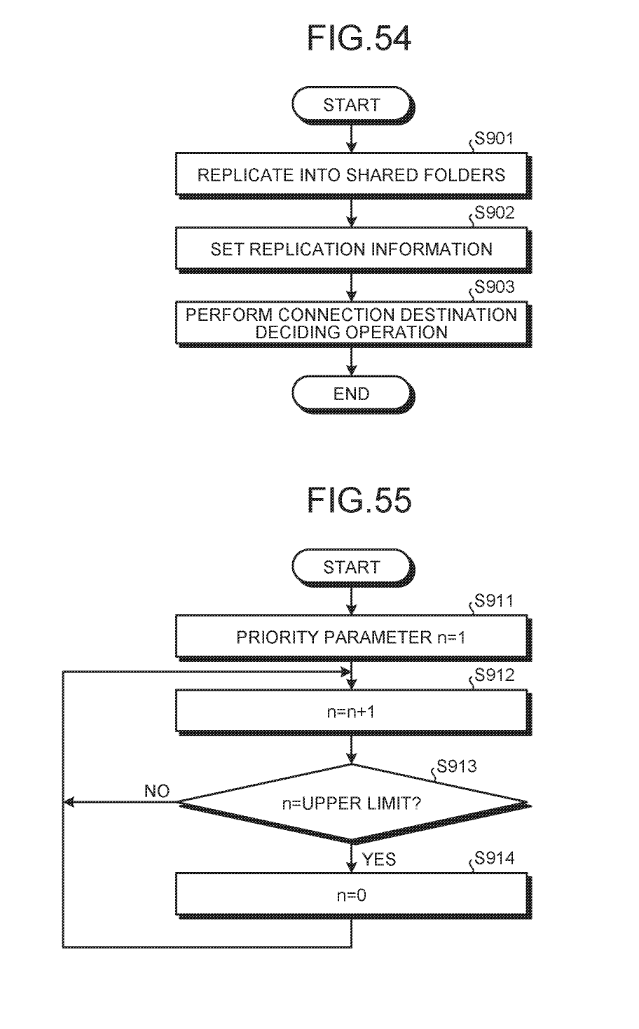

FIG. 54 is a diagram for explaining an example of the overall flow of a distribution process performed by the wireless connection system 15. Firstly, before the start of the services, the administrator replicates the original folder, in which the data to be provided is stored, as a shared folder in a plurality of connection devices connected to the LAN 16 (S901). Moreover, the administrator sets the information about the replicated shared folders in the replication information stored in the HDD 1004 of the wireless connection system 15 (S902).

More particularly, the administrator uses the administrator terminal (not illustrated) in the LAN 16; replicates the original folder in the disks 1005-1 to 1005-3 and the server devices 17-1, 17-2, and so on using the administrator rights; and sets the replicated folders to be sharable. Furthermore, after the replication is done, the administrator inputs information about the replicated shared folders, such as setting information containing the shared folder names, the replication-destination URI information, and the original folder name, in the administrator terminal; and updates the setting of the replication information, which is stored in the HDD of the wireless connection system 15, with the abovementioned settings. Meanwhile, in the administrator terminal, a dedicated setting screen can be provided to input the settings.

Once the services are started after the administrator has done the settings, every time a connection request is received from an information terminal using the first wireless communication, the wireless connection system 15 (the distributor 150) performs a connection destination deciding process for distributing the connection destination, acquires the access information of the connection destination, and transmits the access information to the information terminal, which issued the request, using the first wireless communication (S903).

The information terminal can access the connection destination as assigned using the access information, and avail identical services.

FIG. 55 is a diagram illustrating an exemplary flow of a connection destination deciding operation. The following explanation is given for an exemplary flow of processes in the case in which the connection destination is decided according to the order of priority. There is a plurality of types of decision targets such as access points, web server devices, or shared folders representing the replication destinations of an original folder. Regarding each decision target, a priority parameter n is individually used, and the connection destination is decided in an identical manner.

Firstly, when a connection request is a received from an information terminal using the first wireless communication, the connection destination determiner 1102 substitutes “1” in the priority parameter n, decides that the connection destination specified by the priority parameter n (i.e., the connection destination having the priority of 1) is the connection destination of the concerned information terminal, and transmits the access information meant for accessing the decided connection destination to the first wireless communication controller (S911). For example, in the case of deciding the connection destination of the original folder “temp1”, the URI information of the first row that is set in the replication information D4 (see FIG. 52) and that has the priority of 1 is transmitted as one set of the access information to the first wireless communication controller.

Subsequently, when a connection request is received from another information terminal using the first wireless communication, the connection destination determiner 1102 increments the priority parameter n by one, decides that the connection destination specified by the priority parameter n (i.e., the connection destination having the priority of 2) is the connection destination of the concerned information terminal, and transmits the access information meant for accessing the decided connection destination to the first wireless communication controller (S912). For example, in the case of deciding the connection destination of the original folder “temp1”, the URI information of the second row that is set in the replication information D4 (see FIG. 52) and that has the priority of 2 is transmitted as one set of the access information to the first wireless communication controller.

Subsequently, when a connection request is received from another information terminal using the first wireless communication, the connection destination determiner 1102 determines whether the priority parameter n has reached the upper limit (S913). For example, in the case of deciding on an access point, if there are three access points, the upper limit is “3”. In the case of deciding on a replication-destination shared folder for the original folder “temp1”, the upper limit is “3” in the setting example of the replication information D4 (see FIG. 51).

If the upper limit has not been reached (No at Step S913), then the system control returns to Step S912 and the connection destination determiner 1102 performs the corresponding operation.

When the upper limit is reached (Yes at Step S913), the connection destination determiner 1102 resets the priority parameter n to “0” (S914). Then, the system control returns to Step S912 and the connection destination determiner 1102 performs the corresponding operation.

In this decision method based on the order of priority, the connection destinations having higher priority are sequentially assigned to the information terminals in the sequence of issuing of connection requests. When the allocation of connection destinations is over till the connection destinations having low priority, the connection destinations are again assigned according to the order of priority. However, this method of allocation is only exemplary. Alternatively, when the number of information terminals to be assigned with the connection destinations of higher priority is fulfilled, the connection destinations having the next higher priority are assigned.

Meanwhile, instead of using the order of priority, the connection status at that point of time can be taken into account and the available connection destination can be decided accordingly. In that case, the connection destination determiner 1102 updates the connection count and the data transfer volume of each connection destination in management tables explained below; and, when a connection request is received from an information terminal, decides on the connection destination having a small connection count and a low communication volume.

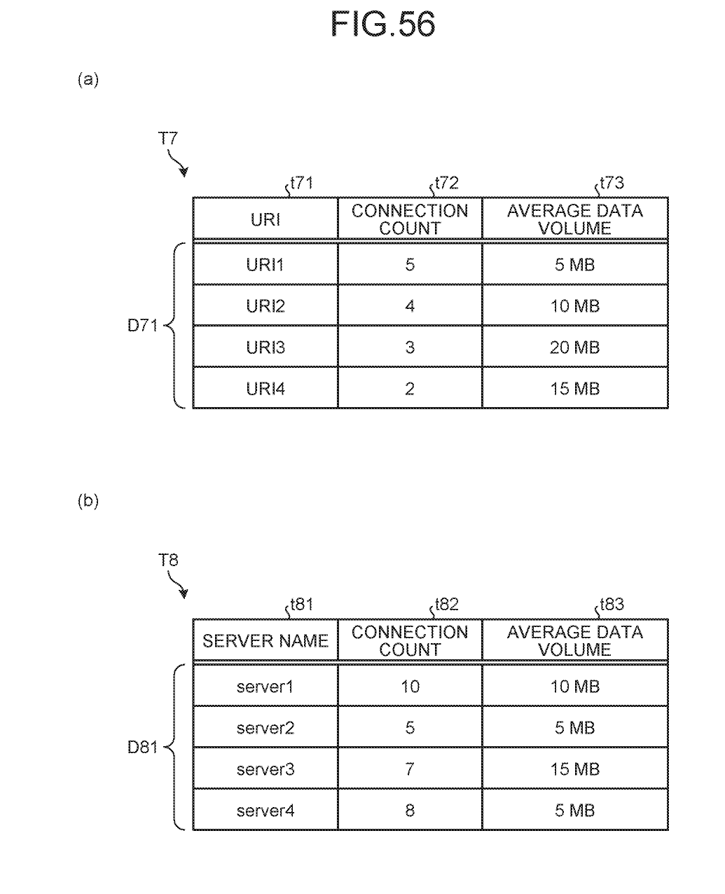

FIG. 56 is a diagram illustrating an exemplary data structure of the management tables maintained in the wireless connection system 15. In (a) of FIG. 56 is illustrated a local folder connection management table meant for managing the access status with respect to local shared folders. In (b) of FIG. 56 is illustrated a server connection management table meant for managing the access status with respect to server devices.

A local folder connection management table T7 illustrated in (a) of FIG. 56 includes a URI setting field t71, a connection count setting field t72, and an average data volume setting field t73.

In a data portion D71 of the local folder connection management table T7, a setting example at a particular point of time during the processes is illustrated. The first row in the data portion D71 indicates that a URI URI1 has the connection count of five and has the average data volume of 5 MB. The second row indicates that a URI URI1 has the connection count of four and has the average data volume of 10 MB.

A server connection management table T8 illustrated in (b) of FIG. 56 includes a server name setting field t81, a connection count setting field t82, and an average data volume setting field t83.

In a data portion D81 of the server connection management table T8, a setting example at a particular point of time during the processes is illustrated. The first row in the data portion D81 indicates that a server device server1 has the connection count of 10 and has the average data volume 10 MB. The second row indicates that a server device server2 has the connection count of five and has the average data volume 5 MB.

When a connection request is received from an information terminal, the connection destination determiner 1102 decides on the connection destination based on the management tables. For example, an available connection destination is decided on priority based on the connection count and the data transfer volume.

Meanwhile, it is desirable that the management tables are appropriately updated.

Moreover, the connection destination determiner 1102 sets stepwise upper limits for the connection count of connection destinations and repeatedly performs the following processes: when the connection count of the first allocation destination reaches the first-step upper limit, decides on the second connection destination as the allocation destination; and, when the connection count of the second allocation destination reaches the first-step upper limit, decides on the third connection destination as the allocation destination; and so on. When all connection destinations reach the first-step upper limit, the first connection destination is again decided as the allocation destination and, when the connection count of the first allocation destination reaches the second-step upper limit, the second connection destination is decided as the allocation destination.

The explanation above is given for an example in which, when a connection request is received from an information terminal, all access information is transmitted at one time using the first wireless communication unit. However, alternatively, depending on the type of connection request, only the corresponding access information can be sequentially sent. For example, when a connection request indicating a connection request with respect to an access point is received, the wireless connection system 15 transmits the connection information (the SSID information and the encryption password information) specific to the decided access point to the information terminal that issued the connection request. When a connection request indicating a connection request with respect to a web server device is received, the wireless connection system 15 transmits predetermined connection destination information (the URI of the web server device) to the information terminal that issued the connection request. When a connection request indicating an access request with respect to a “shared folder” is received, the wireless connection system 15 transmits the “URI information” of the decided shared folder to the information terminal that issued the connection request.

Moreover, in the fifth embodiment, the explanation is given for an example in which an information terminal acquires the URI information of a shared folder. Alternatively, the URI information of that shared folder can be transmitted to the web server device 12 from the wireless connection system 15. In that case, the connection information manager 116 of the web server device 12 changes the access to the shared folder as specified in the concerned information terminal to the connection destination indicated by the received URI information.

As described above, in the fifth embodiment, without making the user of an information terminal conscious about the connection destination, the information terminal selects the connection destination that corresponds to the access information delivered by the wireless connections system, and establishes connection with that connection destination. Since the connection destination is decided by the wireless connection system in such a way that the load is distributed, there is enhancement in the communication throughput of the entire network system, and thus the user of the information terminal can get services in a more comfortable environment.

Note C1

A network system including:

an information terminal; and

a mediating device configured to mediate connection of the information terminal with a communication network, wherein

the mediating device includes
a determiner configured to determine the connection destination for the information terminal, and
a first communicating unit and a second communicating unit configured to perform communication with the information terminal,

the first communicating unit transmits, to the information terminal, access information to be used in accessing the connection destination determined by the determiner, and

the second communicating unit performs communication with the information terminal, to which the first communicating unit has transmitted the access information, using the access information.

The system according to Note C1, wherein

a plurality of sets of replicated shared data is included in the mediating device or in an information processing device in the communication network,

the determiner determines one of the plurality of sets of shared data as the connection destination for the information terminal, and

the first communicating unit transmits, to the information terminal, access information to be used in accessing the shared data determined by the determiner.

Note C3

The system according to Note C1, wherein the access information contains connection information specific to each of the plurality of access points.

Note C4

The system according to Note C2, wherein the access information contains URI information of the plurality of sets of shared data.

The system according to any one of Notes C1 to C3, wherein the determiner determines the connection destination for the information terminal based on the order of priority.

Note C6

The system according to any one of Notes C1 to C3, wherein, the determiner determines the connection destination for the information terminal based on the connection count of the connection destination.

Note C7

The system according to any one of Notes C1 to C3, wherein, the determiner determines the connection destination for the information terminal based on the data transfer volume of the connection destination.

The computer programs executed in the devices according to the embodiments are recorded as installable or executable files in a computer-readable recording medium such as a compact disk read only memory (CD-ROM), a flexible disk (FD), a compact disk recordable (CD-R), or a digital versatile disk (DVD).

Alternatively, the computer programs executed in the devices according to the embodiments can be stored in a downloadable manner in a computer connected to a network such as the Internet. Still alternatively, the computer programs executed in the devices according to the embodiments can be distributed via a network such as the Internet.

Still alternatively, the computer programs executed in the devices according to the embodiments can be stored in advance in a ROM.

According to an aspect of the present invention, by acquiring owner identification information from an information terminal, it becomes possible to clearly know the identity of the person to be charged, thereby enabling prevention of fraudulent orders given by personation.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or processes described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. A system comprising:
an information processing device; and
an information terminal, the information processing device and the information terminal being connectible for communication via a communication network, wherein
the information terminal includes
owner identification information for uniquely identifying an owner of the information terminal,
an input receiver configured to receive input of operator identification information for identifying an operator of the information terminal, and
a request transmitter configured to transmit, to the information processing device, request information for requesting a process for a target for charging and first pair information containing the owner identification information and the operator identification information, and
the information processing device includes
second pair information in which the owner identification information of the information terminal is associated with the operator identification information of the operator who is the owner of the information terminal, the second pair information being registered in advance,
a verifier configured to collate the second pair information with the first pair information transmitted by the request transmitter,
a request processor configured to, when verification information indicating that the first pair information matches with the second pair information is acquired as a result of collation performed by the verifier, perform the process for the target indicated in the request information transmitted by the request transmitter, and
a charge manager configured to manage the owner identification information corresponding to the verification information acquired, as information for a target person for charging for whom the process for the target is performed by the request processor.

2. The system according to claim 1, further comprising a mediating device configured to assign the information terminal as a connection device in the communication network, and mediate communication between the information terminal and the information processing device, wherein
the information terminal includes a communicating unit configured to acquire predetermined connection destination information from the mediating device to access the information processing device.

3. The system according to claim 2, wherein
the mediating device includes a plurality of mediating devices, and
the system further comprises an allocating device configured to allocate one of the mediating devices to perform mediation of connection from the information terminal to the communication network.

4. The system according to claim 3, wherein the allocating device includes an information terminal registerer configured to register identification information of the information terminal in a mediation destination that mediates connection with the communication network.

5. The system according to claim 4, wherein the allocating device includes a deleter configured to delete, from the mediation destination, identification information of the information terminal that is currently connected to the mediation destination.

6. The system according to claim 2, wherein
the mediating device includes
a plurality of access points, and
a roaming processor configured to switch connection of the information terminal that is currently connected to a first access point to a second access point.

7. The system according to claim 6, wherein the roaming processor varies, in a stepwise manner, transmission output of radio waves with respect to the information terminal currently connected to the first access point, and switches connection of some or all information terminals to the second access point.

8. The system according to claim 2, wherein the mediating device includes a distributor configured to distribute connection destination of the information terminal.

9. The system according to claim 2, wherein the communicating unit includes
a first wireless communication unit configured to receive connection information for establishing separate wireless connection from the mediating device, and
a second wireless communication unit configured to establish communication of a wider communication range than the first wireless communication unit, based on the connection information.

10. The system according to claim 1, wherein
the process for the target to be performed by the request processor includes a process for providing data, and
when the request information indicates a request for providing the data, the request processor performs the process for providing the data.

11. The system according to claim 10, wherein the process for providing the data to be performed by the request processor includes transmitting an order screen including the data to the information terminal and receiving an order for the data from the information terminal via the order screen.

12. The system according to claim 10, further comprising a data management device installed in the communication network to manage the data, wherein
the request processor acquires the data from the data management device via the communication network.

13. The system according to claim 11, wherein the request processor receives a search condition with respect to the data from the information terminal and sets data that meets the search condition in the order screen.

14. The system according to claim 1, wherein the information terminal includes a read restriction canceller configured to cancel read restriction that is imposed on the owner identification information depending on a type of operating system.

15. The system according to claim 14, wherein the information terminal includes a communicating unit configured to, when the read restriction imposed on the owner identification information is not cancelled by the read instruction canceller, notify the operator of the information terminal about information indicating that the process for the target would not be performed by the information processing device.

16. An information processing device that processes request information transmitted from an information terminal via a communication network, the information processing device comprising:
second pair information in which owner identification information for identifying an owner of the information terminal is associated with operator identification information for identifying an operator who is the owner of the information terminal, the second pair information being registered in advance;
a verifier configured to collate the second pair information with first pair information transmitted from the information terminal along with request information for requesting a process for a target for charging, the first pair information including the owner identification information of the information terminal and the operator identification information of the information terminal;
a request processor configured to, when verification information indicating that the first pair information matches with the second pair information is acquired as a result of collation performed by the verifier, perform the process for the target indicated in the request information transmitted by the request transmitter; and
a charge manager configured to manage the owner identification information corresponding to the verification information acquired, as information for a target person for charging for whom the process for the target is performed by the request processor.

17. The information processing device according to claim 16, wherein,
the process for the target to be performed by the request processor includes a process for providing data, and
the request processor acquires the data to be provided to the information terminal from a data management device configured to manage the data, via the communication network.

18. The information processing device according to claim 16, further comprising a registerer configured to register the second pair information.

19. The information processing device according to claim 16, wherein the information terminal includes a communicating unit configured to acquire predetermined connection destination information from a mediating device to access the information processing device, the mediating device being configured to assign the information terminal as a connection device in the communication network, and mediate communication between the information terminal and the information processing device.

20. The information processing device according to claim 19, wherein
the mediating device includes a plurality of mediating devices, and
one of the mediating devices is allocated to perform mediation of connection from the information terminal to the communication network by an allocating device.

21. The information processing device according to claim 20, wherein the allocating device includes an information terminal registerer configured to register identification information of the information terminal in a mediation destination that mediates connection with the communication network.

22. The information processing device according to claim 21, wherein the allocating device includes a deleter configured to delete, from the mediation destination, identification information of the information terminal that is currently connected to the mediation destination.

23. The information processing device according to claim 19, wherein
the mediating device includes
a plurality of access points, and
a roaming processor configured to switch connection of the information terminal that is currently connected to a first access point to a second access point.

24. The information processing device according to claim 23, wherein the roaming processor varies, in a stepwise manner, transmission output of radio waves with respect to the information terminal currently connected to the first access point, and switches connection of some or all information terminals to the second access point.

25. The information processing device according to claim 19, wherein the mediating device includes a distributor configured to distribute connection destination of the information terminal.

26. A non-transitory computer-readable recording medium with an executable program stored thereon, wherein the program, when executed by a computer including a storage storing second pair information, causes the computer to perform:
collating the second pair information with first pair information transmitted from an information terminal along with request information for requesting a process for a target for charging, the first pair information including owner identification information for identifying an owner of the information terminal and operator identification information for identifying an operator of the information terminal;
performing, when verification information indicating that the first pair information matches with the second pair information is acquired as a result of the collating, the process for the target indicated in the request information; and
managing the owner identification information corresponding to the verification information acquired, as information for a target person for charging for whom the process for the target is performed.
